(19) United States
(12) Patent Application Publication
(10) Pub. No.: US 2025/0349883 A1
(43) Pub. Date: Nov. 13, 2025

(54) MODIFIED SULFIDE SOLID ELECTROLYTE AND PRODUCTION METHOD THEREFOR, AND ELECTRODE COMPOSITE MATERIAL AND LITHIUM ION BATTERY

(71) Applicant: IDEMITSU KOSAN CO.,LTD., Tokyo (JP)

(72) Inventors: Tomoyuki OKUYAMA, Chiyoda-ku, Tokyo (JP); Keita SEDA, Chiyoda-ku, Tokyo (JP)

(73) Assignee: IDEMITSU KOSAN CO.,LTD., Tokyo (JP)

(21) Appl. No.: 18/871,588

(22) PCT Filed: Jul. 26, 2023
(86) PCT No.: PCT/JP2023/027340

§ 371 Date: Dec. 4, 2024

(30) Foreign Application Priority Data
Jul. 27, 2022 (JP) 2022-119689

(51) Int. Cl. H01M 10/0562; H01M 4/62; H01M 10/0525

(52) U.S. Cl. CPC H01M 10/0562; H01M 4/62; H01M 10/0525; H01M 2300/0068

(57) ABSTRACT

Provided are a modified sulfide solid electrolyte containing a sulfide solid electrolyte having a BET specific surface area of 10 m²/g or more and containing a lithium atom, a sulfur atom, a phosphorus atom, and a halogen atom, and at least two kinds of compounds selected from the particular compounds (A) to (I) that is excellent in coating suitability in coating as a paste, and can exhibit the excellent battery capabilities efficiently, irrespective of the large specific surface area thereof, and a method of producing the same, and also an electrode mixture and a lithium ion battery using the same.

### TECHNICAL FIELD

The present invention relates to a modified sulfide solid electrolyte and a method of producing the same, and an electrode mixture and a lithium ion battery.

### BACKGROUND ART

With rapid spread in recent years of information-related devices, communication devices, and the like, such as personal computers, video cameras, and mobile phones, development of batteries that are utilized as a power source therefor is considered to be important. In particular, lithium ion batteries are attracting attention from the standpoint of the high energy density thereof.

The batteries used in these applications have used an electrolytic solution containing a flammable organic solvent, which thus requires a safety equipment provided for suppressing temperature rise in short circuit, a structure preventing short circuit, and improvements in materials. In view of the situations, the use of a solid electrolyte instead of the electrolytic solution making the battery fully solid can avoid the use of a flammable organic solvent, can simplify the safety equipment, and can improve the production cost and the productivity, and therefore a battery using a solid electrolyte layer instead of the electrolytic solution is being developed.

A sulfide solid electrolyte has been known as a solid electrolyte used in a solid electrolyte layer, and the sulfide solid electrolyte is firstly being demanded to enhance the ionic conductivity, and also to enhance the battery capabilities in the use thereof in a lithium ion battery. Examples of measures being investigated for enhancing the capabilities include a technique of covering the surface of the electrolyte, and a technique using a composition containing a solid electrolyte and an organic compound.

For example, PTL 1 proposes a production method of a composite solid electrolyte including a sulfide based solid electrolyte, the surface of which is covered with a prescribed halogenated hydrocarbon compound as a coating material for enhancing the ionic conductivity. PTL 2 describes a solid electrolyte composition including a sulfide solid electrolyte having on the surface thereof a coating film formed with a compound having a C—O bond and a compound having an S═O bond, for enhancing the cycle characteristics of a lithium ion battery by enhancing the affinity of the solid electrolyte with an active substance used in a negative electrode, a positive electrode, and the like in producing the lithium ion battery. PTL 3 describes a solid electrolyte composition containing a dispersion medium, such as a ketone compound and an alcohol compound, as a solid electrolyte composition capable of producing a fully solid secondary battery showing an excellent battery capacity.

For example, furthermore, PTL 4 describes a solid electrolyte composition containing a fluorine-containing compound containing a fluorine atom and P═O or C—O for achieving good cycle characteristics. PTL 5 describes a technique using a solid electrolyte composition containing a solid electrolyte layer containing an inorganic solid electrolyte and an organic compound having a nonionic monovalent halogen atom other than fluorine, for achieving a fully solid secondary battery that suppresses the growth of lithium dendrite, unlikely causes short circuit, and can suppress the decrease in battery voltage to a high level.

For example, furthermore, PTL 6 describes that in a sulfide solid electrolyte containing a lithium element, a phosphorus element, and a sulfur element, also containing an ester compound of a carboxylic acid and an alcohol, the ester compound is bonded or adsorbed to the surface of the conductive sulfide, enabling the enhancement of the cycle characteristics of a solid battery, and the sulfide solid electrolyte can be obtained by the production method including a step of wet-pulverizing a slurry containing a lithium ion conductive sulfide, an organic solvent, and an ester compound. PTL 7 describes a technique of enhancing the ionic conductivity by covering a sulfide solid electrolyte with a prescribed organic compound having a halogen element as a functional group as a coating agent, and PTL 8 describes a technique of enhancing the ionic conductivity and the moldability by containing a phosphorus compound, such as a phosphate ester. PTL 9 describes a production method of a solid electrolyte including mixing an anionic surfactant, which is a monomer or an oligomer of a sulfosuccinate ester salt, a benzenesulfonate salt, or the like, a solvent, and a sulfide solid electrolyte, and then removing the solvent, and a solid electrolyte containing the surfactant in a prescribed amount per unit specific surface area, and also describes that the use of the surfactant achieves a sulfide solid electrolyte that is suppressed in generation of hydrogen sulfide and coarsening of the particle diameter.

As described above, for contributing to the practical utilization of lithium ion batteries in recent years, there are diversified demands including not only the simple enhancement of the ionic conductivity of the sulfide solid electrolyte, but also the enhancement of other capabilities, such as the capability of the solid electrolyte in applying the solid electrolyte to lithium ion batteries. For addressing the demands, the current situation is that the technique of covering the surface of a solid electrolyte, the technique of forming a composition containing a solid electrolyte and an organic compound, and the like are being investigated.

### CITATION LIST

### Patent Literatures

PTL 1: JP 2020-87633 A
PTL 2: JP 2017-147173 A
PTL 3: WO 2019/151373
PTL 4: JP 2017-157300 A
PTL 5: JP 2019-067523 A
PTL 6: WO 2020/203231
PTL 7: JP 2020-087633 A
PTL 8: JP 2020-166994 A
PTL 9: WO 2021/029315

### SUMMARY OF INVENTION

### Technical Problem

The present invention has been made in view of the current situation, and an object thereof is to provide a modified sulfide solid electrolyte that is excellent in coating suitability in coating as a paste, and is capable of exerting excellent battery capabilities efficiently, and a method of producing the same, and also to provide an electrode mixture and a lithium ion battery that exert excellent battery capabilities.

### Solution to Problem

A modified sulfide solid electrolyte according to the present invention is a modified sulfide solid electrolyte containing a sulfide solid electrolyte having a BET specific surface area of 10 m²/g or more and containing a lithium atom, a sulfur atom, a phosphorus atom, and a halogen atom, and at least two kinds of compounds selected from the following compounds (A) to (I):
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups represented by —CH₂X^{1F} (wherein X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

A method of producing a modified sulfide solid electrolyte according to the present invention is
a method of producing a modified sulfide solid electrolyte, including
mixing a sulfide solid electrolyte having a BET specific surface area of 10 m²/g or more and containing a lithium atom, a sulfur atom, a phosphorus atom, and a halogen atom, an organic solvent, and at least two kinds of compounds selected from the following compounds (A) to (I), and
removing the organic solvent:
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups
represented by —CH₂X^{1F} (in which X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

An electrode mixture according to the present invention is an electrode mixture containing the modified sulfide solid electrolyte according to the present invention, and an electrode active substance.

A lithium ion battery according to the present invention is a lithium ion battery including at least one of the modified sulfide solid electrolyte according to the present invention and the electrode mixture according to the present invention.

### Advantageous Effects of Invention

The present invention can provide a modified sulfide solid electrolyte that is excellent in coating suitability in coating as a paste, and is capable of exerting excellent battery capabilities efficiently, and a method of producing the same, and also can provide an electrode mixture that exerts excellent battery capabilities and a lithium ion battery.

### BRIEF DESCRIPTION OF DRAWING

FIG. 1 is a graph showing the oil absorption (index) and the oxidation current (index) in Examples and Comparative Examples.

### DESCRIPTION OF EMBODIMENTS

An embodiment of the present invention (which may be hereinafter referred to as a “present embodiment”) is described below. In the description herein, the numerical values for the upper limit and the lower limit of the numerical ranges described with “or more”, “or less”, and “to” are numerical values that can be optionally combined, and the numerical values in the examples can be used as a numerical value for the upper limit and the lower limit.

### KNOWLEDGE OBTAINED BY PRESENT INVENTORS IN ACHIEVING PRESENT INVENTION

As a result of earnest investigations for solving the problem by the present inventors, the following matters have been found, and the present invention has been completed.

A technique of allowing a certain compound to cover a surface of a sulfide solid electrolyte or to be contained therein has existed as shown in PTLs 1 to 9. PTLs 1 to 9 use the technique, and thereby intend to enhance the battery capabilities, for example, enhancing the ionic conductivity, suppressing the decrease of the battery capacity and the battery voltage in the use thereof in a lithium ion battery, and enhancing the cycle characteristics relating to the retention of the discharge capacity in repeating discharge and charge.

In the production process of a lithium ion battery (which may be referred to as a “fully solid battery”), a paste is prepared by mixing a solid electrolyte, other prescribed components, and a solvent, and the paste is coated to form a separator layer and an electrode mixture layer. The enhancement of the capabilities of these layers requires the enhancement of the density of the solid electrolyte constituting the layers, and the use of a solid electrolyte having a large specific surface area is effective for enhancing the density.

While there is a demand for using a solid electrolyte having a large specific surface area as described above, a problem exists in production that the solid electrolyte having a large specific surface area increases the viscosity of the paste, which significantly deteriorates the coating suitability. On the other hand, the coating suitability of the paste can be improved by reducing the viscosity of the paste by using a large amount of a solvent, which however leads to a problem of prolonging the drying time, and a problem of deterioration in battery capabilities due to the reduction of the density of the solid electrolyte constituting the layers. Accordingly, there is a trade-off relationship between the coating suitability of the paste and the high battery capabilities. A sulfide solid electrolyte having a specific surface area that is as large as 10 m²/g or more not only increases the viscosity of the paste thereof, deteriorating the coating suitability, but also requires a large amount of a solvent for reducing the viscosity of the paste, resulting in the significant deterioration of the battery capabilities due to the prolongation of the drying time and the decrease of the density, as described above.

Various studies have been made for the measures for enhancing the ionic conductivity and the battery capabilities as shown in PTLs 1 to 9. However, under the current situation where the practical use of lithium ion batteries is progressing rapidly, it has been noted that there has been no study on a measure for enhancing the capabilities in the production process, such as the coating suitability of the paste, in focusing on the mass production.

The present inventors have considered the technique of allowing a certain compound to cover the surface of the solid electrolyte as described in PTLs 1 to 9, and have made earnest investigations focusing on the compound covering the surface, and it has been found that even a sulfide solid electrolyte having a large specific surface area of 10 m²/g or more can be a sulfide solid electrolyte that is excellent in coating suitability in coating in the form of paste and is capable of exerting excellent battery capabilities efficiently, by attaching a combination of multiple kinds of prescribed compounds to the surface thereof. The fact that the effect of providing the excellent coating suitability in coating a paste of a sulfide solid electrolyte having a large specific surface area of 10 m²/g or more by attaching multiple kinds of the prescribed compounds used in the present invention to the surface of the sulfide solid electrolyte can be obtained is a surprising effect that has not been recognized before.

In the description herein, the “solid electrolyte” means an electrolyte that retains a solid state at 25° C. under a nitrogen atmosphere. The “sulfide solid electrolyte” obtained by the production method of the present embodiment is a solid electrolyte that contains a lithium atom, a sulfur atom, a phosphorus atom, and a halogen atom, and has an ionic conductivity derived from the lithium atom.

The “sulfide solid electrolyte” encompasses both of a crystalline sulfide solid electrolyte having a crystal structure and an amorphous sulfide solid electrolyte. In the description herein, the crystalline sulfide solid electrolyte is a solid electrolyte that has a peak derived from a solid electrolyte observed in an X-ray diffraction pattern in a powder X-ray diffraction (XRD) measurement, irrespective of the presence or absence of a peak derived from the raw materials of the solid electrolyte therein. In other words, the crystalline solid electrolyte contains a crystal structure derived from a solid electrolyte, and a part thereof may have a crystal structure derived from the solid electrolyte or the whole thereof may have a crystal structure derived from the solid electrolyte. The crystalline sulfide solid electrolyte may contain an amorphous sulfide solid electrolyte (which may also be referred to as a “glass component”) as a part thereof, as long as having the X-ray diffraction pattern as described above. Accordingly, the crystalline sulfide solid electrolyte encompasses so-called glass ceramics, which are obtained by heating an amorphous solid electrolyte (glass component) to the crystallization temperature or higher.

In the description herein, the amorphous sulfide solid electrolyte (glass component) means a material having an X-ray diffraction pattern in an X-ray diffraction (XRD) measurement that is a halo pattern having substantially no peak other than the peaks derived from the materials, irrespective of the presence or absence of a peak derived from the raw materials of the solid electrolyte therein.

The distinction between crystallinity and amorphousity described above is applied to both of a sulfide solid electrolyte and a modified sulfide solid electrolyte in the present embodiment.

### EMBODIMENTS OF PRESENT EMBODIMENT

The modified sulfide solid electrolyte according to a first embodiment of the present embodiment is a modified sulfide solid electrolyte containing a sulfide solid electrolyte having a BET specific surface area of 10 m²/g or more and containing a lithium atom, a sulfur atom, a phosphorus atom, and a halogen atom, and at least two kinds of compounds selected from the following compounds (A) to (I).
Compound (A): a compound having one heterocyclic ring having a carbon atom and an oxygen atom
Compound (B): a compound having two or more heterocyclic rings having a carbon atom and an oxygen atom
Compound (C): an organic halide 1 (excluding the following compound (F))
Compound (D): a compound having a formyl group (CH(═O)—)
Compound (E): a compound having two or more acetyl groups (CH₃C(═O)—)
Compound (F): an organic halide 2 having two or more halogen-containing groups represented by —CH₂X^{1F} (in which X^{1F} represents a fluorine atom or a bromine atom) and an organic group
Compound (G): a thiol compound
Compound (H): a metal-free phosphorus compound (provided that the compound does not contain an oxygen atom that is bonded to a phosphorus atom via a single bond)
Compound (I): a metal-free boron compound

Typical examples of the sulfide solid electrolyte containing a lithium atom, a sulfur atom, a phosphorus atom, and a halogen atom include a sulfide solid electrolyte obtained by using lithium sulfide, diphosphorus pentasulfide, a lithium halide, an elemental halogen, and the like as raw materials. The modified sulfide solid electrolyte of the present embodiment contains a sulfide solid electrolyte having a large BET specific surface area of 10 m²/g or more, and at least two kinds of compounds selected from the compounds (A) to (I) (which may be hereinafter referred simply to as “multiple kinds of particular compounds”).

A paste containing an ordinary sulfide solid electrolyte having a large BET specific surface area of 10 m²/g or more in a content that is required for securing the density of the solid electrolyte in the layer for exerting the prescribed battery capabilities has a significantly deteriorated coating capability, and it has been extremely difficult to form a positive electrode, a negative electrode, and an electrolyte layer efficiently. The sulfide solid electrolyte of the present embodiment has a significantly enhanced coating suitability by containing the ordinary sulfide solid electrolyte and the multiple kinds of particular compounds, and in other words, should be referred to as a “modified sulfide solid electrolyte” due to the “modification”.

The multiple kinds of particular compounds used in the modified sulfide solid electrolyte of the present embodiment are common in that the compounds contain a hetero atom, such as an oxygen atom, a halogen atom, a sulfur atom, a phosphorus atom, and a boron atom. The modified sulfide solid electrolyte of the present embodiment necessarily contains a combination of multiple kinds of the particular compounds, i.e., the compound (A) to (I), among compounds containing a hetero atom. The use of the combination of multiple kinds of the particular compounds exhibits the effect of providing the excellent coating suitability in coating as a paste, and exerting the excellent battery capabilities efficiently.

Although it is unclear how the compounds (A) to (I) are contained in the modified sulfide solid electrolyte of the present embodiment, it is estimated that these compounds are attached to the surface of the sulfide solid electrolyte while retaining the structures thereof.

It has been confirmed from the examples that the sulfide solid electrolyte containing at least two kinds of compounds selected from the compounds (A) to (I) has a lower oil absorption than a sulfide solid electrolyte that does not contain the compounds. It is naturally considered that the reduction in oil absorption is derived from the multiple kinds of particular compounds that are attached to the surface of the sulfide solid electrolyte, and clog at least a part of fine pores that the sulfide solid electrolyte has. It has been known in general that the enhancement of the coating suitability relates to the oil absorption, as similar to the specific surface area. It is estimated that the attachment of the multiple kinds of particular compounds on the surface of the sulfide solid electrolyte reduces the oil absorption and enhances the coating suitability.

The details of the mode of the attachment of the multiple kinds of particular compounds on the surface of the sulfide solid electrolyte, i.e., either physical attachment or chemical attachment, are unclear. In consideration of the nature of the hetero atom, such as an oxygen atom, having a property of easily bonding to a lithium atom, a halogen atom, and the like, it is highly possible that the hetero atom contained in the compounds (A) to (I) is bonded to the lithium atom, the halogen atom, and the like constituting the sulfide solid electrolyte, and attached to the surface thereof, i.e., the chemical attachment, but in consideration of the estimations described above, it is considered that the oil absorption is reduced to enhance the coating suitability by either the chemical attachment or the physical attachment.

It is considered that the modified sulfide solid electrolyte of the present embodiment can easily reduce the oil absorption, and as a result can enhance the coating suitability, resulting in the enhancement of the battery capabilities, as long as containing the multiple kinds of particular compounds, i.e., the compounds (A) to (I), that are attached to the surface thereof through either of the attachment modes.

The modified sulfide solid electrolyte according to a second embodiment of the present embodiment is the first embodiment, wherein
the modified sulfide solid electrolyte contains at least one kind of a compound selected from the compound (B) and at least one kind of a compound selected from the compounds (A) and (C) to (I), and a third embodiment thereof is the first or second embodiments, wherein
the modified sulfide solid electrolyte contains at least one kind of a compound selected from the compound (B) and at least one kind of a compound selected from the compounds (A), (C), and (F).

In the modified sulfide solid electrolyte of the present embodiment, the use of the at least two kinds of compounds selected from the compounds (A) to (I) exhibits the effect of providing the excellent coating suitability in coating the paste and being capable of exhibiting the excellent battery capabilities efficiently, and in particular, the combination use of at least one kind of a compound selected from the compound (A) and at least one kind of a compound selected from the compounds (B) to (I), and furthermore the combination use of at least one kind of a compound selected from the compound (A) and at least one kind of a compound selected from the compounds (A), (C), and (F), can further enhance the coating suitability, and can exert the excellent battery capabilities more efficiently. The compound (B) is a compound that exerts a further excellent effect on the exertion of the oxidation resistance among the compounds (A) to (I), and the other compounds (A) and (C) to (I) each are a compound that exerts a further excellent effect on the reduction of the oil absorption. Therefore, the combination use of the compound (B) and the other compounds (A) and (C) to (I) can enhance the coating suitability through the reduction of the oil absorption, can enhance the battery capabilities through the enhancement of the density of the solid electrolyte, and can expect the enhancement of the oxidation resistance, which is one of the battery capabilities.

The oxidation resistance is a capability of the solid electrolyte to resist oxidation, and the enhancement of the oxidation resistance means that the oxidation current measured through the cyclic voltammetry (CV measurement (oxidation current measurement)) described later is further reduced. The use of the at least two kinds of compounds selected from the compounds (A) to (I) expects not only the enhancement of the battery capabilities through the reduction of the oil absorption, but also the enhancement of the battery capabilities through the enhancement of the oxidation resistance, and the enhancement of the battery capabilities through the enhancement of the oxidation resistance can be further expected through the combination defined in the second and third embodiments.

The modified sulfide solid electrolyte according to a fourth embodiment of the present embodiment is at least one embodiment of the first to third embodiments, in which the heterocyclic ring having a carbon atom and an oxygen atom of the compounds (A) and (B) is an oxirane ring.

The compounds (A) and (B) used may be any compound that has a heterocyclic ring with no particular limitation, and thus the excellent coating suitability can be obtained thereby. In particular, in the case where an oxirane ring is used as the heterocyclic ring, i.e., in the case where a compound having one or two or more oxirane rings is used, it is considered that the compounds (A) and (B) can be easily attached to the sulfide solid electrolyte, and thereby the oil absorption is further reduced, the excellent coating suitability can be easily obtained, and the excellent battery capabilities can be obtained more efficiently.

The modified sulfide solid electrolyte according to a fifth embodiment of the present embodiment is at least one embodiment of the first to fourth embodiments, in which
the compound (C) is at least one kind of a compound selected from a compound having one group represented by —CH₂X^{1C} (in which X^{1C} represents a halogen atom), a compound having a halogenated formyl group (CX^{1C}(═O)— (in which X^{1C} represents a halogen atom), and a compound having a halogenated silyl group (—SiX^{1C}n_{1C} (in which X^{1C} represents a halogen atom, and n_{1C} represents an integer of 1 to 3).

The compound (C) used may be any organic halide, i.e., an organic compound having a halogen atom as a part thereof, excluding the compound (F) described later, with no particular limitation, and thus the excellent coating suitability can be obtained thereby. In the case where the compound (C) used is a compound having at least one kind selected from the aforementioned three halogen atom-containing groups as the organic halide excluding the compound (F), it is considered that the compound (C) can be easily attached to the sulfide solid electrolyte, and thereby the oil absorption is further reduced, the excellent coating suitability can be easily obtained, and the excellent battery capabilities can be obtained more efficiently.

As for the compound (C), the compound having one group represented by —CH₂X^{1C} (wherein X^{1C} represents a halogen atom) does not have two or more halogen-containing groups represented by —CH₂X^{1F} (in which X^{1F} represents a fluorine atom or a bromine atom), and therefore does not correspond to the compound (F). The compound having a halogenated formyl group and the compound having a halogenated silyl group do not correspond to the compound (F), and therefore a compound having two or more halogen-containing groups represented by —CH₂X^{1F} (in which X^{1F} represents a fluorine atom or a bromine atom) is excluded therefrom.

The modified sulfide solid electrolyte according to a sixth embodiment of the present embodiment is the fourth or fifth embodiments, in which
the compound (A) is at least one kind of a compound selected from an epoxy compound 1A represented by the following general formula (1A), an epoxy compound 2A represented by the following general formula (2A), and an epoxy compound 3A represented by the following general formula (3A).

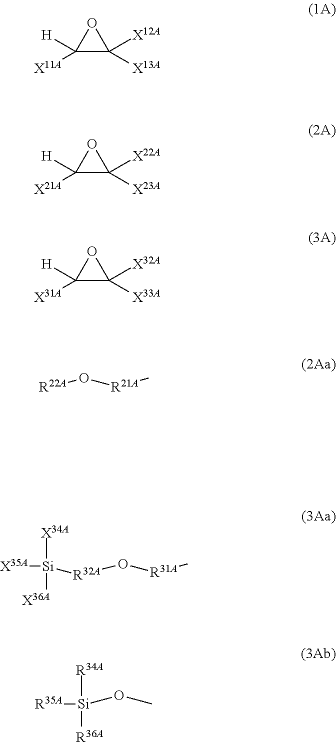

The general formulae will be described later.

The compound (A) used may be any compound that has a heterocyclic ring with no particular limitation, i.e., the excellent coating suitability can be obtained thereby. In particular, in the case where an oxirane ring is used as the heterocyclic ring, i.e., in the case where a compound having one oxirane ring is used, it is considered that the compound (A) can be easily attached to the sulfide solid electrolyte, and thereby the oil absorption is further reduced, the excellent coating suitability can be easily obtained, and the excellent battery capabilities can be obtained more efficiently.

It is considered that the attachment of the compound (A) is preferably moderate attachment since the moderate attachment enhances the coating suitability through the reduction effect of the oil absorption, resulting in the enhancement of the battery capabilities, and on the other hand, suppresses the decrease of the ionic conductivity, and suppresses the decrease of the enhancing effect of the battery capabilities by the enhancement of the coating suitability. For these effects, the compound (A) is preferably the compound having the particular structure represented by the aforementioned general formulae since it is considered that the moderate steric hindrance provides the moderate chemical or physical attachment state.

The modified sulfide solid electrolyte according to a seventh embodiment of the present embodiment is at least one embodiment of the fourth to sixth embodiments, wherein
the compound (B) is an epoxy compound having two or more groups selected from an epoxy group, a glycidyl group, and a glycidyl ether group represented by the following general formula (1B).

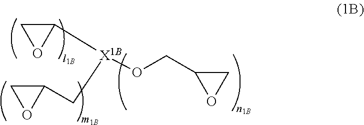

The general formula will be described later.

The compound (B) used may be any compound that has heterocyclic rings with no particular limitation, i.e., the excellent coating suitability can be obtained thereby. In particular, in the case where an oxirane ring is used as the heterocyclic ring, i.e., in the case where a compound having two or more oxirane rings, more specifically a compound having any of an epoxy group, a glycidyl group, and a glycidyl ether group as the group having an oxirane ring, is used, it is considered that the compound (B) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formula above is used as the compound (B), it is considered that the moderate steric hindrance thereof provides the moderate chemical or physical attachment state, as described for the compound (A) above. Consequently, the oil absorption is reduced, the excellent coating suitability can be easily obtained, and the excellent battery capabilities can be obtained more efficiently.

The modified sulfide solid electrolyte according to an eighth embodiment of the present embodiment is at least one embodiment of the fifth to seventh embodiments, in which
the compound (C) is at least one kind of a compound selected from an organic halide 1a represented by the following general formula (1C), an organic halide 1b represented by the following general formula (2C), an organic halide 1c represented by the following general formula (3C), and an organic halide 1d represented by the following general formula (4C).

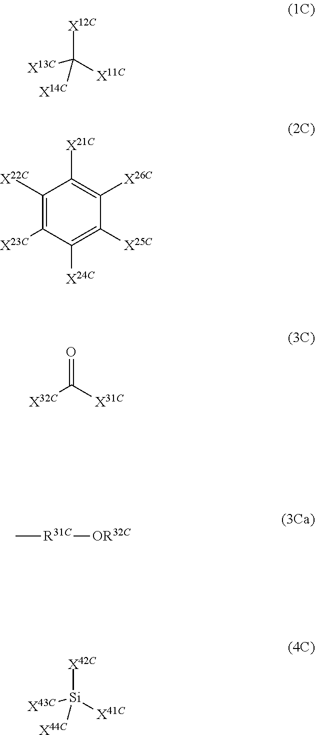

The general formulae will be described later.

The compound (C) used may be any organic halide, i.e., an organic compound having a halogen atom as a part thereof, excluding the compound (F) described later, with no particular limitation, and thus the excellent coating suitability can be obtained thereby. In particular, in the case where the compound represented by the general formulae is used, it is considered that the compound (C) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formulae is used as the compound (C), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

As described in the fifth embodiment, the compound (C) corresponds to any of a compound having one group represented by —CH₂X^{1C} (wherein X^{1C} represents a halogen atom), a compound having a halogenated formyl, and a compound having a halogenated silyl group. Typically, the compound represented by the general formulae (1C) and (2C) corresponds to the compound having one group represented by —CH₂X^{1C} (in which X^{1C} represents a halogen atom), the compound represented by the general formula (3C) corresponds to the compound having a halogenated formyl group, and the compound represented by the general formula (4C) corresponds to the compound having a halogenated silyl group. With regard to the term “typically” used herein in consideration, for example, in the case where the aliphatic hydrocarbon group represented by X^{31C} or X^{32C} in the general formula (3C) is a group in which one hydrogen atom bonded to the end carbon atom thereof is replaced by a halogen atom, the compound may be a compound having a halogenated formyl group and one group represented by —CH₂X^{1C} (in which X^{1C} represents a halogen atom), i.e., the compound represented by the general formula (3C) may correspond to the compound having one group represented by —CH₂X^{1C} (in which X^{1C} represents a halogen atom).

The modified sulfide solid electrolyte according to a ninth embodiment of the present embodiment is at least one embodiment of the first to eighth embodiments, in which
the compound (D) is a compound represented by the following general formula (1D).

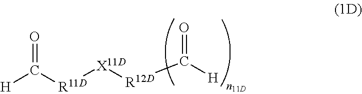

The general formula will be described later.

The compound (D) used may be any compound that has a formyl group (CH(═O)—) with no particular limitation, and thus the excellent coating suitability can be obtained thereby. In particular, in the case where the compound represented by the general formula above is used, it is considered that the compound (D) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formula above is used as the compound (D), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to a tenth embodiment of the present embodiment is at least one embodiment of the first to ninth embodiments, in which
the compound (E) is a compound represented by the following general formula (1E).

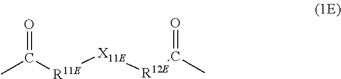

The general formula will be described later.

The compound (E) used may be any compound that has two or more acetyl groups (CH₃C(═O)—) with no particular limitation, and thus the excellent coating suitability can be obtained thereby. In particular, in the case where the compound represented by the general formula above is used, it is considered that the compound (E) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formula above is used as the compound (E), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to an eleventh embodiment of the present embodiment is at least one embodiment of the first to tenth embodiments, in which
the compound (F) is a compound represented by the following general formula (1F).

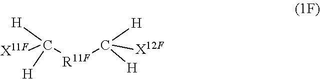

The general formula will be described later.

The compound (F) used may be any compound that two or more halogen-containing groups represented by —CH₂X^{1F} (in which X^{1F} represents a fluorine atom or a bromine atom) and an organic group with no particular limitation, and thus the excellent coating suitability can be obtained thereby. In particular, in the case where the compound represented by the general formula above is used, it is considered that the compound (F) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formula above is used as the compound (F), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to a twelfth embodiment of the present embodiment is at least one embodiment of the first to eleventh embodiments, in which
the compound (G) is at least one kind of a compound selected from a thiol compound 1 represented by the following general formula (1G) and a thiol compound 2 represented by the following general formula (2G).

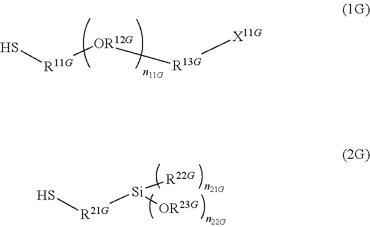

The general formulae will be described later.

The compound (G) used may be any thiol compound, i.e., any compound that has a thiol group, with no particular limitation, and thus the excellent coating suitability can be obtained thereby. In particular, in the case where the compound represented by the general formula above is used, it is considered that the compound (G) can be easily attached to the sulfide solid electrolyte, and thereby the oil absorption is further reduced, the excellent coating suitability can be easily obtained, and the excellent battery capabilities can be obtained more efficiently.

In the case where the compound having the particular structure represented by the general formulae above is used as the compound (G), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to a thirteenth embodiment of the present embodiment is at least one embodiment of the first to twelfth embodiments, in which
the compound (H) is at least one kind of a compound selected from a metal-free phosphorus compound 1H represented by the following general formula (1H), a metal-free phosphorus compound 2H represented by the following general formula (2H), and a metal-free phosphorus compound 3H represented by the following general formula (3H).

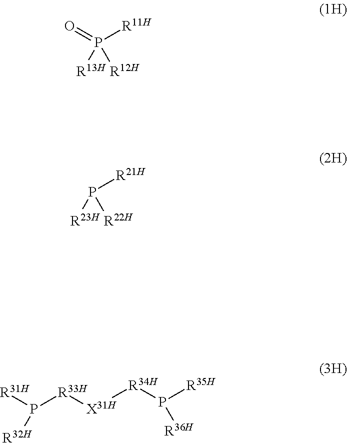

The general formulae will be described later.

The compound (H) used may be any metal-free phosphorus compound (provided that the compound does not contain an oxygen atom that is bonded to a phosphorus atom via a single bond) with no particular limitation, and thus the excellent coating suitability can be obtained thereby. In particular, in the case where the compound represented by the general formulae above is used, it is considered that the compound (H) can be easily attached to the sulfide solid electrolyte, the oil absorption is further reduced, and the excellent coating suitability can be easily obtained, by which the excellent battery capabilities can be obtained more efficiently.

In the case where the compound having the particular structure represented by the general formulae above is used as the compound (H), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to a fourteenth embodiment of the present embodiment is at least one embodiment of the first to thirteenth embodiments, in which
the compound (I) is a compound represented by the following general formula (1I).

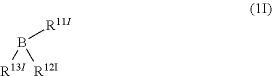

The general formulae will be described later.

The compound (I) used may be any a metal-free boron compound with no particular limitation, and thus the excellent coating suitability can be obtained thereby. In particular, in the case where the compound represented by the general formula above is used, it is considered that the compound (I) can be easily attached to the sulfide solid electrolyte, the oil absorption is further reduced, and the excellent coating suitability can be easily obtained, by which the excellent battery capabilities can be obtained more efficiently.

In the case where the compound having the particular structure represented by the general formulae above is used as the compound (I), it is considered that the moderate steric hindrance thereof provides the moderate chemical or physical attachment state, as described for the compound (A) above, and consequently, the oil absorption is reduced, the excellent coating suitability can be easily obtained, and the excellent battery capabilities can be obtained more efficiently.

The modified sulfide solid electrolyte according to a fifteenth embodiment of the present embodiment is at least one embodiment of the first to fourteenth embodiments, in which the modified sulfide solid electrolyte has a content of the at least two kinds of compounds of 0.03 part by mass or more and 25 parts by mass or less per 100 parts by mass of the sulfide solid electrolyte.

In the case where the content of the at least two kinds of compounds selected from the compounds (A) to (I) is 0.03 part by mass or more and 25 parts by mass or less per 100 parts by mass of the sulfide solid electrolyte, the compounds are moderately dispersed and attached to the surface of the sulfide solid electrolyte to reduce the oil absorption and to retain the proper ionic conductivity, and thereby the coating suitability can be easily enhanced, and the excellent battery capabilities can be obtained efficiently. As for the content of the compounds, the amount of the compounds used in producing the modified sulfide solid electrolyte can be used as the content of the compounds.

A method of producing a modified sulfide solid electrolyte according to a sixteenth embodiment of the present embodiment includes
mixing a sulfide solid electrolyte having a BET specific surface area of 10 m²/g or more and containing a lithium atom, a sulfur atom, a phosphorus atom, and a halogen atom, an organic solvent, and at least two kinds of compounds selected from the following compounds (A) to (I), and
removing the organic solvent:
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups represented by —CH₂X^{1F} (in which X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

The production method of the modified sulfide solid electrolyte of the present embodiment is not particularly limited, as far as containing at least two kinds of compounds selected from the compounds (A) to (I) as described above, and according to the method of producing a modified sulfide solid electrolyte according to the sixteenth embodiment of the present embodiment, the at least two kinds of compounds selected from the compounds (A) to (I) can exist to attach to the surface of the sulfide solid electrolyte in view of the features thereof, and thereby the modified sulfide solid electrolyte is excellent in coating suitability and exerts the excellent battery capabilities efficiently, and the modified sulfide solid electrolyte of the present embodiment can be produced more efficiently.

While a mixture in the form of solution or slurry is obtained by mixing the sulfide solid electrolyte, the at least two kinds of compounds selected from the compounds (A) to (I), and the solvent, the modified sulfide solid electrolyte cannot be used as it is, and therefore the removal of the organic solvent from the solution or slurry is included.

The method of producing a modified sulfide solid electrolyte according to a seventeenth embodiment of the present embodiment is the production method according to the sixteenth embodiment, in which the organic solvent used therein is at least one kind of a solvent selected from an aliphatic hydrocarbon solvent, an alicyclic hydrocarbon solvent, an aromatic hydrocarbon solvent, an ether solvent, an ester solvent, and a nitrile solvent.

The use of the solvents above as the organic solvent can facilitate the attachment of the multiple kinds of particular compounds to the surface of the sulfide solid electrolyte, and can easily enhance the coating suitability.

An electrode mixture according to an eighteenth embodiment of the present embodiment contains the modified sulfide solid electrolyte according to any one of the first to fifteenth embodiments and an electrode active substance.

A lithium ion battery according to a nineteenth embodiment of the present embodiment includes at least one of the modified sulfide solid electrolyte according to any one of the first to fifteenth embodiments and the electrode mixture according to the eighteenth embodiment.

As described above, the modified sulfide solid electrolyte of the present embodiment is excellent in coating suitability in coating as a paste, and can exert the excellent battery capabilities efficiently. Accordingly, the electrode mixture containing the modified sulfide solid electrolyte of the present embodiment is also excellent in coating suitability, and can produce a lithium ion battery efficiently, and the resulting lithium ion battery has the excellent battery capabilities.

### [Modified Sulfide Solid Electrolyte]

The modified sulfide solid electrolyte of the present embodiment contains a sulfide solid electrolyte having a BET specific surface area of 10 m²/g or more and containing a lithium atom, a sulfur atom, a phosphorus atom, and a halogen atom, and at least two kinds of compounds selected from the following compounds (A) to (I):
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups represented by —CH₂X^{1F} (in which X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

The compounds (A) to (I) contained in the modified sulfide solid electrolyte of the present embodiment will be described below.

### (Compound (A))

The compound (A) used in the modified sulfide solid electrolyte of the present embodiment is a compound having one heterocyclic ring having a carbon atom and an oxygen atom (which may also be referred to as a “heteromonocyclic compound”).

Preferred examples of the heterocyclic ring having a carbon atom and an oxygen atom of the compound (A) include a heterocyclic ring of a saturated or unsaturated monocyclic oxygen-containing heterocyclic compound, such as oxirane, oxetane, tetrahydrofuran, dihydrofuran, furan, dioxolane, tetrahydropyran, and pyran. The heterocyclic ring contained reduces the oil absorption, easily provides the excellent coating suitability, and provides the excellent battery capabilities more efficiently.

Among the heterocyclic rings, the heterocyclic ring of oxirane, i.e., an oxirane ring, is preferred in consideration of the availability. Therefore, the heteromonocyclic compound as the compound (A) used in the present embodiment is preferably a compound having one oxirane ring, and particularly preferred examples thereof include an epoxy compound 1A represented by the following general formula (1A), an epoxy compound 2A represented by the following general formula (2A), and an epoxy compound 3A represented by the following general formula (3A). In the modified sulfide solid electrolyte of the present embodiment, the compounds represented by the general formulae may be used alone as the compound (A), or multiple kinds thereof may be used in combination (for example, multiple kinds of the compounds represented by the general formula (1A) may be used in combination).

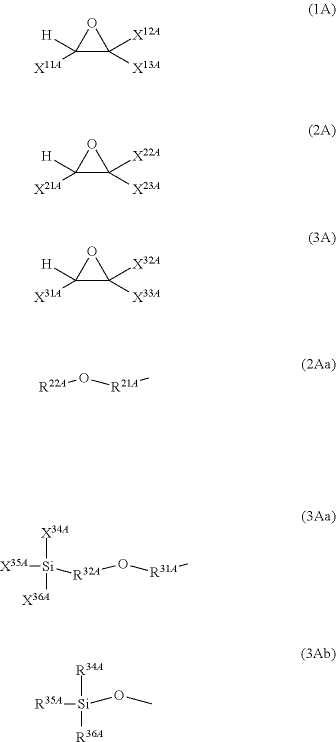

### (Epoxy Compound 1A)

The epoxy compound 1A is a compound represented by the general formula (1A).

In the general formula (1A), X^{11A} to X^{13A} each independently represent a hydrogen atom, a halogen atom, a hydrocarbon group, or a halogenated hydrocarbon group, and at least one of X^{11A} to X^{13A} represents a hydrocarbon group or a halogenated hydrocarbon group.

The hydrocarbon group represented by X^{11A} to X^{13A} is a monovalent hydrocarbon group, examples of which include an aliphatic hydrocarbon group, an alicyclic hydrocarbon group, and an aromatic hydrocarbon group, in which an aliphatic hydrocarbon group and an alicyclic hydrocarbon group are preferred, and an aliphatic hydrocarbon group is more preferred.

Preferred examples of the aliphatic hydrocarbon group include an alkyl group and an alkenyl group, in which an alkyl group is preferred. The number of carbon atoms of the aliphatic hydrocarbon group for an alkyl group is preferably 1 or more, more preferably 2 or more, further preferably 4 or more, and still further preferably 6 or more, and the upper limit thereof is preferably 24 or less, more preferably 20 or less, and further preferably 16 or less. That for an alkenyl group is 2 or more, and preferably 4 or more, and the upper limit thereof is preferably 24 or less, more preferably 20 or less, and further preferably 16 or less.

The aliphatic hydrocarbon group represented by X^{11A} to X^{13A} may be either linear or branched, and is preferably linear. The aliphatic hydrocarbon group may be partially substituted by a hydroxy group and the like. Multiple groups represented by X^{11A} to X^{13A} are aliphatic hydrocarbon groups, the multiple aliphatic hydrocarbon groups may be the same as or different from each other.

Preferred examples of the alicyclic hydrocarbon represented by X^{11A} to X^{13A} include a cycloalkyl group and a cycloalkenyl group, in which a cycloalkyl group is preferred. The number of carbon atoms of the alicyclic hydrocarbon group is 3 or more, and preferably 4 or more, and the upper limit thereof is preferably 12 or less, more preferably 8 or less, and further preferably 6 or less.

The alicyclic hydrocarbon group represented by X^{11A} to X^{13A} may be partially substituted by a hydroxy group, the aliphatic hydrocarbon group above (such as an alkyl group and an alkenyl group), and the like. Multiple groups represented by X^{11A} to X^{13A} are alicyclic hydrocarbon groups, the multiple alicyclic hydrocarbon groups may be the same as or different from each other.

Examples of the aromatic hydrocarbon group represented by X^{11A} to X^{13A} include a phenyl group, a naphthyl group, a biphenylyl group, a diphenylmethyl group, a trityl group, an anthracenyl group, a perylenyl group, and a pyrenyl group.

The aromatic hydrocarbon group represented by X^{11A} to X^{13A} may be partially substituted by a hydroxy group, the aliphatic hydrocarbon group above (such as an alkyl group and an alkenyl group), and the like. Multiple groups represented by X^{11A} to X^{13A} are aromatic hydrocarbon groups, the multiple aromatic hydrocarbon groups may be the same as or different from each other.

Examples of the halogenated hydrocarbon group represented by X^{11A} to X^{13A} include groups obtained by partially substituting the hydrocarbon groups described for the hydrocarbon groups represented by X^{11A} to X^{13A} by a halogen atom. Among the hydrocarbon groups, the hydrocarbon group to be substituted by a halogen atom is preferably an aliphatic hydrocarbon group or an alicyclic hydrocarbon group, in which an aliphatic hydrocarbon group is preferred, and an alkyl group is more preferred.

The halogen atom contained in the halogenated hydrocarbon group represented by X^{11A} to X^{13A} is preferably fluorine, chlorine, bromine, or iodine, more preferably fluorine, chlorine, or bromine, and further preferably fluorine.

The number of the halogen atom in the halogenated hydrocarbon group cannot be determined unconditionally since it may vary depending on the number of carbon atoms of the hydrocarbon group, and is preferably 1 or more, more preferably 2 or more, further preferably 3 or more, and still further preferably 6 or more, and the upper limit thereof is preferably 16 or less, more preferably 12 or less, and further preferably 9 or less.

The halogen atom represented by X^{11A} to X^{13A} is preferably fluorine, chlorine, bromine, or iodine, more preferably fluorine, chlorine, or bromine, and further preferably fluorine, as similar to the halogen atom contained in the halogenated hydrocarbon group.

At least one of X^{11A} to X^{13A} represents a hydrocarbon group or a halogenated hydrocarbon group, i.e., one, two, or three of X^{11A} to X^{13A} may represent a hydrocarbon group or a halogenated hydrocarbon group, and it is preferred that one thereof represents a hydrocarbon group or a halogenated hydrocarbon group from the standpoint of enhancing the coating suitability.

The epoxy compound 1A represented by the general formula (1A) is preferably a compound, in which X^{11A} represents a hydrocarbon group having 1 to 24 carbon atoms or a halogenated hydrocarbon group having 1 to 24 carbon atoms, and X^{12A} and X^{13A} represent hydrogen atoms, in which the hydrocarbon group is preferably an aliphatic hydrocarbon group, more preferably an alkyl group or an alkenyl group, and further preferably an alkyl group, as described above. The number of carbon atoms for the alkyl group is preferably 1 or more, more preferably 2 or more, further preferably 4 or more, and still further preferably 6 or more, and the upper limit thereof is preferably 24 or less, more preferably 20 or less, and further preferably 16 or less, as described above.

The halogenated hydrocarbon carbon group is preferably a group, in which three halogen atoms are bonded to the carbon atom at the end (which is the opposite end to the carbon atom bonded to the oxirane ring) (i.e., all the hydrogen atoms bonded to the carbon atom are replaced by halogen atoms). Examples of the halogenated hydrocarbon group of this type include a group obtained by removing one hydrogen atom from 2,2,3,3,4,4,5,5,6,6,7,7,7-tridecafluoroheptane, which has heptane as the basic structure of the aliphatic group, in which 13 hydrogen atoms are replaced by fluorine atoms (i.e., a 1-2,2,3,3,4,4,5,5,6,6,7,7,7-octafluorohexyl group).

In the case where X^{11A} to X^{13A} represent a halogenated hydrocarbon group, there may be a case where the epoxy compound 1A is a compound capable of being referred to as an organic halide as the compounds (C) and (F) described later. In the description herein, however, a compound having one heterocyclic ring having a carbon atom and an oxygen atom is regarded as a compound corresponding to the compound (A), but is not regarded as an organic halide as the compounds (C) and (F). Accordingly, in the case where X^{11A} to X^{13A} represent a halogenated hydrocarbon group, the compound (A) does not correspond to the compounds (C) and (F) described later, and these compounds are excluded therefrom. As for the epoxy compounds 2A and 3A described later, there may be a case where the compound has a halogen atom as a part thereof (for example, the case where the compound has a halogenated hydrocarbon group), and in this case, the epoxy compounds 2A and 3A are handled as similar to the epoxy compound 1A herein.

### (Epoxy Compound 2A)

The epoxy compound 2A is a compound represented by the general formula (2A).

In the general formula (2A), X^{21A} to X^{23A} each independently represent a hydrogen atom, a halogen atom, a hydrocarbon group, a halogenated hydrocarbon group, or a group represented by the general formula (2Aa), and at least one of X^{21A} to X^{23A} represents a group represented by the general formula (2Aa). In the general formula (2Aa), R^{21A} represents a divalent hydrocarbon group, and R^{22A} represents a hydrogen atom, a halogen atom, a hydrocarbon group, or a halogenated hydrocarbon group.

Examples of the hydrocarbon group represented by X^{21A} to X^{23A} include the same groups as the aliphatic hydrocarbon group, the alicyclic hydrocarbon group, and the aromatic hydrocarbon group as described for the hydrocarbon group represented by X^{11A} to X^{13A}, in which an aliphatic hydrocarbon group and an alicyclic hydrocarbon group are preferred, and an aliphatic hydrocarbon group is more preferred. In the aliphatic hydrocarbon group, an alkyl group and an alkenyl group are more preferred, and an alkyl group is further preferred.

Examples of the halogenated hydrocarbon group represented by X^{21A} to X^{23A} include the same groups as described for the halogenated hydrocarbon group represented by X^{11A} to X^{13A}, and examples of the halogen atom also include those described for the hydrocarbon group represented by X^{11A} to X^{13A}.

At least one of X^{21A} to X^{23A} represents a group represented by the general formula (2Aa). Specifically, one, two, or three of X^{21A} to X^{23A} may represent a group represented by the general formula (2Aa), and it is preferred that one thereof represents the group.

In the group represented by the general formula (2Aa) in X^{21A} to X^{23A}, examples of the divalent hydrocarbon group represented by R^{21A} include hydrocarbon groups obtained by removing one hydrogen atom from the hydrocarbon groups represented by X^{21A} to X^{23A} Accordingly, examples of the divalent group represented by R^{21A} include a divalent aliphatic hydrocarbon group, a divalent alicyclic hydrocarbon group, and a divalent aromatic hydrocarbon group, in which an aliphatic hydrocarbon group and an alicyclic hydrocarbon group are preferred, and an aliphatic hydrocarbon group is more preferred.

The divalent hydrocarbon group is preferably an alkanediyl group or an alkenediyl group, more preferably an alkanediyl group. The number of carbon atoms of the alkanediyl group is preferably 1 or more, and the upper limit thereof is preferably 8 or less, more preferably 6 or less, further preferably 4 or less, and still further preferably 2 or less. The number of carbon atoms of the alkenediyl group is preferably 2 or more, and the upper limit thereof is the same as in the alkanediyl group.

In the group represented by the general formula (2Aa) in X^{21A} to X^{23A}, examples of the monovalent hydrocarbon group represented by R^{22A} include the same groups as the monovalent hydrocarbon group represented by X^{21A} to X^{23A}, i.e., a monovalent aliphatic hydrocarbon group, a monovalent alicyclic hydrocarbon group, and a monovalent aromatic hydrocarbon group, in which an aliphatic hydrocarbon group and an aromatic hydrocarbon group are preferred.

The aliphatic hydrocarbon group is preferably an alkyl group or an alkenyl group, and more preferably an alkyl group, and the aliphatic hydrocarbon group may be either linear or branched. In the case where the aliphatic hydrocarbon group is an alkyl group, the number of carbon atoms thereof is preferably 1 or more, more preferably 2 or more, and further preferably 4 or more, and the upper limit thereof is preferably 24 or less, more preferably 16 or less, further preferably 12 or less, and still further preferably 10 or less.

Preferred examples of the aromatic hydrocarbon group include a phenyl group, a biphenylyl group, a diphenylmethyl group, and a trityl group, in which a phenyl group, a diphenylmethyl group, and a trityl group are more preferred, and a phenyl group and a trityl group are further preferred. The aromatic hydrocarbon group may be substituted by a halogen atom, a hydroxy group, a monovalent aliphatic hydrocarbon group (such as an alkyl group or an alkenyl group), and the like.

Examples of the halogenated hydrocarbon group represented by R^{22A} include a group obtained by partially substituting the hydrocarbon group represented by R^{22A} by a halogen atom. The halogen atom contained in the halogenated hydrocarbon group represented by R^{22A} and the halogen atom represented by R²² are preferably fluorine, chlorine, bromine, or iodine, more preferably fluorine, chlorine, or bromine, and further preferably fluorine.

The epoxy compound 2A represented by the general formula (2A) is preferably a compound, in which X^{21A} represents a group represented by the general formula (2Aa), X^{22A} and X^{23A} represent hydrogen atoms, and in the general formula (2Aa), R^{21A} represents a hydrocarbon group having 1 to 8 carbon atoms, and R^{22A} represents a hydrocarbon group having 1 to 24 carbon atoms, in which the divalent hydrocarbon group represented by R^{21A} and the hydrocarbon group represented by R^{22A} are as described above.

In the case where the monovalent hydrocarbon group represented by R^{22A} is a phenyl group, the phenyl group is preferably substituted by a monovalent aliphatic hydrocarbon group, and more preferably substituted by an alkyl group. The number of carbon atoms of the alkyl group is preferably 1 or more, more preferably 2 or more, and further preferably 4 or more, and the upper limit thereof is preferably 24 or less, more preferably 12 or less, further preferably 8 or less, and still further preferably 6 or less. In this case, the aliphatic hydrocarbon group may be either linear or branched, and is preferably branched. Among these, R^{22A} preferably represents an aliphatic hydrocarbon group having a quaternary carbon atom, and particularly preferably a tert-butyl group.

### (Epoxy Compound 3A)

The epoxy compound 3A is a compound represented by the general formula (3A).

In the general formula (3A), X^{31A} to X^{33A} each independently represent a hydrogen atom, a halogen atom, a hydrocarbon group, a halogenated hydrocarbon group, or a group represented by the general formula (3Aa), and at least one of X^{31A} to X^{33A} represents a group represented by the general formula (3Aa). In the general formula (3Aa), R^{31A} and R^{32A} each independently represent a single bond or a divalent hydrocarbon group, and X^{34A} to X^{36A} each independently represent a hydrogen atom, a halogen atom, a hydrocarbon group, a halogenated hydrocarbon group, —OR^{33A}, or a group represented by the general formula (3Ab). R^{33A} to R^{36A} each independently represent a hydrogen atom, a halogen atom, a hydrocarbon group, or a halogenated hydrocarbon group.

Examples of the hydrocarbon group represented by X^{31A} to X^{33A} include the same groups as the monovalent aliphatic hydrocarbon group, the monovalent alicyclic hydrocarbon group, and the monovalent aromatic hydrocarbon group as described for the hydrocarbon group represented by X^{11A} to X^{13A}, in which an aliphatic hydrocarbon group and an alicyclic hydrocarbon group are preferred, and an aliphatic hydrocarbon group is more preferred. In the aliphatic hydrocarbon group, an alkyl group and an alkenyl group are more preferred, and an alkyl group is further preferred.

Examples of the halogenated hydrocarbon group represented by X^{31A} to X^{33A} include the same groups as described for the halogenated hydrocarbon group represented by X^{11A} to X^{13A}, and examples of the halogen atom also include those described for the hydrocarbon group represented by X^{11A} to X^{13A}.

At least one of X^{31A} to X^{33A} represents a group represented by the general formula (3Aa). Specifically, one, two, or three of X^{31A} to X^{33A} may represent a group represented by the general formula (3Aa), and it is preferred that one thereof represents the group.

In the group represented by the general formula (3Aa) in X^{31A} to X^{33A}, examples of the divalent hydrocarbon group represented by R^{31A} and R^{32A} include hydrocarbon groups obtained by removing one hydrogen atom from the monovalent hydrocarbon groups represented by X^{31A} to X^{33A}. Accordingly, examples of the divalent group represented by R^{31A} include a divalent aliphatic hydrocarbon group, a divalent alicyclic hydrocarbon group, and a divalent aromatic hydrocarbon group, in which an aliphatic hydrocarbon group and an alicyclic hydrocarbon group are preferred, and an aliphatic hydrocarbon group is more preferred.

The divalent hydrocarbon group is preferably an alkanediyl group or an alkenediyl group, more preferably an alkanediyl group. The number of carbon atoms of the alkanediyl group is preferably 1 or more, and the upper limit thereof is preferably 8 or less, more preferably 6 or less, further preferably 4 or less, and still further preferably 2 or less. The number of carbon atoms of the alkenediyl group is preferably 2 or more, and the upper limit thereof is the same as in the alkanediyl group.

Examples of the hydrocarbon group and the halogenated hydrocarbon represented by X^{34A} to X^{36A} include the same groups as described for the monovalent hydrocarbon group and the halogenated hydrocarbon group represented by X^{31A} to X^{33A}.

Examples of the hydrocarbon group and the halogenated hydrocarbon represented by R^{33A} in —OR^{33A} in X^{34A} to X^{36A} and R^{34A} to R^{36A} in the general formula (3Ab) also include the same groups as described for the hydrocarbon group and the halogenated hydrocarbon group represented by X^{34A} to X^{36A}.

The epoxy compound 3A represented by the general formula (3A) is preferably a compound, in which X^{31A} represents a group represented by the general formula (3Aa), X^{32A} and X^{33A} represent hydrogen atoms, in the general formula (3Aa), R^{31A} represents a divalent hydrocarbon group having 1 to 8 carbon atoms, R^{32A} represents a divalent hydrocarbon group having 1 to 8 carbon atoms, X^{34A} and X^{36A} represent groups represented by the general formula (3Ab), X^{35A} represents a hydrocarbon group having 1 to 24 carbon atoms, and in the general formula (3Ab), R^{34A} to R^{36A} represent hydrocarbon group having 1 to 24 carbon atoms.

In this case, the divalent hydrocarbon group represented by R^{31A} and R^{32A} is as described above, and the number of carbon atoms of the divalent hydrocarbon group represented by R^{31A} is preferably 1 or more, and the upper limit thereof is preferably 8 or less, more preferably 6 or less, further preferably 4 or less, and still further preferably 2 or less. The number of carbon atoms of the divalent hydrocarbon group represented by R^{32A} is preferably 1 or more, and more preferably 2 or more, and the upper limit thereof is preferably 8 or less, more preferably 6 or less, and further preferably 4 or less. The hydrocarbon group represented by X^{35A} and R^{34A} to R^{36A} is as described above, and the number of carbon atoms of the hydrocarbon group represented by X^{35A} is preferably 1 or more, and the upper limit thereof is preferably 24 or less, more preferably 12 or less, further preferably 8 or less, still further preferably 4 or less, and particularly preferably 2 or less. The number of carbon atoms of the hydrocarbon group represented by R^{34A} to R^{36A} is the same as the number of carbon atoms of the hydrocarbon group represented by X^{35A}.

The epoxy compound 3A represented by the general formula (3A) is preferably a compound, in which X^{31A} represents a group represented by the general formula (3Aa), X^{22A} and X^{23A} represent hydrogen atoms, in the general formula (3Aa), R^{31A} represents a hydrocarbon group having 1 to 8 carbon atoms, R^{32A} represents a single bond, and X^{34A} to X^{36A} represent hydrocarbon group having 1 to 24 carbon atoms.

In this case, the hydrocarbon group represented by R^{31A} is as described above, and the number of carbon atoms of the hydrocarbon group represented by R^{31A} is preferably 1 or more, and the upper limit thereof is preferably 8 or less, more preferably 6 or less, further preferably 4 or less, and still further preferably 2 or less. The hydrocarbon group represented by X^{34A} to X^{36A} is as described above, and the number of carbon atoms of the hydrocarbon group represented by X^{34A} and X^{36A} is preferably 1 or more, and the upper limit thereof is preferably 24 or less, more preferably 12 or less, further preferably 8 or less, still further preferably 4 or less, and particularly preferably 2 or less. The number of carbon atoms of the monovalent hydrocarbon group represented by X^{35A} is preferably 1 or more, more preferably 2 or more, and further preferably 4 or more, and the upper limit thereof is preferably 24 or less, more preferably 12 or less, further preferably 8 or less, and still further preferably 6 or less. In this case, the hydrocarbon group represented by X^{35A} may be either linear or branched, is preferably branched, and is preferably an aliphatic hydrocarbon group having a quaternary carbon atom, and particularly preferably a tert-butyl group.

The compound (A) contained in the modified sulfide solid electrolyte of the present embodiment preferably has a molecular weight of 60 or more, and more preferably 70 or more, and the upper limit thereof is preferably 400 or less, more preferably 380 or less, and further preferably 350 or less. The use of the compound (A) having such a molecular weight can enhance the coating suitability efficiently.

### (Compound (B))

The compound (B) used in the modified sulfide solid electrolyte of the present embodiment is a compound having two or more heterocyclic rings having a carbon atom and an oxygen atom, which may also be referred to as a “heteropolycyclic compound”, in contrast to the heteromonocyclic compound as the compound (A).

Preferred examples of the heterocyclic ring having a carbon atom and an oxygen atom of the compound (B) include a heterocyclic ring of a saturated or unsaturated monocyclic oxygen-containing heterocyclic compound, such as oxirane, oxetane, tetrahydrofuran, dihydrofuran, furan, dioxolane, tetrahydropyran, and pyran. The heterocyclic ring contained reduces the oil absorption, easily provides the excellent coating suitability, and provides the excellent battery capabilities more efficiently.

Among the heterocyclic rings, the heterocyclic ring of oxirane, i.e., an oxirane ring, is preferred in consideration of the availability. Therefore, the compound (B) used in the present embodiment is preferably a compound having two or more oxirane rings, and particularly preferred examples thereof include an epoxy compound having two or more groups selected from an epoxy group, a glycidyl group, and a glycidyl ether group represented by the following general formula (1B) (which may hereinafter referred to as an “epoxy compound 1B”).

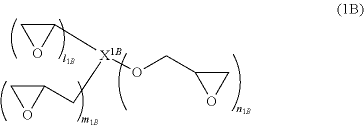

In the general formula (1B), X^{1B} represents a single bond, an aliphatic group, an alicyclic group, an aromatic group, an organic group having a siloxane structure, or an organic group containing a combination of these groups, and l_{1B}, m_{1B}, and n_{1B} each represent an integer of 0 or more and 16 or less, and satisfy l_{1B}+m_{1B}+n_{1B}≥2. In the case where the organic group represented by X^{1B} has the alicyclic group, the epoxy group may be condensed with the alicyclic ring in the alicyclic group.

### (Single Bond)

In the case where X^{1B} in the general formula (1B) represents a single bond, preferred examples of the epoxy compound 1B include a butadiene epoxide having two epoxy groups bonded to each other and a hexadiene epoxide having two glycidyl groups bonded to each other. The hexadiene epoxide having two glycidyl groups bonded to each other can also be comprehended as an epoxy compound represented by the general formula (1B), in which X^{1B} represents a single bond, m_{1B} is 2, and l_{1B} and n_{1B} are 0, and can also be comprehended as an epoxy compound represented by the general formula (1B), in which X^{1B} represents an ethylene group, l_{1B} is 2, and m_{1B} and n_{1B} are 0, assuming that two epoxy groups are bonded to both ends of an ethylene group.

### (Aliphatic Group)

As for X^{1B} in the general formula (1B), preferred examples of the aliphatic group include a group having bonding sites, which are obtained by removing hydrogen atoms of the number of the at least two groups selected from an epoxy group, a glycidyl group, and a glycidyl ether group (i.e., l_{1B}+m_{1B}+n_{1B}) from an alkane, an alkene, or an alkyne. For example, a group having bonding sites, which are obtained by removing two hydrogen atoms from an alkane (i.e., a divalent aliphatic group) is an alkanediyl group, and a group having bonding sites, which are obtained by removing three hydrogen atoms therefrom (i.e., a trivalent aliphatic group) is an alkanetriyl group.

In this manner, in the present embodiment, the name of the group may change depending on the number of the bonding sites of X^{1B} (which is the number of the at least two groups selected from an epoxy group, a glycidyl group, and a glycidyl ether group bonded to X^{1B} (i.e., l_{1B}+m_{1B}+N_{1B})). Accordingly, in the description herein, the basic structure (which corresponds, for example, to the alkane, the alkene, and the alkyne) establishing the basis of the aliphatic group and other groups is described below.

Preferred examples of the basic structure of the aliphatic group include an alkane, an alkene, and an alkyne, as described above. Among these, an alkane and an alkene are more preferred, and an alkane is further preferred, from the standpoint of reducing the oil absorption, easily providing the excellent coating suitability, and providing the excellent battery capabilities more efficiently.

The number of carbon atoms of the aliphatic group is preferably 1 or more, and more preferably 2 or more, and the upper limit thereof may be 24 or less, is preferably 16 or less, more preferably 10 or less, further preferably 8 or less, and still further preferably 6 or less. In the case where the number of carbon atoms of the aliphatic group is in the range, the oil absorption is reduced, the excellent coating suitability can be easily obtained, and the excellent battery capabilities can be obtained more efficiently.

Typical preferred examples of the epoxy compound 1B having an aliphatic group as X^{1B} in the general formula (1B) include ethylene glycol diglycidyl ether having an ethylene group as the aliphatic group and having two glycidyl ether groups (i.e., n_{1B} is 2), butanediol diglycidyl ether having a butylene group as the aliphatic group and having two glycidyl ether groups (i.e., n_{1B} is 2), hexanediol diglycidyl ether having a hexylene group as the aliphatic group and having two glycidyl ether groups (i.e., n_{1B} is 2), and octadiene diepoxide having an ethylene group as the aliphatic group and having two glycidyl ether groups (i.e., m_{1B} is 2).

In the description herein, for example, the expression “butanediol diglycidyl ether” above means that butane (i.e., an alkane having 4 carbon atoms) encompasses both a linear group and a branched group, and the positions of the carbon atoms having diglycidyl ether groups bonded thereto (i.e., the positions of the diol) encompasses all the possible positions.

More specifically, the “butanediol diglycidyl ether” encompasses 1,4-butanediol diglycidyl ether, in which one glycidyl ether is bonded to each of the 1- and 4-positions of butanediol, and compounds having glycidyl ether groups bonded to other carbon atoms, for example, 1,2-butanediol diglycidyl ether, in which one glycidyl ether is bonded to each of the 1- and 2-positions of butanediol, and 1,3-butanediol diglycidyl ether, in which one glycidyl ether is bonded to each of the 1- and 3-positions of butanediol, and also encompasses 2-methyl-1,3-propanediol diglycidyl ether, in which one glycidyl ether is bonded to each of the 1- and 3-positions of 2-methyl-1,3-propanediol, which is obtained by replacing butane in 1,3-butanediol by 2-methylpropane, i.e., a branched group.

The aliphatic group may be either linear or branched.

At least a part of the hydrogen atoms thereof may be replaced by a halogen atom, a hydroxy group, an amino group, and the like. In this case, the halogen atom is preferably a fluorine atom. In the case where at least a part of the hydrogen atoms of the aliphatic group is replaced by a halogen atom, there may be a case where the epoxy compound 1B is a compound capable of being referred to as an organic halide as the compounds (C) and (F) described later, as similar to the epoxy compounds 1A to 3A. However, a compound having two or more heterocyclic rings having a carbon atom and an oxygen atom is regarded as a compound corresponding to the compound (B), but is not regarded as an organic halide as the compounds (C) and (F). The case where the epoxy compound 1B has a group substituted by a halogen atom other than the aliphatic group is also the same as the case where the compound has an aliphatic group substituted by a halogen atom.

Typical preferred examples of the epoxy compound 1B having a branched aliphatic group as X^{1B} in the general formula (1B) include neopentyl glycol diglycidyl ether having a neopentylene group as the aliphatic group and having two glycidyl ether groups (i.e., n_{1B} is 2), trimethylolpropane triglycidyl ether having a group obtained by removing three hydrogen atoms from 2,2-dimethylbutane, which is a branched alkane as the basic structure, as the aliphatic group and having three glycidyl ether groups (i.e., n_{1B} is 3), and pentaerythritol trimethylolpropane triglycidyl ether having a group obtained by removing four hydrogen atoms from pentaerythritol as the basic structure as the aliphatic group and having four glycidyl ether groups (i.e., m_{1B} is 4) (which can also be comprehended as a compound having a group obtained by removing four hydrogen atoms from 2,2-dimethylbutane as the basic structure as the aliphatic group and having four glycidyl ether groups (i.e., n_{1B} is 4)).

Typical preferred examples of the epoxy compound 1B having an aliphatic group in which at least a part of hydrogen atoms are replaced as X^{1B} in the general formula (1B) include 2,2′-(2,2,3,3,4,4,5,5-octafluorohexan-1,6-diyl)bisoxirane having a group obtained by removing two hydrogen atoms from 2,2,3,3,4,4,5,5-octafluorohexane obtained by replacing eight hydrogen atoms of hexane by fluorine atoms (i.e., a 2,2,3,3,4,4,5,5-octafluorohexan-1,6-diyl group) as the basic structure as the aliphatic group and having two epoxy groups (i.e., l₁ is 2).

2,2′-(2,2,3,3,4,4,5,5-Octafluorohexan-1,6-diyl)bisoxirane described above is a compound used in the examples, and therefore the substitution positions of fluorine atoms and the like are specifically indicated. However, in the description herein, while a compound indicated with the substitution positions and the like that is described in the examples means the actual compound itself, such a compound that is not described in the examples encompasses all the linear form and the branched forms of hexane (i.e., an alkane having 6 carbon atoms) and encompasses all the possible positions for the position of the carbon atom substituted by a fluorine atom and the position of the carbon atom bonded to an oxirane ring (epoxy group), as similar to the compounds indicated without the substitution positions above.

### (Alicyclic Group)

As for X^{1B} in the general formula (1B), preferred examples of the basic structure of the alicyclic group include a cycloalkane and a cycloalkene, with which the oil absorption is reduced, the excellent coating suitability can be easily obtained, and the excellent battery capabilities can be obtained more efficiently. A cycloalkane is more preferred from the standpoint of the availability.

Examples of the basic structure of the alicyclic group include a structure containing multiple alicyclic rings, and preferred examples thereof include a bonded polyaliphatic ring structure, such as bicyclohexyl; a structure containing two or more alicyclic rings condensed to each other, such as hexahydronaphthalene, octahydronaphthalene, and decahydronaphthalene; and a bridged cyclic structure, such as norbornane, norbornene, adamantane, tricyclodecane, and pinene. Examples of the basic structure also include a basic structure having a double bond in the alicyclic ring, such as pentalene and azulene.

Preferred examples of the basic structure thereof also include a structure containing any of the basic structure of the monocyclic alicyclic ring, the basic structure of the polycyclic alicyclic rings, and the basic structure of the aromatic ring described later, which are bonded or condensed to each other.

The basic structure of the alicyclic group may be a structure having a heterocyclic ring obtained by replacing a carbon atom of the basic structure described above by a hetero atom, such as a nitrogen atom, an oxygen atom, a sulfur atom, and a phosphorus atom.

In the basic structure described above, at least a part of hydrogen atoms may be replaced by a halogen atom, such as a fluorine atom, a hydroxy group, an amino group, or the aliphatic group described above, and may be replaced by a silicon atom or a group containing a silicon atom and an aliphatic group. In this case, the aliphatic group is preferably an alkyl group or an alkenyl group, the number of carbon atoms of which is preferably 1 or more, and the upper limit thereof is preferably 12 or less, more preferably 8 or less, further preferably 6 or less, and still further preferably 4 or less.

The number of carbon atoms of the alicyclic group may be 3 or more, and is preferably 4 or more, and more preferably 6 or more, and the upper limit thereof is preferably 24 or less, more preferably 20 or less, further preferably 16 or less, and still further preferably 12 or less.

In the case where X^{1B} represents an alicyclic group, the epoxy group (oxirane ring) may exist in a condensed form with the alicyclic ring of the alicyclic group.

Typical preferred examples of the basic structure of the alicyclic group capable of being condensed with the epoxy group (oxirane ring) include cyclopentane, cyclohexane, and cyclooctane, in which cyclohexane is preferred from the standpoint of the availability. For example, in the case where the basic structure of the alicyclic group is cyclohexane, condensation with an epoxy group forms epoxycyclohexane, and therefore the polyfunctional epoxy compound becomes a compound having epoxycyclohexane as a part thereof. Typical preferred examples of the polyfunctional epoxy compound include 1,3-bis[2-(7-oxabicyclo[4.1.0]heptan-3-yl)ethyl]-1,1,3,3-tetramethyldisiloxane used in the examples (which is a compound represented by the general formula (1), in which the basic structure of X^{1D} is 1,3-ethylcyclohexyl-1,1,3,3-tetramethyldisiloxane (which is a compound obtained by replacing the hydrogen atom bonded to the silicon atom by a propyl group), l_{1B} represents 2, m_{1B} and n_{1B} represent 0, and the epoxy group exists in the form of epoxycyclohexane through condensation with cyclohexane).

### (Aromatic Group)

As for X^{1B} in the general formula (1B), preferred examples of the basic structure of the aromatic group include a monocyclic aromatic compound, such as benzene, toluene, and styrene; a bonded polycyclic aromatic compound containing multiple aromatic rings bonded to each other, such as biphenyl, diphenylmethane (benzylbenzene), diphenylethane (bibenzyl), methylidynetrisphenol, and triphenylcyclohexane; and a condensed polycyclic aromatic compound containing multiple aromatic rings condensed to each other, such as naphthalene, phenanthrene, anthracene, pyrene, triphenylene, tetracene, and pentacene, and that containing an aromatic ring and an alicyclic ring condensed each other, such as indene, indacene, acenaphthene, dihydronaphthalene, tetrahydronaphthalene, biphenylene, fluorene, and fluoranthene.

Preferred examples of the basic structure thereof also include a structure containing any of the basic structure of the aromatic ring, the basic structure of the monocyclic aliphatic ring, and the basic structure of the polycyclic aliphatic ring, which are bonded or condensed to each other, representative examples of which include diphenylfluorene (9,9-diphenyl-9H-fluorene), which is a compound containing two benzene rings bonded to the 9-position of fluorene via a single bond.

Typical preferred examples of the epoxy compound 1B having an aromatic group as X^{1B} in the general formula (1B) include diglycidyl resorcinol ether (which is a compound having a 1,3-phenylene group) and 1,4-glycidyloxybenzene (which is a compound having a 1,4-phenylene group) each having a phenylene group as the aromatic group and having two glycidyl ether groups (i.e., n_{1B} is 2), and tris(4-hydroxyphenyl) methane triglycidyl ether having a group obtained by removing three hydrogen atoms from methylidyne trisphenol as the basic structure of the condensed polycyclic aromatic compound as the aromatic group and having three glycidyl groups (i.e., m_{1B} is 3).

Typical preferred examples thereof also include 9,9-bis(4-glycidyloxyphenyl) fluorene having a group obtained by removing two hydrogen atoms from 9,9-bis(4-hydroxyphenyl) fluorene as the basic structure of the condensed polycyclic aromatic compound as the aromatic group and having two glycidyl groups (i.e., m_{1B} is 2).

Preferred examples of the basic structure of the aromatic group include a bisphenol compound, such as bisphenol A (2,2-bis(4-hydroxyphenyl) propane), bisphenol AP (1,1-bis(4-hydroxyphenyl)-1-phenylethane), bisphenol B (2,2-bis(4-hydroxyphenyl) butane), bisphenol BP (bis(4-hydroxyphenyl)diphenylmethane), bisphenol M (1,3-bis(2-(4-hydroxyphenyl)-2-propyl)benzene), bisphenol PH (5,5′-(1-methylethylidene)-bis(1,1-(bisphenyl)-2-ol) propane), and bisphenol Z (1,1-bis(4-hydroxyphenyl)cyclohexane), and a compound containing the bisphenol compound.

Preferred examples of the bisphenol compound also include is a compound that is partially substituted by a halogen atom, such as a fluorine atom, such as bisphenol AF (2,2-bis(4-hydroxyphenyl) hexafluoropropane), and a compound that contains an oxygen atom or a sulfur atom, such as bisphenol S (4-hydroxyphenyl) sulfone).

Typical preferred examples of the epoxy compound 1B having an aromatic group as X^{1B} in the general formula (1B) in which the basic structure of the aromatic group is a bisphenol compound include bisphenol A diglycidyl ether having a group obtained by removing hydrogen atoms from the hydroxy groups of bisphenol A as the basic structure of the aromatic group and having two glycidyl groups (i.e., m_{1B} is 2), and bisphenol A propoxylate diglycidyl ether having a group obtained by removing hydrogen atoms of the propyl groups of 2,2-bis((4-propoxyphenyl) propane) obtained by replacing the hydrogen atoms of the hydroxy groups of bisphenol A as the basic structure of the aromatic group by propyl groups and having two glycidyl groups (i.e., n_{1B} is 2).

The basic structure of the aromatic group represented by X^{1B} in the general formula (1B) may have a heterocyclic ring obtained by replacing a carbon atom in the basic structures described above by a hetero atom, such as a nitrogen atom, an oxygen atom, a sulfur atom, and a phosphorus atom. In the case where a heterocyclic ring obtained by replacing by a phosphorus atom is contained, the compound (B) (epoxy compound (1B)) does not correspond to the compound (H) described later, and the compound (H) is excluded.

In the basic structure described above, at least a part of hydrogen atoms may be replaced by a halogen atom, such as a fluorine atom, a hydroxy group, an amino group, or the aliphatic group described above. In this case, the aliphatic group is preferably an alkyl group or an alkenyl group, in which the number of carbon atoms thereof is preferably 1 or more, and the upper limit thereof is preferably 12 or less, more preferably 8 or less, further preferably 6 or less, and still further preferably 4 or less.

In the basic structure of the aromatic group, an amino group and a hydroxy group are preferred among these substituents. In the case where the aromatic group is substituted by an amino group, preferred examples thereof include aniline and dimethylaniline, and in the case where the aromatic group is substituted by a hydroxy group, preferred examples thereof include phenol and benzenediol. Preferred examples thereof also include hydroxyaniline (aminophenol), which is substituted by an amino group and a hydroxy group.

Typical preferred examples of the epoxy compound 1B having an aromatic group as X^{1B} in the general formula (1B) in which the basic structure of the aromatic group is substituted by an amino group, a hydroxy group, or the like include N,N-diglycidyl-4-glycidyloxyaniline having a group obtained by removing hydrogen atoms from the amino group and the hydroxy group of hydroxyaniline (which is a compound obtained by replacing two hydrogen atoms of benzene by an amino group and a hydroxy group) as the basic structure of the aromatic group and having two glycidyl groups (i.e., m_{1B} is 3), and 4,4′-methylenebis(N,N-diglycidylaniline) having a group obtained by removing hydrogen atoms from the amino groups of 4,4′-methylenebis(N,N-dimethylaniline) (which is a compound obtained by replacing two hydrogen atoms of diphenylmethane by amino group) as the basic structure of the aromatic group and having four glycidyl groups (i.e., m_{1B} is 4).

Assuming that diglycidyl resorcinol ether and 1,4-glycidyloxybenzene, which are described above as specific examples, each are comprehended as a compound having a group obtained by removing hydrogen atoms from the hydroxy groups of a compound obtained by replacing two hydrogen atoms of benzene by hydroxy group (benzenediol) as the basic structure of the aromatic group and having two glycidyl groups (i.e., m_{1B} is 2), these compounds can also be considered as a compound having the basic structure of the aromatic group that is substituted by an amino group, a hydroxy group, or the like in the epoxy compound 1B having an aromatic group as X^{1B} in the general formula (1).

The number of carbon atoms of the aromatic group may be 6 or more, and is preferably 8 or more, and more preferably 10 or more, and the upper limit thereof is preferably 36 or less, more preferably 32 or less, and further preferably 28 or less.

### (Organic Group Having Siloxane Structure)

As for X^{1B} in the general formula (1B), the basic structure of the organic group having a siloxane structure used may be a group having at least an —Si—O— bond with no particular limitation, and preferred examples thereof include a chain-like siloxane compound, for example, an alkoxysilane having one silicon atom, such as dimethylmethoxysilane, dimethoxymethylsilane, trimethoxysilane, trimethoxymethylsilane, and tetramethoxysilane; and a disiloxane compound having two silicon atoms, such as tetramethyldisiloxane, hexamethyldisiloxane, and divinyltetramethyldisiloxane.

Preferred examples thereof also include a cyclic siloxane compound, such as hexamethylcyclotrisiloxane, octamethylcyclotetrasiloxane, and decamethylcyclopentasiloxane, and a cage siloxane, such as silsesquioxane.

As for the chain-like siloxane compound and the cyclic siloxane compound above, while the compounds having a methyl group as the group bonded to the silicon atom and the alkyl group in the alkoxy group are described, it is obvious that compounds having other groups than a methyl group, i.e., the aliphatic group, the alicyclic group, and the aromatic group described above, such as an ethyl group and a propyl group, are also encompassed. In this case, the aliphatic group is preferably an alkyl group or an alkenyl group, and the number of carbon atoms thereof is preferably 1 or more, and the upper limit thereof is preferably 12 or less, more preferably 8 or less, further preferably 6 or less, and still further preferably 4 or less.

As for the compound containing a group other than a methyl group for the chain-like siloxane compound, preferred examples of the chain-like siloxane compound as the basic structure include a polyfunctional epoxy compound having a siloxane compound as the basic structure from the standpoint of the availability, for example, in hexamethyldisiloxane, 1,3-dipropyl-1,1,3,3-tetramethyldisiloxane having propyl groups replacing one methyl group bonded to each of the two silicon atoms, and 1,3-dicyclohexaneethyl-1,1,3,3-tetramethyldipropyldisiloxane having a cyclohexaneethyl groups replacing one methyl group bonded to each of the two silicon atoms.

Typical preferred examples of the epoxy compound 1B having an organic group having a siloxane structure as X^{1B} in the general formula (1B) include 1,3-bis(3-glycidyloxypropyl)tetramethyldisiloxane having a group obtained by removing two hydrogen atoms from the propyl groups of 1,3-dipropyl-1,1,3,3-tetramethyldisiloxane as the basic structure of the organic group having a siloxane structure and having two glycidyl ether groups (i.e., n_{1B} is 3).

Typical preferred examples of the epoxy compound 1B having an organic group having a siloxane structure as X^{1B} in the general formula (1B) also include 1,3-bis[2-(7-oxabicyclo[4.1.0]heptan-3-yl)ethyl]-1,1,3,3-tetramethyldisiloxane described above for the compound having epoxycyclohexane having an alicyclic group and an epoxy group condensed to each other.

As for the cyclic siloxane compound, preferred examples of the cyclic siloxane compound as the basic structure include the epoxy compound 1B having 2,4,6,8-tetramethyl-2,4,6,8-tetrapropylcyclotetrasiloxane as the basic structure having propyl groups replacing one methyl group bonded to each of the four silicon atoms in octamethylcyclotetrasiloxane from the standpoint of the availability.

Typical preferred examples of the polyfunctional epoxy compound having an organic group having a siloxane structure as X^{1B} in the general formula (1B) in which the basic structure is a cyclic siloxane compound include 1,3-bis(3-glycidyloxypropyl)tetramethyldisiloxane having a group obtained by removing four hydrogen atoms from the propyl groups of 2,4,6,8-tetramethyl-2,4,6,8-tetrapropylcyclotetrasiloxane as the basic structure of the organic group having a siloxane structure and having four glycidyl ether groups (i.e., n_{1B} is 4).

Typical preferred examples of the epoxy compound 1B having an organic group having a siloxane structure as X^{1B} in the general formula (1B) in which the basic structure is a cage siloxane compound include PSS-octa[(3-glycidyloxypropyl)dimethylsiloxy] substituted having a group obtained by removing one hydrogen atom from each of the eight propyl groups of the compound having silsesquioxane (PSS-octamethyl substituted) having one propyldimethylsiloxy group bonded to each of the eight silicon atoms (i.e., eight groups in total) (which is a compound that can also be referred to as “PSS-octa (propyldimethylsiloxy) substituted”) as the basic structure of the organic group having a siloxane structure and having eight glycidyl ether groups (i.e., n_{1B} is 8).

The number of silicon atoms of the basic structure having a siloxane structure is preferably 1 or more, and more preferably 2 or more, and the upper limit thereof is preferably 12 or less, more preferably 8 or less, further preferably 6 or less, and still further preferably 4 or less.

### (Linking Group)

In the epoxy compound 1B, the group containing a combination of the groups described above as X^{1B} may be a group containing at least two groups selected from the aliphatic group, the alicyclic group, the aromatic group, and the organic group having a siloxane structure above that are bonded via a single bond or a linking group selected from —O—, —SO₂—, —CO—, —C(═O)O—, —N—, and —S—. In the description herein, the aliphatic group, the alicyclic group, the aromatic group, and the organic group having a siloxane structure represented by X^{1B} are described by referring to the basic structures containing these groups, and therefore it can also be understood that the basic structures are bonded via a single bond or a linking group, such as —O—.

Preferred examples of the case where X^{1B} represents a group containing at least two groups selected from the aliphatic group, the alicyclic group, the aromatic group, and the organic group having a siloxane structure that are bonded via a single bond include a case where one of the groups is substituted by the other group, and a case where two benzene rings as one basic structure are bonded via a single bond to the 9-position of fluorene as another basic structure, e.g., diphenylfluorene (9,9-diphenyl-9H-fluorene) described above.

Preferred examples of the basic structure in the case where X^{1B} represents a group bonded via a single bond also include 4,4-methylenedianiline (p-toluidine) having aniline and 4-methylaniline bonded via a single bond, and 4,4′-methylenebis(N,N-dimethylaniline) having dimethylaniline and 4,N,N-trimethylaniline bonded via a single bond.

Typical preferred examples of the case where X^{1B} represents a group containing —O— as the linking group include a case where multiple aliphatic groups bonded via —O—, and more specifically a basic structure having a repeating unit represented by —R^{1B}O— (in which R^{1B} represents a divalent aliphatic group, preferably an alkanediyl group), such as oxyethylene and oxypropylene.

In the case where the basic structure has a repeating unit represented by —R^{1B}O—, the basic structure may have one repeating unit represented by —R^{1B}O—, or may have two or more thereof. In the case where basic structure has two or more thereof, the average number of repetitions (n) is preferably 2 or more, more preferably 4 or more, and further preferably 5 or more, and the upper limit thereof is preferably 200 or less, more preferably 180 or less, and further preferably 170 or less.

In this case, the number average molecular weight of the epoxy compound 1B cannot be determined unconditionally since it may vary depending on the kind of R^{1B} in —R^{1B}O—, and is preferably 200 or more, more preferably 300 or more, and further preferably 350 or more, and the upper limit thereof is preferably 10,000 or less, more preferably 8,000 or less, further preferably 7,000 or less, and still further preferably 6,500 or less.

Typical preferred examples of the polyfunctional epoxy compound in which X^{1B} has —O— as the linking group include polypropylene glycol diglycidyl ether having an oxypropylene group as —R^{1B}O— (i.e., RIB represents a propylene group) and having one glycidyl group and one glycidyl ether group (i.e., m_{1B} is 1, and n_{1B} is 1), and polyethylene glycol diglycidyl ether having an oxyethylene group as —R^{1B}O— (i.e., R^{1B} represents an ethylene group) and having one glycidyl group and one glycidyl ether group (i.e., m_{1B} is 1, and n_{1B} is 1). The average number of repetitions (n) in the polyethylene glycol diglycidyl ether and the polypropylene glycol diglycidyl ether is appropriately selected from the aforementioned range.

Preferred examples of the basic structure in the case where the group represented by X^{1B} has —O— as the linking group also include a compound having aliphatic groups, such as diethylene glycol and diglycerin, bonded via —O—.

Preferred examples of the basic structure in the case where the group represented by X^{1B} has —O— as the linking group also include a compound having alicyclic rings, such as dicyclohexyl ether, bonded via —O—, and compound having aromatic rings, such as dihydroxydiphenyl ether and phenyl biphenylyl ether, bonded via —O—.

Typical preferred examples of the epoxy compound 1B in the case where the group represented by X^{1B} has —O— as the linking group include diethylene glycol diglycidyl ether having —CH₂CH₂—O—CH₂CH₂-containing two ethylene groups bonded via —O— (i.e., a group obtained by removing two hydrogen atoms from diethylene glycol as the basic structure) as the group represented by X^{1B} having —O— as the linking group and having two glycidyl ether groups (i.e., n_{1B} is 2).

Preferred examples of the case where X^{1B} has —C(═O)O— as the linking group include a compound having two alicyclic rings, such as cyclohexylmethyl cyclohexanecarboxylate, bonded via —C(═O)O—.

(l_{1B}, m_{1B}, and n_{1B})

l_{1B}, m_{1B}, and n_{1B} each represent an integer of 0 or more and 16 or less, and satisfy l_{1B}+m_{1B}+N_{1B}≥2.

The values of l_{1B}, m_{1B}, and n_{1B} are not particularly limited, as long as the sum thereof (l_{1B}+m_{1B}+n_{1B}) is 2 or more, and in the case of 1 or more, each are preferably 2 or more, and the upper limit thereof is preferably 10 or less, more preferably 8 or less, and further preferably 4 or less.

The value of l_{1B}+m_{1B}+n_{1B} is not particularly limited, as long as being 2 or more, and preferably 2 or more, and upper limit thereof is preferably 10 or less, more preferably 8 or less, and further preferably 4 or less.

In the case where l_{1B}, m_{1B}, and n_{1B} satisfy the range, the oil absorption is reduced, the excellent coating suitability can be easily obtained, and the excellent battery capabilities can be obtained more efficiently. It is preferred that any one of l_{1B}, m_{1B}, and n_{1B} represents 2 or more, and the other two represent 0, from the standpoint of the availability. In other words, the epoxy compound 1B used in the present embodiment preferably has two or more of any one group of an epoxy group, a glycidyl group, and a glycidyl ether group from the standpoint of the availability.

A polyfunctional epoxy group in which any one of l_{1B}, m_{1B}, and n_{1B} represents 1, and any one of the other two represents 1 is also preferred from the standpoint of the availability. In this case, the epoxy compound 1B having one glycidyl ether group and one or more glycidyl group is preferred, and the epoxy compound 1B having one glycidyl ether group and two glycidyl groups is more preferred, from the same standpoint.

### (Additional Heteropolycyclic Compound)

Examples of the heteropolycyclic compound having two or more heterocyclic rings having a carbon atom and an oxygen atom as the compound (B) that is a compound other than the compound having two or more oxirane rings as the epoxy compound 1B above include a compound having heterocyclic rings other than an oxirane ring among heterocyclic rings constituted by three atoms, and a compound having heterocyclic rings constituted by four or more atoms. Preferred examples of such a heteropolycyclic compound other than the epoxy compound 1B include a compound represented by the following general formula (2B).

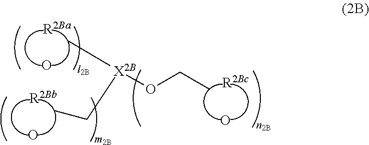

In the general formula (2B), X^{2B} represents a single bond, an aliphatic group, an alicyclic group, an aromatic group, an organic group having a siloxane structure, or an organic group containing a combination of these groups, and R^{2Ba}, R^{2Bb}, and R^{2Bc} each independently represent an aliphatic group having 1 or more carbon atoms. The heterocyclic rings containing R^{2Ba}, R^{2Bb}, and R^{2Bc} each may contain a linking group selected from —O—, —SO₂—, —CO—, —C(═O)O—, —N—, and —S—.

l_{2B}, m_{2B}, and n_{2B} each represent an integer of 0 or more and 16 or less, and satisfy l_{2B}+m_{2B}+n_{2B}≥2. In the case where the organic group represented by X^{2B} has the alicyclic group, the heterocyclic group may be condensed with the alicyclic ring in the alicyclic group.

In the general formula (2B), the single bond, the aliphatic group, the alicyclic group, the aromatic group, the organic group having a siloxane structure, and the organic group containing a combination of these groups represented by X^{2B} are the same as described for the single bond, the aliphatic group, the alicyclic group, the aromatic group, the organic group having a siloxane structure, and the organic group containing a combination of these groups represented by X^{1B} in the general formula (1B).

l_{2B}, m_{2B}, and n_{2B} are the same as described for l_{1B}, m_{1B}, and n_{1B} in the general formula (1).

In the general formula (2B), the aliphatic groups represented by R^{2Ba}, R^{2Bb}, and R^{2Bc} each form an alicyclic structure with the oxygen atom. Examples of the aliphatic groups represented by R^{2Ba}, R^{2Bb}, and R^{2Bc} include the same groups as described for the aliphatic group represented by X^{1B} in the general formula (1B), and examples thereof include a divalent aliphatic group, such as an alkanediyl group, an alkenediyl group, and an alkynediyl group. In the present embodiment, any of these groups may be used, in which an alkanediyl group and an alkenediyl group are preferred, and an alkanediyl group is more preferred, from the standpoint of the availability.

The number of carbon atoms of the aliphatic groups represented by R^{2Ba}, R^{2Bb}, and R^{2Bc} is preferably 2 or more, and more preferably 3 or more, and the upper limit thereof is preferably 12 or less, more preferably 8 or less, and further preferably 6 or less, from the same standpoint.

The compound (B) that is represented by the general formula (2B) is a heteropolycyclic compound other than the compound having two or more oxirane rings as the heterocyclic rings, such as the epoxy compound 1B. Therefore, for example, in the case where R^{2Ba}, R^{2Bb}, and R^{2Bc} each represent an aliphatic group having 2 carbon atoms, and l_{2B}, m_{2B}, and n_{2B} represent 1, the aliphatic group having 2 carbon atoms is a group other than an alkanediyl group, i.e., an alkenediyl group or an alkynediyl group. Even in the case where R^{2Ba}, R^{2Bb} and R^{2Bc} each represent an aliphatic group having 2 carbon atoms, and l_{2B}, m_{2B}, and n_{2B} represent 1, the aliphatic group having 2 carbon atoms may be an alkanediyl group (i.e., an ethylene group) in the case where the heterocyclic ring contains the linking group described later. Examples of the case where the aliphatic group having 2 carbon atoms may be an alkanediyl group (i.e., an ethylene group) include an oxathietane ring having ethylene groups as R^{2Ba}, R^{2Bb}, and R^{2Bc}, and —S— as the linking group.

Typical preferred examples of the heteropolycyclic compound having an alkanediyl group as R^{2Ba} include bis(tetrahydrofuryloxy) butane (particularly 1,4-bis(2-tetrahydrofuryloxy) butane) having a group obtained by removing two hydrogen atoms from butanediol as the basic structure of X^{2B} and having two tetrahydrofurane rings (i.e., R^{2Ba} represents a butylene group) (i.e., l_{2B} is 2).

The heterocyclic rings containing R^{2Ba}, R^{2Bb}, and R^{2Bc} each may contain a linking group selected from —O—, —SO₂—, —CO—, —C(—O)O—, —N—, and —S—.

Examples thereof in the case where the heterocyclic ring is a dioxirane ring include the case where the aliphatic groups in R^{2Ba}, R^{2Bb}, and R^{2Bc} are methylene groups having one carbon atom, and the methylene group and the oxygen atom of the heterocyclic ring are bonded via —O—. Examples thereof in the case where the heterocyclic ring is a 1,3-dioxolane ring include the case where the aliphatic groups in R^{2Ba}, R^{2Bb}, and R^{2Bc} each are a methylene group and an ethylene group, and these groups and the oxygen atom of the heterocyclic ring are bonded via —O—. Examples thereof in the case where the heterocyclic ring is an oxazolidine ring include the case where the aliphatic groups in R^{2Ba}, R^{2Bb}, and R^{2Bc} each are a methylene group and an ethylene group, and these groups and the oxygen atom of the heterocyclic ring are bonded via —N—. The heterocyclic ring containing a linking group is described with reference to some examples above, but is not limited to these examples in the present embodiment.

The number of carbon atoms of the heterocyclic ring that has the linking group may be within the range of the number of the carbon atoms of the aliphatic groups represented by R^{2Ba}, R^{2Bb}, and R^{2Bc}.

In the aliphatic group, at least a part of the hydrogen atoms may be replaced by a halogen atom, a hydroxy group, an amino group, and the like, and at least a part of the hydrogen atoms may be replaced by a monovalent aliphatic group. In the case where the heteropolycyclic compound represented by the general formula (2B) has an aliphatic group in which at least a part of the hydrogen atoms is replaced by a halogen atom, there may be a case where the compound is a compound capable of being referred to as an organic halide as the compounds (C) and (F) as similar to the epoxy compounds 1A to 3A above, but a compound having two or more heterocyclic rings having a carbon atom and an oxygen atom is regarded as a compound corresponding to the compound (B), but is not regarded as an organic halide as the compounds (C) and (F).

The heterocyclic ring in the general formula (2B) may be bonded to or condensed with an alicyclic ring or an aromatic ring. The bonded ring herein is the heterocyclic ring in the general formula (2B), at least one carbon atom of which is bonded to another alicyclic ring or heterocyclic ring, and the condensed ring is the heterocyclic ring in the general formula (2B), at least one carbon atom of which is condensed with another alicyclic ring or heterocyclic ring. The bonded and condensed ring of the heterocyclic ring in the general formula (2B) corresponds to the condensed ring described for the alicyclic ring and the heterocyclic ring in X^{1B} in the general formula (1B), i.e., the ring having any of the basic structure of the monocyclic alicyclic ring and the basic structure of the polycyclic alicyclic ring described above, and the basic structure of the aromatic ring described above, bonded and condensed thereto.

The number of carbon atoms of the heterocyclic ring that has the alicyclic ring and the aromatic ring bonded or condensed thereto may be within such a range that the number of carbon atoms of one of the alicyclic ring or the aromatic ring is in the range of the number of carbon atoms of the aliphatic groups represented by R^{2Ba}, R^{2Bb}, and R^{2Bc}.

In the modified sulfide solid electrolyte of the present embodiment, the compound (B) may be the compounds described for the compound (B) above, for example, the compounds represented by the general formulae (1B) and (2B), used alone or as a combination of multiple kinds thereof.

### (Compound (C))

The compound (C) used in the modified sulfide solid electrolyte of the present embodiment is an organic halide 1 (excluding the following compound (F)), which may be an organic compound having a halogen atom as a part thereof, and any compound that is other than the compound (F) described later can be used with no particular limitation.

Preferred examples of the compound (C) include a compound having one group represented by —CX^{1C} (in which X^{1C} represents a halogen atom), a compound having a halogenated formyl group (CX^{1C}(═O)— (in which X^{1C} represents a halogen atom)), and a compound having a halogenated silyl group (—SiX^{1C}n_{1C} (in which X^{1C} represents a halogen atom, and n_{1C} represents an integer of 1 to 3)). These groups having a halogen atom each are a group that exists at the end of the organic halide 1. The compound (C) that has the halogen atom-containing group at the end thereof can be easily attached to the sulfide solid electrolyte, and thereby the oil absorption is reduced, the excellent coating suitability can be easily obtained, and the excellent battery capabilities can be obtained more efficiently. The organic halide 1 having the halogen atom-containing group is different from the compound (F) (i.e., the organic halide 2) as described above, and the compound (C) encompasses compounds excluding the compound (F).

Preferred specific examples of the compound (C) include an organic halide 1a represented by the following general formula (1C), an organic halide 1b represented by the following general formula (2C), an organic halide 1c represented by the following general formula (3C), and an organic halide 1d represented by the following general formula (4C). In the modified sulfide solid electrolyte of the present embodiment, the compound (C) may be the compound having a halogen atom-containing group above or the compounds represented by the general formulae, used alone or as a combination of multiple kinds thereof (for example, multiple kinds of the compounds having a halogenated formyl group may be used in combination, and for example, multiple kinds of the compounds represented by the following general formula (1C) may be used in combination).

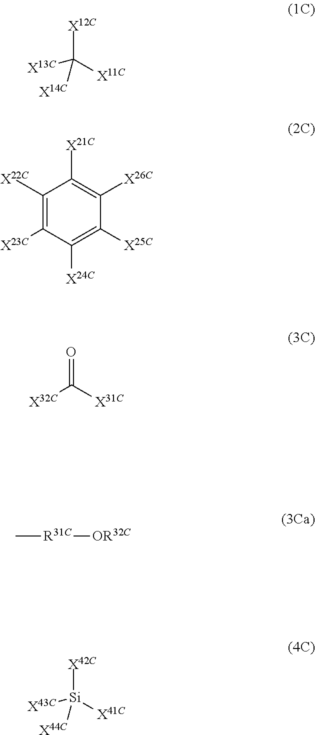

### (Organic Halide 1a)

The organic halide 1a is a compound represented by the general formula (1C).

In the general formula (1C), X^{11C} represents a halogen atom, and X^{12C} to X^{14C} each independently represent a hydrogen atom, a halogen atom, an aliphatic hydrocarbon group, an alicyclic hydrocarbon group, or an aromatic hydrocarbon group, in which the hydrogen atoms of the aliphatic hydrocarbon group, the alicyclic hydrocarbon group, and the aromatic hydrocarbon group may be replaced by a halogen atom. In the general formula (1C), the halogen atom represented by X^{11C} is an atom selected from a chlorine atom, a bromine atom, and an iodine atom, and the halogen atom represented by X^{12C} to X^{14C} is an atom selected from a fluorine atom, a chlorine atom, a bromine atom, and an iodine atom.

The halogen atom represented by X^{11C} is an atom selected from a chlorine atom, a bromine atom, and an iodine atom as described above, and is preferably a bromine atom or an iodine atom, and more preferably a bromine atom. The halogen atom represented by X^{12C} to X^{14C} is an atom selected from a fluorine atom, a chlorine atom, a bromine atom, and an iodine atom as described above, in which a chlorine atom, a bromine atom, and an iodine atom are more preferred. In the case where X^{11C} to X^{14C} represent multiple halogen atoms, the multiple halogen atoms may be the same as or different from each other.

In the case where the organic halide 1a is used, it is considered that the attachment thereof to the sulfide solid electrolyte is mainly attributed to the halogen atom represented by X^{11C}, and in the case where X^{12C} to X^{14C} represent a halogen atom or a group containing a halogen atom, it is considered that there may be a case where the attachment is attributed to X^{12C} to X^{14C}. However, it has been found that a fluorine atom is liable to cause the attachment to the sulfide solid electrolyte as compared to the other halogen atoms. In consideration of this, in the case where X^{12C} to X^{14C} have a halogen atom other than a fluorine atom, it can be understood that there is an increased tendency that the attachment to the sulfide solid electrolyte is more attributed to X^{11C}. This tendency is also applied to the organic halides 1b to 1d represented by the general formulae (2C) to (4C) described later.

Examples of the aliphatic hydrocarbon group represented by X^{12C} to X^{14C} include the same groups as described for the aliphatic group represented by X^{1B} in the general formula (1B). Preferred examples thereof include an alkyl group and an alkenyl group, in which an alkyl group is preferred.

The number of carbon atoms of the aliphatic hydrocarbon group for the alkyl group is preferably 1 or more, and the upper limit thereof is preferably 24 or less, more preferably 16 or less, and further preferably 12 or less. The number of carbon atoms thereof for the alkenyl group may be 2 or more, and is preferably 3 or more, and the upper limit thereof is preferably 24 or less, more preferably 16 or less, and further preferably 12 or less.

The aliphatic hydrocarbon group represented by X^{12C} to X^{14C} may be either linear or branched, and the hydrogen atoms thereof may be replaced by a halogen atom or may be replaced by a hydroxy group and the like. In the case of replacing by a halogen atom, examples thereof include the same halogen atom as described for the halogen atom represented by X^{12C} to X^{14C}, as defined that the halogen atom represented by X^{12C} to X^{14C} is an atom selected from a fluorine atom, a chlorine atom, a bromine atom, and an iodine atom. In the case where X^{12C} to X^{14C} represent multiple aliphatic hydrocarbon groups, the multiple aliphatic hydrocarbon groups may be the same as or different from each other.

Examples of the alicyclic hydrocarbon group represented by X^{12C} to X^{14C} include the same groups as described for the alicyclic group represented by X^{1B} in the general formula (1B). Preferred examples thereof include a cycloalkyl group and a cycloalkenyl group, in which a cycloalkyl group is preferred.

The number of carbon atoms of the alicyclic hydrocarbon group may be 3 or more, and is preferably 4 or more, and the upper limit thereof is preferably 12 or less, more preferably 8 or less, and further preferably 6 or less.

In the alicyclic hydrocarbon group represented by X^{12C} to X^{14C}, the hydrogen atoms thereof may be replaced by a halogen atom, and a part thereof may be replaced by a hydroxy group, the aliphatic hydrocarbon group described above (such as an alkyl group or an alkenyl group), and the like. In the case of replacing by a halogen atom, examples of the halogen atom substituting the alicyclic hydrocarbon group represented by X^{12C} to X^{14C} include the same halogen atom as described for the halogen atom represented by X^{12C} to X^{14C}, as defined that the halogen atom represented by X^{12C} to X^{14C} is an atom selected from a fluorine atom, a chlorine atom, a bromine atom, and an iodine atom. In the case where X^{12C} to X^{14C} represent multiple alicyclic hydrocarbon groups, the multiple alicyclic hydrocarbon groups may be the same as or different from each other.

Examples of the aromatic hydrocarbon group represented by X^{12C} to X^{14C} include the same groups as described for the aromatic group represented by X^{1B} in the general formula (1B). Preferred examples thereof include groups having a bonding site obtained by removing one hydrogen atom from the basic structure, for example, a monocyclic aromatic compound, such as benzene, toluene, and styrene; a bonded polycyclic aromatic compound containing multiple aromatic rings bonded to each other, such as biphenyl, diphenylmethane (benzylbenzene), diphenylethane (bibenzyl), methylidynetrisphenol, and triphenylcyclohexane; and a condensed polycyclic aromatic compound containing multiple aromatic rings condensed to each other, such as naphthalene, phenanthrene, anthracene, pyrene, triphenylene, tetracene, and pentacene, and that containing an aromatic ring and an alicyclic ring condensed each other, such as indene, indacene, acenaphthene, dihydronaphthalene, tetrahydronaphthalene, biphenylene, fluorene, and fluoranthene.

Preferred examples of the basic structure thereof also include a structure containing any of the basic structure of the aromatic ring, the basic structure of the monocyclic aliphatic ring, and the basic structure of the polycyclic aliphatic ring, which are bonded or condensed to each other, representative examples of which include diphenylfluorene (9,9-diphenyl-9H-fluorene), which is a compound containing two benzene rings bonded to the 9-position of fluorene via a single bond.

In the aromatic hydrocarbon group represented by X^{12C} to X^{14C}, the hydrogen atoms thereof may be replaced by a halogen atom, and a part thereof may be replaced by a hydroxy group, the aliphatic hydrocarbon group described above (such as an alkyl group or an alkenyl group), and the like. In the case of replacing by a halogen atom, examples of the halogen atom substituting the aromatic hydrocarbon group represented by X^{12C} to X^{14C} include the same halogen atom as described for the halogen atom represented by X^{12C} to X^{14C}, as defined that the halogen atom represented by X^{12C} to X^{14C} is an atom selected from a fluorine atom, a chlorine atom, a bromine atom, and an iodine atom. In the case where X^{12C} to X^{14C} represent multiple aromatic hydrocarbon groups, the multiple aromatic hydrocarbon groups may be the same as or different from each other.

the number of carbon atoms of the aromatic group may be 6 or more, and is preferably 8 or more, and the upper limit thereof is preferably 36 or less, more preferably 28 or less, further preferably 20 or less, and still further preferably 14 or less.

The organic halide 1a represented by the general formula (1C) is preferably a compound, in which X^{11C} represents a halogen atom, X^{12C} represents an aliphatic hydrocarbon group having 2 to 24 carbon atoms or an aromatic hydrocarbon group having 6 to 18 carbon atoms, and X^{13C} and X^{14C} represent hydrogen atoms, in which X^{12C} more preferably represents an aromatic hydrocarbon group. The halogen atom is preferably a chlorine atom, a bromine atom, or an iodine atom, more preferably a bromine atom or an iodine atom, and further preferably a bromine atom, as described above.

The aliphatic hydrocarbon group is preferably an alkyl group, in which the number of carbon atoms of the alkyl group is preferably 2 or more, and more preferably 3 or more, and the upper limit thereof is preferably 16 or less, and more preferably 12 or less. The aromatic hydrocarbon group is preferably a phenyl group or a phenylalkyl group, and more preferably a phenylalkyl group, as described above.

The organic halide 1a represented by the general formula (1C) is also preferably a compound, in which X^{11C} represents a halogen atom, X^{12C} and X^{13C} each represent an aliphatic hydrocarbon group having 1 to 24 carbon atoms, and X^{14C} represents a hydrogen atom, in which the halogen atom is preferably a chlorine atom, a bromine atom, or an iodine atom, more preferably a bromine atom or an iodine atom, and further preferably a bromine atom, as described above. The aliphatic hydrocarbon group is preferably an alkyl group, in which the number of carbon atoms of the alkyl group is preferably 1 or more, and the upper limit thereof is preferably 24 or less, more preferably 16 or less, further preferably 8 or less, and still further preferably 3 or less.

As described above, the compound represented by the general formula (1C) typically corresponds to the compound having one group represented by —CX^{1C} (in which X^{1C} represents a halogen atom). In this case, examples thereof include a compound represented by the general formula (1C), in which X^{11C} represents a halogen atom, X^{12C} and X^{14C} represent aliphatic hydrocarbon groups, and X^{13C} represents an aliphatic hydrocarbon group, and a compound, in which X^{11C} represents a halogen atom, X^{12C} and X^{14C} represent hydrogen atoms, and X^{13C} represents an aliphatic hydrocarbon group in which one hydrogen atom bonded to the end carbon atom is replaced by a halogen atom. In other words, the halogen atom represented by X^{11C} may form —CX^{1C} (in which X^{1C} represents a halogen atom), or the halogen atom contained in X^{12C} to X^{14C} may form —CX^{1C} (in which X^{1C} represents a halogen atom).

### (Organic Halide 1b)

The organic halide 1b is a compound represented by the general formula (2C).

In the general formula (2C), X^{21C} to X^{26C} each independently represent a hydrogen atom, a halogen atom, an aliphatic hydrocarbon group, an alicyclic hydrocarbon group, or an aromatic hydrocarbon group, in which the hydrogen atoms of the aliphatic hydrocarbon group, the alicyclic hydrocarbon group, and the aromatic hydrocarbon group represented by X^{21C} to X^{26C} may be replaced by a halogen atom, and at least one of X^{2I}C to X^{26C} represents a halogen atom or a group containing a halogen atom. In the general formula (2C), the halogen atom represented by X^{21C} is an atom selected from a chlorine atom, a bromine atom, and an iodine atom, and the halogen atom represented by X^{22C} to X^{26C} is an atom selected from a fluorine atom, a chlorine atom, a bromine atom, and an iodine atom.

Preferred examples of the halogen atom represented by X^{21C} include those described for the halogen atom represented by X^{11C}, and preferred examples of the halogen atom represented by X^{22C} to X^{26C} include those described for the halogen atom represented by X^{12C} to X^{14C}. The halogen atom represented by X^{22C} to X^{26C} is more preferably a fluorine atom. In the case where X^{21C} to X^{26C} represent multiple halogen atoms, the multiple halogen atoms may be the same as or different from each other.

Examples of the aliphatic hydrocarbon group, the alicyclic hydrocarbon group, and the aromatic hydrocarbon group represented by X^{21C} to X^{26C} include the same groups described for the alicyclic hydrocarbon group, and the aromatic hydrocarbon group represented by X^{12C} to X^{14C}, in which an aliphatic hydrocarbon group is preferred.

The aliphatic hydrocarbon group is preferably an alkyl group or an alkenyl group, and more preferably an alkyl group. The number of carbon atoms of the alkyl group may be 1 or more, and the upper limit thereof is preferably 24 or less, more preferably 12 or less, further preferably 8 or less, and still further preferably 2 or less. The number of carbon atoms of the alkenyl group is preferably 2 or more, and the upper limit thereof is the same as described for the alkyl group. The aliphatic hydrocarbon group may be either linear or branched as similar to the aliphatic hydrocarbon group represented by X^{12C} to X^{14C}, and in the case where X^{22C} to X^{26C} represent the multiple aliphatic hydrocarbon groups, the multiple alicyclic hydrocarbon groups, or the multiple aromatic hydrocarbon groups, the multiple aliphatic hydrocarbon groups, the multiple alicyclic hydrocarbon groups, and the multiple aromatic hydrocarbon groups may be the same as or different from each other.

In the aliphatic hydrocarbon group represented by X^{21C} to X^{26C}, the hydrogen atoms may be replaced by a halogen atom, and may also be replaced by a hydroxy group and the like. In the alicyclic hydrocarbon groups, the hydrogen atoms may be replaced by a halogen atom, and may also be replaced by a hydroxy group, the aliphatic hydrocarbon group above (such as an alkyl group and an alkenyl group), and the like. In the case of replacing by a halogen atom, preferred examples of the halogen atom substituting the hydrocarbon group represented by X^{21C} include the same halogen atom as described for the halogen atom represented by X^{21C}, and preferred examples of the halogen atom substituting the hydrocarbon group represented by X^{22C} to X^{26C} include the same halogen atom as described for the halogen atom represented by X^{22C} to X^{26C}, as defined that the halogen atom represented by X^{21C} is an atom selected from a chlorine atom, a bromine atom, and an iodine atom, and the halogen atom represented by X^{22C} to X^{26C} is an atom selected from a fluorine atom, a chlorine atom, a bromine atom, and an iodine atom.

The organic halide 1b represented by the general formula (2C) is preferably a compound, in which X^{21C} to X^{26C} each represent a halogen atom or a halogenated hydrocarbon group in which at least one hydrogen atom is replaced by a halogen atom, and at least one of X^{21C} to X^{26C} represents a halogenated hydrocarbon group. As described above, the halogen atom is preferably a chlorine atom, a bromine atom, or an iodine atom, the aliphatic hydrocarbon group is preferably an alkyl group, and the number of carbon atoms of the alkyl group is preferably 1 or more, and the upper limit thereof is preferably 16 or less, more preferably 8 or less, further preferably 4 or less, and still further preferably 2 or less.

In the case where one of X^{21C} to X^{26C} represents a halogenated hydrocarbon group, at least one of the remaining preferably represents a halogen atom or a hydrogen atom, and the number of a halogen atom or a hydrogen atom therefor is more preferably 2 or more, further preferably 3 or more, still further preferably 4 or more, and particularly preferably 5, i.e., in the case where one of X^{2I}C to X^{26C} represents a halogenated hydrocarbon group, it is particularly preferred that all the remaining represent halogen atoms, or all the remaining represent hydrogen atoms.

In the case where two or more X^{21C} to X^{26C} each represent a halogenated hydrocarbon group, at least one thereof preferably has two or more halogen atoms, and more preferably has three halogen atoms, and at least one of the remaining preferably has one halogen atom. The remaining are a hydrogen atom or a halogen atom, and preferably a hydrogen atom, and it is more preferred that all the remaining are hydrogen atoms. The compound of this type is advantageous in availability.

### (Organic Halide 1c)

The organic halide 1c is a compound represented by the general formula (3C).

In the general formula (3C), X^{31C} and X^{32C} each independently represent a hydrogen atom, a halogen atom, an aliphatic hydrocarbon group, an alicyclic hydrocarbon group, an aromatic hydrocarbon group, or a group represented by the general formula (3Ca), and in the general formula (3Ca), R^{31C} represents a single bond or an aliphatic hydrocarbon group, and R^{32C} represents a hydrogen atom, a halogen atom, or an aliphatic hydrocarbon group. The hydrogen atoms of the aliphatic hydrocarbon group, the alicyclic hydrocarbon group, and the aromatic hydrocarbon group may be replaced by a halogen atom, and at least one of X^{31C} and X^{32C} represents a halogen atom or a group containing a halogen atom. In the general formula (3C), the halogen atom represented by X^{31C} is an atom selected from a chlorine atom, a bromine atom, and an iodine atom, and the halogen atom represented by X^{32C} is an atom selected from a fluorine atom, a chlorine atom, a bromine atom, and an iodine atom.

Preferred examples of the halogen atom represented by X^{31C} include those described for the halogen atom represented by X^{11C}, and preferred examples of the halogen atom represented by X^{32C} include those described for the halogen atom represented by X^{12C} to X^{14C} The halogen atom represented by X^{32C} is more preferably a fluorine atom, a chlorine atom, or a bromine atom, and further preferably a chlorine atom. In the case where X^{31C} and X^{32C} represent multiple halogen atoms, the multiple halogen atoms may be the same as or different from each other.

Preferred examples of the aliphatic hydrocarbon group, the alicyclic hydrocarbon group, and the aromatic hydrocarbon group represented by X^{31C} and X^{32C} include the same groups as described for the alicyclic hydrocarbon group, and the aromatic hydrocarbon group represented by X^{12C} to X^{14C}, in which an aliphatic hydrocarbon group is preferred.

The aliphatic hydrocarbon group is preferably an alkyl group or an alkenyl group, and more preferably an alkyl group. The number of carbon atoms of the alkyl group is preferably 1 or more, more preferably 2 or more, and further preferably 4 or more, and the upper limit thereof is preferably 24 or less, more preferably 16 or less, further preferably 12 or less, and still further preferably 10 or less. The number of carbon atoms of the alkenyl group is preferably 2 or more, and more preferably 4 or more, and the upper limit thereof is the same as described for the alkyl group. The aliphatic hydrocarbon group may be either linear or branched as similar to the aliphatic hydrocarbon group represented by X^{12C} to X^{14C}. In the case where X^{31C} and X^{32C} represent aliphatic hydrocarbon groups, alicyclic hydrocarbon groups, or aromatic hydrocarbon groups, the multiple aliphatic hydrocarbon groups, the multiple alicyclic hydrocarbon groups, and the multiple aromatic hydrocarbon groups may be the same as or different from each other, and at least one of the multiple alicyclic hydrocarbon groups, and the multiple aromatic hydrocarbon groups is a group in which the hydrogen atom thereof is replaced by a halogen atom.

In the aliphatic hydrocarbon group represented by X^{31C} and X^{32C}, the hydrogen atoms may be replaced by a halogen atom, and may also be replaced by a hydroxy group and the like. In the alicyclic hydrocarbon groups, the hydrogen atoms may be replaced by a halogen atom, and may also be replaced by a hydroxy group, the aliphatic hydrocarbon group above (such as an alkyl group and an alkenyl group), and the like. In the case of replacing by a halogen atom, preferred examples of the halogen atom substituting the hydrocarbon group represented by X^{31C} include the same halogen atom as described for the halogen atom represented by X³¹, and preferred examples of the halogen atom substituting the hydrocarbon group represented by X^{32C} include the same halogen atom as described for the halogen atom represented by X^{32C}, as defined that the halogen atom represented by X^{31C} is an atom selected from a chlorine atom, a bromine atom, and an iodine atom, and the halogen atom represented by X^{32C} is an atom selected from a fluorine atom, a chlorine atom, a bromine atom, and an iodine atom.

Examples of the divalent aliphatic hydrocarbon group represented by R^{31C} in the general formula (3Ca) include a group obtained by removing one hydrogen atom from the aliphatic hydrocarbon group represented by X^{31C} and X^{32C}. Accordingly, the divalent hydrocarbon group is preferably an alkanediyl group or an alkenediyl group, and more preferably an alkanediyl group.

The number of carbon atoms of the divalent aliphatic hydrocarbon group is preferably 1 or more, and upper limit thereof is 8 or less, more preferably 6 or less, and further preferably 4 or less.

Preferred examples of the aliphatic hydrocarbon group represented by R^{32C} in the general formula (3Ca) include the same groups as described for the aliphatic hydrocarbon group represented by X^{31C} and X^{32C}.

The aliphatic hydrocarbon group is preferably an alkyl group or an alkenyl group, and more preferably an alkyl group, and the aliphatic hydrocarbon group may be either linear or branched, and is preferably branched. In the case where the aliphatic hydrocarbon group is an alkyl group, the number of carbon atoms thereof is preferably 1 or more, more preferably 2 or more, and further preferably 4 or more, and the upper limit thereof is preferably 24 or less, more preferably 16 or less, further preferably 12 or less, and still further preferably 10 or less.

The hydrocarbon groups represented by R^{31C} and R^{32C} may be substituted by a halogen atom as similar to the hydrocarbon groups represented by X^{31C} and X^{32C}, and the halogen atom in this case is determined by whether X^{31C} or X^{32C} represents a group represented by the general formula (3Ca). In the case where X^{31C} represents a group represented by the general formula (3Ca), the halogen atom corresponds to the halogen atom represented by X^{31C}, i.e., is selected from a chlorine atom, a bromine atom, and an iodine atom, and in the case where X^{32C} represents a group represented by the general formula (3Ca), the halogen atom corresponds to the halogen atom represented by X^{32C}, i.e., is selected from a fluorine atom, a chlorine atom, a bromine atom, and an iodine atom.

The organic halide 1c represented by the general formula (3C) is preferably a compound, in which X^{31C} represents a halogen atom, and X^{32C} represents an aliphatic hydrocarbon group having 2 or more carbon atoms or a group represented by the general formula (3Ca). The halogen atom represented by X^{31C} is preferably a chlorine atom or a bromine atom, and more preferably a chlorine atom. The aliphatic hydrocarbon group represented by X^{32C} is preferably an alkyl group, in which the number of carbon atoms thereof is more preferably 4 or more, and the upper limit thereof is preferably 12 or less, and more preferably 10 or less.

In the general formula (3Ca), R^{31C} preferably represents a single bond or a divalent aliphatic hydrocarbon group, and more preferably a single bond. R^{32C} preferably represents an aliphatic hydrocarbon group, more preferably an alkyl group or an alkenyl group, and further preferably an alkyl group.

### (Organic Halide 1d)

The organic halide 1d is a compound represented by the general formula (4C).

In the general formula (4C), X^{41C} to X^{44C} each independently represent a hydrogen atom, a halogen atom, an aliphatic hydrocarbon group, an alicyclic hydrocarbon group, or an aromatic hydrocarbon group, in which the aliphatic hydrocarbon group, the alicyclic hydrocarbon group, and the aromatic hydrocarbon group may be substituted by a halogen atom, and at least one of X^{41C} to X^{44C} represents a halogen atom or a group containing a halogen atom. In the general formula (4C), the halogen atom represented by X^{41C} is an atom selected from a chlorine atom, a bromine atom, and an iodine atom, and the halogen atom represented by X^{42C} to X^{44C} is an atom selected from a fluorine atom, a chlorine atom, a bromine atom, and an iodine atom.

Preferred examples of the halogen atom represented by X^{41C} include those described for the halogen atom represented by X^{11C}, and preferred examples of the halogen atom represented by X^{42C} to X^{44C} include those described for the halogen atom represented by X^{12C} to X^{14C}. The halogen atom represented by X^{41C} is preferably a chlorine atom or a bromine atom, and preferably a chlorine atom, and the halogen atom represented by X^{42C} to X^{44C} is also the same. In the case where X^{41C} to X^{44C} represent multiple halogen atoms, the multiple halogen atoms may be the same as or different from each other.

Preferred examples of the aliphatic hydrocarbon group, the alicyclic hydrocarbon group, and the aromatic hydrocarbon group represented by X^{41C} to X^{44C} include the same groups as described for the aliphatic hydrocarbon group, the alicyclic hydrocarbon group, and the aromatic hydrocarbon group represented by X^{12C} to X^{14C}, in which an aliphatic hydrocarbon group is preferred.

The aliphatic hydrocarbon group is preferably an alkyl group or an alkenyl group, and more preferably an alkyl group. The number of carbon atoms of the alkyl group is preferably 1 or more, and the upper limit thereof is preferably 24 or less, more preferably 12 or less, further preferably 8 or less, still further preferably 4 or less, and particularly preferably 2 or less, and the number of carbon atoms of the alkenyl group is preferably 2 or more, and the upper limit thereof is the same as described for the alkyl group. The aliphatic hydrocarbon group may be either linear or branched as similar to the aliphatic hydrocarbon group represented by X^{12C} to X^{14C}. In the case where X^{41C} to X^{44C} represent aliphatic hydrocarbon groups, alicyclic hydrocarbon groups, or aromatic hydrocarbon groups, the multiple aliphatic hydrocarbon groups, the multiple alicyclic hydrocarbon groups, and the multiple aromatic hydrocarbon groups may be the same as or different from each other.

In the aliphatic hydrocarbon group represented by X^{41C} to X^{44C}, the hydrogen atoms may be replaced by a halogen atom, and may also be replaced by a hydroxy group and the like. In the alicyclic hydrocarbon groups, the hydrogen atoms may be replaced by a halogen atom, and may also be replaced by a hydroxy group, the aliphatic hydrocarbon group above (such as an alkyl group and an alkenyl group), and the like. In the case of replacing by a halogen atom, preferred examples of the halogen atom substituting the hydrocarbon group represented by X^{41C} include the same halogen atom as described for the halogen atom represented by X^{41C}, and preferred examples of the halogen atom substituting the hydrocarbon group represented by X^{42C} to X^{44C} include the same halogen atom as described for the halogen atom represented by X^{42C} to X^{44C}, as defined that the halogen atom represented by X^{41C} is an atom selected from a chlorine atom, a bromine atom, and an iodine atom, and the halogen atom represented by X^{42C} to X^{44C} is an atom selected from a fluorine atom, a chlorine atom, a bromine atom, and an iodine atom.

The organic halide 1d represented by the general formula (4C) is preferably a compound, in which X^{41C} represents a halogen atom, and X^{42C} to X^{44C} each represent a monovalent aliphatic hydrocarbon group. The halogen atom is preferably fluorine atom, a chlorine atom, or a bromine atom, and more preferably a chlorine atom. The monovalent aliphatic hydrocarbon group represented by X^{42C} to X^{44C} is preferably an alkyl group, in which the number of carbon atoms thereof is more preferably 1 or more, and the upper limit thereof is preferably 8 or less, more preferably 4 or less, and further preferably 2 or less.

### (Compound (D))

The compound (D) used in the modified sulfide solid electrolyte of the present embodiment is a compound having a formyl group (CH(═O)—). Preferred examples of the compound (D) include a compound represented by the following general formula (1D). In the case where the compound (D) has a formyl group in the manner shown by the following general formula (1D), the compound can be easily attached to the sulfide solid electrolyte, and thereby the oil absorption is reduced, the excellent coating suitability can be easily obtained, and the excellent battery capabilities can be obtained more efficiently.

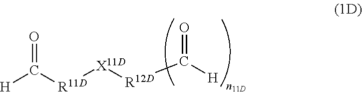

In the general formula (1D), R^{11D} and R^{12D} each independently represent an organic group or a single bond, X^{11D} represents an oxygen atom, a sulfur atom, or a single bond, and n_{11D} represents 0 or 1.

The organic group represented by R^{11D} is a divalent group, and the organic group represented by R^{12D} is a monovalent group in the case where n_{11D} represents 0, or a divalent group in the case where n_{11D} represents 1. Examples of the organic group represented by R^{11D} and R^{12D} include an aliphatic group, an alicyclic group, an aromatic group, and a heterocyclic group, in which an aliphatic group and an aromatic group are preferred.

### (Aliphatic Group)

Examples of the monovalent aliphatic group include the same groups as described for the aliphatic group represented by X^{1B} in the general formula (1B). Examples thereof include an alkyl group, an alkenyl group, and an alkynyl group, in which an alkyl group and an alkenyl group are preferred, and an alkyl group is more preferred, from the standpoint of reducing the oil absorption, easily providing the excellent coating suitability, and providing the excellent battery capabilities more efficiently.

From the same standpoint, the number of carbon atoms of the monovalent aliphatic group is preferably 1 or more, more preferably 2 or more, and further preferably 3 or more, and the upper limit thereof is preferably 20 or less, more preferably 16 or less, and further preferably 12 or less.

Typical preferred examples of the monovalent aliphatic group include a methyl group, an ethyl group, various propyl groups, various butyl groups, various pentyl groups, various hexyl groups, various heptyl groups, various octyl groups, various nonyl groups, various decyl groups, various undecyl groups, and various dodecyl groups. In the description herein, the term “various” means that a linear group, a branched group, and isomers thereof are encompassed, and for example, various propyl groups encompasses a 1-propyl group, a 2-propyl group, and a 1-methylethyl group, which are linear and branched saturated aliphatic groups having 3 carbon atoms.

The aliphatic group may be either linear or branched, and is preferably linear.

Examples of the divalent aliphatic group include a group obtained by removing one hydrogen atom to form a bonding site in the monovalent aliphatic group described above, i.e., an alkanediyl group, an alkenediyl group, and an alkynediyl group. An alkanediyl group and an alkenediyl group are preferred, and an alkanediyl group is more preferred, from the standpoint of reducing the oil absorption, easily providing the excellent coating suitability, and providing the excellent battery capabilities more efficiently.

The number of carbon atoms of the divalent aliphatic group is preferably 1 or more, and the upper limit thereof is preferably 12 or less, more preferably 8 or less, further preferably 4 or less, and still further preferably 3 or less. The other matters therefor are the same as in the monovalent aliphatic group described above.

The aliphatic group may be a group in which at least a part of the hydrogen atoms thereof is replaced by a halogen atom, a hydroxy group, an amino group, or the like.

### (Alicyclic Group)

Examples of the monovalent alicyclic group include the same groups as described for the alicyclic group represented by X^{1B} in the general formula (1B). Examples thereof include a cycloalkyl group, a cycloalkenyl group, and a cycloalkynyl group, in which a cycloalkyl group and a cycloalkenyl group are preferred, and a cycloalkyl group is more preferred, from the standpoint of reducing the oil absorption, easily providing the excellent coating suitability, and providing the excellent battery capabilities more efficiently.

From the same standpoint, the number of carbon atoms of the monovalent alicyclic group is preferably 3 or more, and more preferably 4 or more, and the upper limit thereof is preferably 20 or less, more preferably 16 or less, and further preferably 12 or less.

Typical preferred examples of the alicyclic group include a group containing multiple alicyclic rings, and preferred examples thereof include a group obtained by removing one hydrogen atom to form a bonding site from a basic structure, for example, a structure containing multiple alicyclic rings, and preferred examples thereof include a bonded polyaliphatic ring structure, such as bicyclohexyl; a structure containing two or more alicyclic rings condensed to each other, such as hexahydronaphthalene, octahydronaphthalene, and decahydronaphthalene; and a bridged cyclic structure, such as norbornane, norbornene, adamantane, tricyclodecane, and pinene. Examples of the basic structure also include a basic structure having a double bond in the alicyclic ring, such as pentalene and azulene.

Preferred examples of the basic structure also include a structure containing any of the basic structure of the monocyclic alicyclic ring, the basic structure of the polycyclic alicyclic rings, and the basic structure of the aromatic ring described later, which are bonded or condensed to each other.

As for the one hydrogen atom to be removed from the basic structure of the alicyclic group, the one hydrogen atom may be a hydrogen atom of the alicyclic ring, and may be a hydrogen atom of a substituent, such as an alkyl group, bonded to the alicyclic ring (the substituent is described later).

The basic structure of the alicyclic group may have a heterocyclic ring obtained by replacing the carbon atom of the alicyclic group described above by a hetero atom, such as a nitrogen atom, an oxygen atom, a sulfur atom, and a phosphorus atom.

The examples of the basic structure of the alicyclic group are merely typical preferred examples thereof, and the basic structure is not limited thereto. For example, examples thereof also include a group containing an alicyclic group based on the basic structure above, having bonded or condensed thereto an aromatic group or a heterocyclic group described later.

In the alicyclic group and the basic structure described above, at least a part of the hydrogen atoms may be replaced by a halogen atom, such as a fluorine atom, a hydroxy group, an amino group, or a substituent, such as the aliphatic group above. In this case, the aliphatic group is preferably an alkyl group or an alkenyl group, the number of carbon atoms of which is preferably 1 or more, and the upper limit thereof is preferably 12 or less, more preferably 8 or less, further preferably 6 or less, and still further preferably 4 or less.

Examples of the divalent alicyclic group include a group obtained by removing one hydrogen atom to form a bonding site from the monovalent alicyclic group described above. The one hydrogen atom may be a hydrogen atom of the alicyclic ring, and may be a hydrogen atom of a substituent, such as an alkyl group, bonded to the alicyclic ring.

### (Aromatic Group)

Examples of the monovalent aromatic group include the same groups as described for the aromatic group represented by X^{1B} in the general formula (1B). Preferred examples thereof include a group obtained by removing one hydrogen atom to form a bonding site from a basic structure, for example, a monocyclic aromatic compound, such as benzene, toluene, and styrene; a bonded polycyclic aromatic compound containing multiple aromatic rings bonded to each other, such as biphenyl, diphenylmethane (benzylbenzene), diphenylethane (bibenzyl), methylidynetrisphenol, and triphenylcyclohexane; and a condensed polycyclic aromatic compound containing multiple aromatic rings condensed to each other, such as naphthalene, phenanthrene, anthracene, pyrene, triphenylene, tetracene, and pentacene, and that containing an aromatic ring and an alicyclic ring condensed each other, such as indene, indacene, acenaphthene, dihydronaphthalene, tetrahydronaphthalene, biphenylene, fluorene, and fluoranthene.

As for the one hydrogen atom to be removed from the aromatic group, the one hydrogen atom may be a hydrogen atom of the aromatic ring (including the condensed polycyclic ring and the like above), and may be a hydrogen atom of a substituent, such as an alkyl group, bonded to the aromatic ring (including the condensed polycyclic ring and the like above) (the substituent is described later). A group obtained by removing one hydrogen atom of the hydrogen atoms of the substituent, such as an alkyl group, bonded to the aromatic ring (including the condensed polycyclic ring and the like above) from the standpoint of reducing the oil absorption, easily providing the excellent coating suitability, and providing the excellent battery capabilities more efficiently.

Among the above, the aromatic group is preferably an aromatic group having a monocyclic aromatic group as the basic structure, in which preferred examples thereof include a group obtained by removing one hydrogen atom to form a bonding site from an aromatic ring, such as a phenyl group, a methylphenyl group, and a vinylphenyl group; and a group obtained by removing one hydrogen atom to form a bonding site from an alkyl group bonded to an aromatic ring, such as a benzyl group, a phenylethyl group, and a phenylpropyl group, and more preferred examples thereof include a group obtained by removing one hydrogen atom to form a bonding site from an alkyl group bonded to an aromatic ring, such as a benzyl group, a phenylethyl group, and a phenylpropyl group.

The number of carbon atoms of the monovalent aromatic group is preferably 6 or more, and more preferably 7 or more, and the upper limit thereof is preferably 36 or less, more preferably 24 or less, further preferably 12 or less, and still further preferably 10 or less.

The basic structure of the aromatic group may have a heterocyclic ring obtained by replacing the carbon atom of the basic structure described above (including the condensed polycyclic ring and the like) by a hetero atom, such as a nitrogen atom, an oxygen atom, a sulfur atom, and a phosphorus atom.

The examples of the basic structure of the aromatic group are merely typical preferred examples thereof, and the basic structure is not limited thereto. For example, examples thereof also include a group containing an aromatic group based on the basic structure above, having bonded or condensed thereto the aliphatic group described above or a heterocyclic group described later.

In the basic structure described above, at least a part of the hydrogen atoms of the aromatic ring (including the condensed polycyclic ring and the like) may be replaced by a halogen atom, such as a fluorine atom, a hydroxy group, an amino group, or a substituent, such as the aliphatic group above. In this case, the aliphatic group is preferably an alkyl group or an alkenyl group, and more preferably an alkyl group, the number of carbon atoms of which is preferably 1 or more, and the upper limit thereof is preferably 12 or less, more preferably 8 or less, further preferably 6 or less, and still further preferably 4 or less.

In the case where at least a part of the hydrogen atoms of the aromatic ring (including the condensed polycyclic ring and the like) is replaced, the substituent is preferably an aliphatic group, and more preferably an alkyl group.

Examples of the divalent aromatic group include a group obtained by removing one hydrogen atom to form a bonding site from the monovalent aromatic group described above. The one hydrogen atom may be a hydrogen atom of the aromatic ring, and may be a hydrogen atom of a substituent, such as an alkyl group, bonded to the aromatic ring.

### (Heterocyclic Group)

Examples of the monovalent heterocyclic group include a monocyclic heterocyclic group obtained by removing one hydrogen atom to form a bonding site from a basic structure of a monocyclic heterocyclic compound, for example, a saturated or unsaturated monocyclic oxygen-containing heterocyclic compound, such as oxetane, tetrahydrofuran, dihydrofuran, furan, dioxolane, tetrahydropyran, and pyran; a saturated or unsaturated monocyclic nitrogen-containing heterocyclic compound, such as pyrrolidine, pyrroline, imidazolidine, imidazoline, imidazole, piperidine, pyridine, piperazine, pyridazine, pyrimidine, pyrazine, and triazine; a saturated or unsaturated monocyclic sulfur-containing heterocyclic compound, such as thietane, tetrahydrothiophene, thiophene, thiane, and thiopyran; a saturated or unsaturated monocyclic oxygen-nitrogen-containing heterocyclic compound, such as tetrahydrooxazole, oxazole, oxadiazole, succinimide, morpholine, and oxazine; a saturated or unsaturated monocyclic nitrogen-sulfur-containing heterocyclic compound, such as tetrahydrothiazole, thiazole, thiomorpholine, and thiazine; and a saturated monocyclic oxygen-sulfur-containing heterocyclic compound, such as oxathiolane, sulfolane, thioxane, and dioxooxathiane.

Examples thereof also include a polycyclic heterocyclic group obtained by removing one hydrogen atom to form a bonding site from a basic structure of a polycyclic heterocyclic compound, for example, a saturated or unsaturated condensed polycyclic oxygen-containing heterocyclic compound, such as benzofuran, octahydrobenzofuran, benzopyran, benzodioxane, dibenzofuran, xanthene, and dibenzodioxin; a saturated or unsaturated condensed polycyclic nitrogen-containing heterocyclic compound, such as indoline, indole, indolizine, benzimidazole, azaisoindole, decahydroquinoline, quinoline, quinoxaline, carbazole, acridine, phenazine, and azaadamantane; a saturated or unsaturated condensed polycyclic sulfur-containing heterocyclic compound, such as benzothiophene, benzothiopyran, dodecahydrodibenzothiophene, hexahydrodibenzothiophene, and dibenzothiophene; a condensed polycyclic oxygen-nitrogen-containing heterocyclic compound, such as furopyrrole, benzoxazole, benzoxazine, dihydrobenzoxazine, and phenoxazine; a condensed polycyclic nitrogen-sulfur-containing heterocyclic compound, such as benzothiazole, benzothiadiazole, and phenothiazine; and a condensed polycyclic oxygen-sulfur-containing heterocyclic compound, such as phenylthiochromeneone and phenoxathiin.

The number of carbon atoms of the monovalent heterocyclic group is preferably 3 or more, and more preferably 4 or more, and the upper limit thereof is preferably 36 or less, more preferably 24 or less, and further preferably 18 or less.

The examples of the polycyclic heterocyclic compound are described focusing on the condensed polycyclic compound, but are merely typical preferred examples, and for example, it is obvious that a bonded polycyclic heterocyclic compound is also included in the basic structure. A group containing the heterocyclic group described above having bonded or condensed thereto the alicyclic group and the aromatic group described above is also included therein.

As for the one hydrogen atom to be removed from the heterocyclic group, the one hydrogen atom may be a hydrogen atom of the aromatic ring, and may be a hydrogen atom of a substituent, such as an alkyl group, bonded to the heterocyclic ring (the substituent is described later).

In the basic structure described above, at least a part of the hydrogen atoms of the heterocyclic ring may be replaced by a halogen atom, such as a fluorine atom, a hydroxy group, an amino group, or a substituent, such as the aliphatic group above. In this case, the aliphatic group is preferably an alkyl group or an alkenyl group, and more preferably an alkyl group, the number of carbon atoms of which is preferably 1 or more, and the upper limit thereof is preferably 12 or less, more preferably 8 or less, further preferably 6 or less, and still further preferably 4 or less.

Examples of the divalent heterocyclic group include a group obtained by removing one hydrogen atom to form a bonding site from the monovalent heterocyclic group described above. The one hydrogen atom may be a hydrogen atom of the heterocyclic ring, and may be a hydrogen atom of a substituent, such as an alkyl group, bonded to the heterocyclic ring.

X^{11D} represents an oxygen atom, a sulfur atom, or a single bond. X^{11D} preferably represents an oxygen atom or a single bond from the standpoint of reducing the oil absorption, easily providing the excellent coating suitability, and easily providing the excellent battery capabilities more efficiently.

n_{11D} represents 0 or 1, and preferably represents 0, from the standpoint of reducing the oil absorption, easily providing the excellent coating suitability, and easily providing the excellent battery capabilities more efficiently.

As for the preferred combination of R^{11D}, R^{12D}, X^{11D}, and n_{11D} in the general formula (1D) in the case where X^{11D} represents a single bond, it is preferred that R^{11D} represents a single bond, R^{12D} represents an aliphatic group, and n_{11D} represents 0, in which the aliphatic group represented by R^{12D} is preferably an alkyl group, and the number of carbon atoms of the alkyl group is as described above.

Typical preferred examples of the compound (D) of this type include heptanal (represented by the general formula (1D), in which R^{11D} and X^{11D} represent single bonds, n_{11D} represents 0, and R^{12D} represents a hexyl group) and undecanal (represented by the general formula (1D), in which R^{11D} and X^{11D} represent single bonds, n_{11D} represents 0, and R^{12D} represents a decyl group). It is obvious that any of compounds that have the similar structure can also provide the similar effects.

As for the preferred combination of R^{11D}, R^{12D}, X^{11D}, and n_{11D} in the general formula (1D) in the case where X^{11D} represents an oxygen atom, it is preferred that R^{11D} represents an aliphatic group, R^{12D} represents an aromatic group, and n_{11D} represents 0, in which the aliphatic group represented by R^{11D} is preferably an alkyl group, and the number of carbon atoms of the alkyl group is as described above. The aromatic group represented by R^{12D} is preferably an aromatic group having a monocyclic aromatic compound as the basic structure, more preferably a group obtained by removing one hydrogen atom to form a bonding site from an aliphatic group (preferably an alkyl group), the aliphatic group (preferably an alkyl group) being bonded to an aromatic ring, in which a benzyl group, a phenylethyl group, and a phenylpropyl group are preferred, and a benzyl group is more preferred.

Typical preferred examples of the compound (D) of this type include benzyloxyacetaldehyde (represented by the general formula (D), in which X^{11D} represents an oxygen atom, R¹¹ represents a methylene group, n_{11D} represents 0, and R^{12D} represents a benzyl group). It is obvious that any of compounds that have the similar structure can also provide the similar effects.

In the modified sulfide solid electrolyte of the present embodiment, the compound (D) may be used alone, or multiple kinds thereof may be used in combination.

### (Compound (E))

The compound (E) used in the modified sulfide solid electrolyte of the present embodiment is a compound having two or more acetyl groups (CH₃C(═O)—). Preferred examples of the compound (E) include a compound represented by the following general formula (1E). In the case where the compound (E) has two or more acetyl groups, and the two or more acetyl groups exist in the manner shown by the following general formula (1E), the compound can be easily attached to the sulfide solid electrolyte, and thereby the oil absorption is reduced, the excellent coating suitability can be easily obtained, and the excellent battery capabilities can be obtained more efficiently.

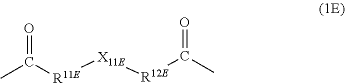

In the general formula (1E), R^{11E} and R^{12E} each independently represent an organic group or a single bond, and X^{11E} represents an oxygen atom, a sulfur atom, or a single bond.

The organic group represented by R^{11E} and R^{12E} is a divalent organic group, and examples thereof include a divalent aliphatic group, a divalent alicyclic group, a divalent aromatic group, and a divalent heterocyclic group in the organic groups described for R^{11D} and R^{12D}, in which a divalent aliphatic group is preferred. The divalent aliphatic group, the divalent alicyclic group, the divalent aromatic group, and the divalent heterocyclic group are the same as described for the organic groups described for R^{11D} and R^{12D}.

As for the preferred combination of R^{11E}, R^{12E}, and X^{11E} in the general formula (1E), it is preferred that any one of R^{11E} and R^{12E} represents an aliphatic group, the other one thereof represents a single bond, and X^{11E} represents a single bond, and the aliphatic group represented by any one of R^{11E} and R^{12E} is preferably an alkanediyl group.

The number of carbon atoms of the alkanediyl group is as described for the number of carbon atoms of the divalent aliphatic group represented by R^{11D} and R^{12D}, i.e., is preferably 1 or more, and the upper limit thereof is preferably 12 or less, more preferably 8 or less, further preferably 4 or less, and still further preferably 3 or less.

X^{11E} represents an oxygen atom, a sulfur atom, or a single bond. X^{11E} preferably represents a single bond from the standpoint of reducing the oil absorption, easily providing the excellent coating suitability, and easily providing the excellent battery capabilities more efficiently.

Typical preferred examples of the compound (E) of this type include acetylacetone (represented by the general formula (1E), in which R^{11E} and X^{11E} represent single bonds, and R^{12E} represents a methylene group). It is obvious that any of compounds that have the similar structure can also provide the similar effects.

In the modified sulfide solid electrolyte of the present embodiment, the compound (E) may be used alone, or multiple kinds thereof may be used in combination.

### (Compound (F))

The compound (F) used in the modified sulfide solid electrolyte of the present embodiment is an organic halide 2 having two or more halogen-containing groups represented by —CH₂X (in which X represents a fluorine atom or a bromine atom) and an organic group. The organic halide 2 as the compound (F) has two or more halogen-containing groups represented by —CH₂X (in which X represents a fluorine atom or a bromine atom) and an organic group, or may have two or more halogen-containing groups represented by —CH₂X (in which X represents a fluorine atom or a bromine atom) and an organic group in the manner shown by the following general formula (1F), the compound can be easily attached to the sulfide solid electrolyte, and thereby the oil absorption is reduced, the excellent coating suitability can be easily obtained, and the excellent battery capabilities can be obtained more efficiently.

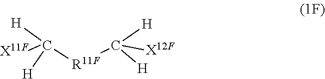

In the general formula (1F), R^{11F} represents an organic group or a single bond, and X^{11F} and X^{12F} each independently represent a fluorine atom or a bromine atom.

The organic group represented by R^{11F} is a divalent organic group, and examples thereof include a divalent aliphatic group, a divalent alicyclic group, a divalent aromatic group, and a divalent heterocyclic group in the organic groups described for R^{11D} and R^{12D}, in which a divalent aliphatic group is preferred.

Examples of the divalent aliphatic group include a group obtained by removing one hydrogen atom to form a bonding site in the monovalent aliphatic group described above, i.e., an alkanediyl group, an alkenediyl group, and an alkynediyl group, as similar to the divalent aliphatic group represented by R^{11D} and R^{12D}. An alkanediyl group and an alkenediyl group are preferred, and an alkanediyl group is more preferred, from the standpoint of reducing the oil absorption, easily providing the excellent coating suitability, and providing the excellent battery capabilities more efficiently.

The number of carbon atoms of the divalent aliphatic group is preferably 1 or more, and the upper limit thereof is preferably 20 or less, more preferably 16 or less, further preferably 12 or less, and still further preferably 10 or less.

The aliphatic group may be either linear or branched, and is preferably linear. The other matters therefor are the same as in the aliphatic group represented by R^{11D} and R^{12D}.

A divalent alicyclic group, a divalent aromatic group, and a divalent heterocyclic group that are capable of becoming the organic group represented by R^{11F} are the same as described for the alicyclic group, the aromatic group, and the heterocyclic group in the organic group represented by R^{11D} and R^{12D}.

R^{11F} may represent either the organic group above or a single bond, and preferably represents the organic group from the standpoint of reducing the oil absorption, easily providing the excellent coating suitability, and providing the excellent battery capabilities more efficiently.

X^{11F} and X^{12F} each independently represent a fluorine atom or a bromine atom, and X^{11F} and X^{12F} may be the same as or different from each other, and are preferably the same as each other from the standpoint of reducing the oil absorption, easily providing the excellent coating suitability, and providing the excellent battery capabilities more efficiently.

Either a fluorine atom or a bromine atom may be used, and a bromine atom is preferred from the same standpoint.

Representative preferred examples of the compound (F) of this type include a dibromoalkane, such as 1,3-dibromopropane (represented by the general formula (3), in which R^{11F} represents a methylene group, and X^{11F} and X^{12F} represent bromine atoms), 1,4-dibromobutane (represented by the general formula (1F), in which R^{11F} represents a methylene group, and X^{11F} and X^{12F} represent bromine atoms), 1,6-dibromohexane (represented by the general formula (1F), in which R^{11F} represents a 1,4-butanediyl group, and X^{11F} and X^{12F} represent bromine atoms), and 1,10-dibromodecane (represented by the general formula (3), in which R^{11F} represents a 1,8-octanediyl group, and X^{11F} and X^{12F} represent bromine atoms). A dihalogenated alkyl group having one bromine atom as a halogen atom bonded to each of the end carbon atoms, such as the compounds above, is particularly preferred. It is obvious that any of compounds that have the similar structure can also provide the similar effects.

In the modified sulfide solid electrolyte of the present embodiment, the compound (F) may be used alone, or multiple kinds thereof may be used in combination.

### (Compound (G))

The compound (G) used in the modified sulfide solid electrolyte of the present embodiment is a thiol compound. The thiol compound as the compound (G) is a compound having a thiol group, and may have a thiol group in the manner shown by the following general formulae (1G) and (2G), by which the compound can be easily attached to the sulfide solid electrolyte, and thereby the oil absorption is reduced, the excellent coating suitability can be easily obtained, and the excellent battery capabilities can be obtained more efficiently. Specifically, in the case where the compound (G) is a thiol compound 1 or a thiol compound 2 represented by the following general formulae (1G) and (2G), respectively, the oil absorption is reduced, the excellent coating suitability can be easily obtained, and the excellent battery capabilities can be obtained more efficiently.

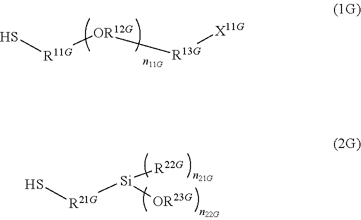

In the general formula (1G), R^{11G}, R^{12G}, and R^{13G} each independently represent an organic group or a single bond, X^{11G} represents a hydrogen atom or a thiol group, and n_{11G} represents an integer of 0 to 3, provided that at least one of R^{11G}, R^{12G}, and R^{13G} represents an organic group.

In the general formula (2G), R^{21G}, R^{22G}, and R^{23G} each independently represent an organic group, and n_{21G} and n_{22G} each represent an integer of 0 to 3, in which n_{21G} and n_{22G} satisfy n_{21G}+n_{22G}=3, provided that at least one of R^{21G}, R^{22G}, and R^{23G} represents an organic group.

The organic group represented by R^{11G}, R^{12G}, and R^{13G} in the general formula (1G) is a divalent organic group, and examples thereof include a divalent aliphatic group, a divalent alicyclic group, a divalent aromatic group, and a divalent heterocyclic group in the organic groups described for R^{11D} and R^{12D}, in which a divalent aliphatic group is preferred.

The number of carbon atoms of the divalent aliphatic groups represented by R^{11G} and R^{13G} is preferably 1 or more, and the upper limit thereof is preferably 24 or less, more preferably 20 or less, further preferably 16 or less, and still further preferably 12 or less, from the standpoint of reducing the oil absorption, easily providing the excellent coating suitability, and providing the excellent battery capabilities more efficiently.

The number of carbon atoms of the divalent aliphatic group represented by R^{12G} is preferably 1 or more, and the upper limit thereof is preferably 8 or less, more preferably 6 or less, further preferably 4 or less, and still further preferably 2 or less, from the same standpoint. In the case where multiple groups represented by R^{12G} exist (i.e., in the case where n_{11G} represents an integer of 2 or 3), the multiple groups represented by R^{12G} may be the same as or different from each other, and are preferably the same as each other.

The aliphatic group may be either linear or branched, and is preferably linear. The other matters therefor are the same as in the aliphatic group represented by R^{11D} and R^{12D}.

A divalent alicyclic group, a divalent aromatic group, and a divalent heterocyclic group that are capable of becoming the organic groups represented by R^{11G} R^{12G}, and R^{13G} are the same as described for the alicyclic group, the aromatic group, and the heterocyclic group in the organic group represented by R^{111D} and R^{12D}.

R^{11G}, R^{12G}, and R^{13G} may represent a single bond as described above, and it is preferred that at least one thereof represents the organic group above from the standpoint of reducing the oil absorption, easily providing the excellent coating suitability, and providing the excellent battery capabilities more efficiently.

X^{11G} represents either a hydrogen atom or a thiol group, and preferably represents a hydrogen atom from the standpoint of reducing the oil absorption, easily providing the excellent coating suitability, and providing the excellent battery capabilities more efficiently. In other words, the thiol compound as the compound (G) may be either a monothiol compound having one thiol group or a dithiol compound having two thiol groups, and is preferably a monothiol compound.

n_{11G} represents an integer of 0 to 3, preferably represents 0 or 1, and more preferably 0, from the same standpoint.

The organic group represented by R^{21G} in the general formula (2G) is a divalent organic group, and examples thereof include a divalent aliphatic group, a divalent alicyclic group, a divalent aromatic group, and a divalent heterocyclic group in the organic groups described for R^{11D} and R^{12D}, in which a divalent aliphatic group or a divalent aromatic group are preferred, and a divalent aromatic group is preferred. The divalent aliphatic group, the divalent alicyclic group, the divalent aromatic group, and the divalent heterocyclic group are the same as described for the organic groups represented by R^{11D} and R^{12D}.

The number of carbon atoms of the divalent aliphatic group represented by R^{21G} is preferably 1 or more, and more preferably 2 or more, and the upper limit thereof is preferably 12 or less, more preferably 8 or less, and further preferably 4 or less, from the standpoint of reducing the oil absorption, easily providing the excellent coating suitability, and providing the excellent battery capabilities more efficiently.

In the general formula (2G), R^{22G} and R^{23G} each represent a monovalent organic group, and examples thereof include a monovalent aliphatic group, a monovalent alicyclic group, a monovalent aromatic group, and a monovalent heterocyclic group in the organic groups described for R^{11D} and R^{12D}, in which a monovalent aliphatic group is preferred. The monovalent aliphatic group, the monovalent alicyclic group, the monovalent aromatic group, and the monovalent heterocyclic group are the same as described for the organic groups represented by R^{11D} and R^{12D}.

The number of carbon atoms of the monovalent aliphatic groups represented by R^{22G} and R^{23G} is preferably 1 or more, and the upper limit thereof is preferably 12 or less, more preferably 8 or less, further preferably 4 or less, and still further preferably 2 or less, from the standpoint of reducing the oil absorption, easily providing the excellent coating suitability, and providing the excellent battery capabilities more efficiently.

In the case where multiple groups represented by R^{22G} or R^{23G} exist (i.e., in the case where n_{21G} represents an integer of 1 or 2), the multiple groups represented by R^{22G} or R^{23G} may be the same as or different from each other, and are preferably the same as each other.

The aliphatic groups represented by R^{21G}, R^{22G}, and R^{23G} each may be either linear or branched, and is preferably linear. The other matters therefor are the same as in the aliphatic group represented by R^{11D} and R^{12D}.

A monovalent or divalent alicyclic group, a monovalent or divalent aromatic group, and a monovalent or divalent heterocyclic group that are capable of becoming the organic groups represented by R^{21G}, R^{22G}, and R^{23G} are the same as described for the alicyclic group, the aromatic group, and the heterocyclic group in the organic group represented by R^{11D} and R^{12D}.

As for the compound (G) of this type, representative preferred examples of the thiol compound 1 represented by the general formula (1G) include 1-dodecanethiol (represented by the general formula (1G), in which R^{11G} represents a single bond, n_{11G} represents 0, R^{13G} represents 1,12-dodecanediyl group, and X^{11G} represents a hydrogen atom) and 1,10-decanedithiol (represented by the general formula (1G), in which R^{11G} represents a single bond, n_{11G} represents 0, R^{13G} represents 1,10-decanediyl group, and X^{11G} represents a thiol group). Representative preferred examples of the thiol compound 2 represented by the general formula (2G) include 3-mercaptopropyltrimethoxysilane (represented by the general formula (2G), in which R^{21G} represents a 1,3-propanediyl group, R^{23G} represents a methyl group, n_{21G} represents 0, and n_{22G} represents 3). It is obvious that any of compounds that have the similar structure can also provide the similar effects.

In the modified sulfide solid electrolyte of the present embodiment, the compound (G) may be used alone, or multiple kinds thereof may be used in combination, and at least one kind of a compound selected from the compound represented by the general formula (1G) and the compound represented by general formula (2G) may be used. For example, the compound represented by general formula (1G) may be used alone, or two kinds of the compounds represented by the general formula (1G) may be used in combination, and the compound represented by general formula (2G) is also the same. For example, furthermore, one kind or multiple kinds of the compound represented by general formula (1G) and one kind or multiple kinds of the compound represented by general formula (2G) may be used in combination.

### (Compound (H))

The compound (H) used in the modified sulfide solid electrolyte of the present embodiment is a metal-free phosphorus compound (provided that the compound does not contain an oxygen atom that is bonded to a phosphorus atom via a single bond). It suffices that the compound (H) is a phosphorus compound that does not contain a metal atom, provided that the compound does not contain an oxygen atom that is bonded to a phosphorus atom via a single bond. Accordingly, the compound (H) does not encompass a compound having a phosphorus atom bonded to a hydrocarbon group via an oxygen atom, for example a compound having various organic groups bonded to a phosphorus atom via an alkoxy group or an ether bond.

The compound (H) is a compound that does not contain a metal atom, and contains a phosphorus atom, and may contain a phosphorus atom in the manner shown by the following general formulae (1H) to (3H), by which the compound can be easily attached to the sulfide solid electrolyte, and thereby the oil absorption is reduced, the excellent coating suitability can be easily obtained, and the excellent battery capabilities can be obtained more efficiently. Accordingly, preferred examples of the compound (H) include a metal-free phosphorus compound 1H represented by the following general formula (1H), a metal-free phosphorus compound 2H represented by the following general formula (2H), and a metal-free phosphorus compound 3H represented by the following general formula (3H). In the modified sulfide solid electrolyte of the present embodiment, the compound (H) used may be any of the metal-free phosphorus compounds represented by these general formulae used alone, or multiple kinds thereof may be used in combination (for example, multiple kinds of the compounds represented by the following general formula (1H) may be used in combination).

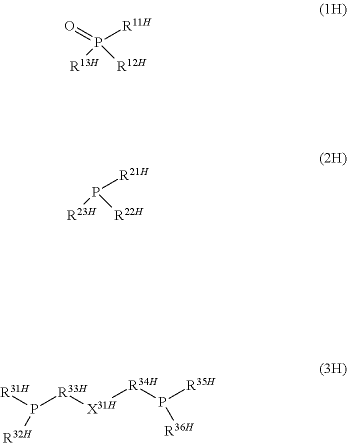

In the general formula (1H), R^{11H}, R^{12H}, and R^{13H} each independently represent an organic group.

In the general formula (2H), R^{21H}, R^{22H}, and R^{23H} each independently represent an organic group.

In the general formula (3H), R^{31H}, R^{32H}, R^{35H}, and R^{36H} each independently represent an organic group, R^{33H} and R^{34H} each independently represent a single bond or an organic group, and X^{31H} represents a single bond or an oxygen atom. At least one of R^{33H} and R^{34H} represents an organic group, and R^{33H} and R^{34H} may be bonded to each other to form a condensed ring.

### (Metal-Free Phosphorus Compound 1H)

The metal-free phosphorus compound 1H is a compound represented by the general formula (1H).

In the general formula (1H), R^{11H}, R^{12H}, and R^{13H} each independently represent an organic group.

The organic group represented by R^{11H}, R^{12H}, and R^{13H} is a monovalent organic group, and examples thereof include a monovalent aliphatic group, a monovalent alicyclic group, a monovalent aromatic group, and a monovalent heterocyclic group in the organic groups described for R^{11D} and R^{12D}, in which a monovalent aliphatic group is preferred. The monovalent aliphatic group, the monovalent alicyclic group, the monovalent aromatic group, and the monovalent heterocyclic group are the same as described for the organic groups represented by R^{11D} and R^{12D}.

The number of carbon atoms of the monovalent aliphatic group represented by R^{11H}, R^{12H}, and R^{13H} is preferably 1 or more, more preferably 2 or more, and further preferably 3 or more, and the upper limit thereof is preferably 20 or less, more preferably 16 or less, further preferably 12 or less, and still further preferably 10 or less, from the standpoint of reducing the oil absorption, easily providing the excellent coating suitability, and providing the excellent battery capabilities more efficiently.

The aliphatic groups each may be either linear or branched, and is preferably linear. The other matters therefor are the same as in the aliphatic group represented by R^{11D} and R^{12D}.

A monovalent alicyclic group, a monovalent aromatic group, and a monovalent heterocyclic group that are capable of becoming the organic groups represented by R^{11H}, R^{12H}, and R^{13H} are the same as described for the alicyclic group, the aromatic group, and the heterocyclic group in the organic group represented by R^{11D} and R^{12D}.

R^{11H}, R^{12H}, and R^{13H} each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group.

Representative preferred examples of the metal-free phosphorus compound 1H of this type represented by the general formula (1H) include tri-n-octylphosphine oxide (represented by the general formula (1H), in which R^{11H}, R^{12H}, and R^{13H} represent 1-octyl groups). It is obvious that any of compounds that have the similar structure can also provide the similar effects.

### (Metal-Free Phosphorus Compound 2H)

The metal-free phosphorus compound 2H is a compound represented by the general formula (2H).

In the general formula (2H), R^{21H}, R^{22H}, and R^{23H} each independently represent an organic group.

The organic group represented by R^{21H}, R^{22H}, and R^{23H} is a monovalent organic group, and examples thereof include a monovalent aliphatic group, a monovalent alicyclic group, a monovalent aromatic group, and a monovalent heterocyclic group in the organic groups described for R^{11D} and R^{12D}, in which a monovalent aliphatic group and a monovalent aromatic group are preferred. The monovalent aliphatic group, the monovalent alicyclic group, the monovalent aromatic group, and the monovalent heterocyclic group are the same as described for the organic groups represented by R^{11D} and R^{12D}.

The number of carbon atoms of the monovalent aliphatic group represented by R^{21H}, R^{22H}, and R^{23H} is preferably 1 or more, more preferably 2 or more, and further preferably 3 or more, and the upper limit thereof is preferably 20 or less, more preferably 16 or less, further preferably 12 or less, and still further preferably 10 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R^{11D} and R^{12D}.

The monovalent aromatic group represented by R^{21H}, R^{22H}, and R^{23H} is preferably an aromatic group having a monocyclic aromatic compound as the basic structure in the aromatic group described for the aromatic group represented by R^{11D} and R^{12D}, in which a phenyl group is more preferred.

R^{21H}. R^{22H}, and R^{23H} each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group.

Representative preferred examples of the metal-free phosphorus compound 2H of this type represented by the general formula (2H) include tri-n-octylphosphine (represented by the general formula (2H), in which R^{21H}, R^{22H}, and R^{23H} represent 1-octyl groups) and triphenylphosphine (represented by the general formula (2H), in which R^{21H}, R^{22H}, and R^{23H} represent phenyl groups). It is obvious that any of compounds that have the similar structure can also provide the similar effects.

### (Metal-Free Phosphorus Compound 3H)

The metal-free phosphorus compound 3H is a compound represented by the general formula (3H).

In the general formula (3H), R^{31H}, R^{32H}, R^{35H}, and R^{36H} each independently represent an organic group. R^{33H} and R^{34H} each independently represent a single bond or an organic group, and X^{31H} represents a single bond or an oxygen atom. At least one of R^{33H} and R^{34H} represents an organic group, and R^{33H} and R^{34H} may be bonded to each other to form a condensed ring.

The organic group represented by R^{31H}, R^{32H}, R^{35H}, and R^{36H} is a monovalent organic group, and examples thereof include a monovalent aliphatic group, a monovalent alicyclic group, a monovalent aromatic group, and a monovalent heterocyclic group in the organic groups described for R^{11D} and R^{12D}, in which a monovalent aliphatic group and a monovalent aromatic group are preferred, and a monovalent aromatic group is more preferred. The monovalent aliphatic group, the monovalent alicyclic group, the monovalent aromatic group, and the monovalent heterocyclic group are the same as described for the organic groups represented by R^{11D} and R^{12D}.

The monovalent aromatic group represented by R^{31H}, R^{32H}, R^{35H}, and R^{36H} is preferably an aromatic group having a monocyclic aromatic compound as the basic structure in the aromatic group described for the aromatic group represented by R^{11D} and R^{12D}, and more preferably a phenyl group.

R^{31H}, R^{32H}, R^{35H}, and R^{36H} each may represent an organic group having an oxygen atom, and for example, may represent a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group, and a group having an oxygen atom and an aromatic group.

The organic group represented by R^{33H} and R^{34H} is a divalent organic group, and examples thereof include a divalent aliphatic group, a divalent alicyclic group, a divalent aromatic group, and a divalent heterocyclic group in the organic groups described for R^{11D} and R^{12D}, in which a divalent aliphatic group or a divalent aromatic group are preferred, and a divalent aromatic group is preferred. The divalent aliphatic group, the divalent alicyclic group, the divalent aromatic group, and the divalent heterocyclic group are the same as described for the organic groups represented by R^{11D} and R^{12D}.

The number of carbon atoms of the divalent aliphatic group represented by R^{33H} and R^{34H} is preferably 1 or more, more preferably 2 or more, and further preferably 3 or more, and the upper limit thereof is preferably 16 or less, more preferably 12 or less, further preferably 8 or less, and still further preferably 6 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R^{11D} and R^{12D}.

The divalent aromatic group represented by R^{33H} and R^{34H} may be a divalent aromatic group in the aromatic group described for the aromatic group represented by R^{11D} and R^{12D}, and may be a group obtained by removing two hydrogen atoms to form bonding sites from the basic structure of the monocyclic aromatic compound, the bonded polycyclic aromatic compound, and the condensed polycyclic aromatic compound described above, and preferably a group obtained by removing two hydrogen atoms to form bonding sites from the basic structure of the monocyclic aromatic compound and the condensed polycyclic aromatic compound described above.

At least one of R^{33H} and R^{34H} represents an organic group.

R^{33H} and R^{34H} may be bonded to each other to form a condensed ring. In this case, X^{31H} represents a single bond. Examples of the condensed ring in this case include the condensed ring described for the alicyclic group, the aromatic group, and the heterocyclic group represented by R^{11D} and R^{12D}.

In the case where X^{31H} represents an oxygen atom, R^{33H}, X^{31H}, and R^{34H} may be bonded to each other to form a condensed ring. Examples of the condensed ring in this case include the condensed polycyclic heterocyclic compound containing an oxygen atom described for the heterocyclic group represented by R^{11D} and R^{12D}.

Representative preferred examples of the metal-free phosphorus compound 3H of this type represented by the general formula (3H) include 1,4-bis(diphenylphosphino) butane (represented by the general formula (3H), in which R^{31H}, R^{32H}, R^{35H}, and R^{36H} represent phenyl groups, R^{33H} represents a 1,4-butanediyl group, and R^{34H} and X^{31H} represent single bonds), bis((2-diphenylphosphino)phenyl) ether (represented by the general formula (3H), in which R^{31H}, R^{32H}, R^{35H}, and R^{36H} represent phenyl groups, R^{33H} and R^{34H} represent benzenediyl groups, and X^{31H} represents an oxygen atom), and 4,5-bis(diphenylphosphino)-9,9-dimethylxanthene (represented by the general formula (3H), in which R^{31H}, R^{32H}, R^{35H}, and R^{36H} represent phenyl groups, R^{33H} represents a xanthen-4,5-diyl group, and R^{34H} and X^{31H} represent single bonds, which may also be considered that R^{33H} represents a dihydrobenzopyranyl group, R^{34H} represents a phenyl group, R^{33H} and R^{34H} are condensed to each other to form a xanthen-4,5-diyl group). It is obvious that any of compounds that have the similar structure can also provide the similar effects.

In the modified sulfide solid electrolyte of the present embodiment, the compound (H) may be used alone, or multiple kinds thereof may be used in combination, and at least one kind of a compound selected from the metal-free phosphorus compound 1H represented by the general formula (1H), the metal-free phosphorus compound 2H represented by the general formula (2H), and the metal-free phosphorus compound 3H represented by the general formula (3H) may be used. For example, the compound represented by general formula (1H) may be used alone, or two kinds of the metal-free phosphorus compounds 1H represented by the general formula (1H) may be used in combination, and the metal-free phosphorus compounds 2H and 3H represented by the general formulae (2H) and (3H) are also the same. For example, furthermore, one kind or multiple kinds of the metal-free phosphorus compound 1H represented by general formula (1H) and one kind or multiple kinds of the metal-free phosphorus compound 2H represented by general formula (2H) may be used in combination, and the combination of the metal-free phosphorus compound 2H represented by the general formula (2H) and the metal-free phosphorus compound 3H represented by the general formula (3H), and the combination of the metal-free phosphorus compound 1H represented by the general formula (1H) and the metal-free phosphorus compound 3H represented by the general formula (3H) are also the same.

The molecular weight of the compound (H) is preferably 3,000 or less, more preferably 2,000 or less, further preferably 1,500 or less, and still further preferably 1,000 or less, from the standpoint of reducing the oil absorption, easily providing the excellent coating suitability, and providing the excellent battery capabilities more efficiently.

### (Compound (I))

The compound (I) used in the modified sulfide solid electrolyte of the present embodiment is a metal-free boron compound. It suffices that the compound (I) is a boron compound that does not contain a metal. The metal-free boron compound as the compound (I) is a compound that does not contain a metal atom and contains a boron atom, and may contain a boron atom in the manner shown by the following general formula (1I), by which the compound can be easily attached to the sulfide solid electrolyte, and thereby the oil absorption is reduced, the excellent coating suitability can be easily obtained, and the excellent battery capabilities can be obtained more efficiently. Accordingly, preferred examples of the compound (I) include a metal-free boron compound represented by the following general formula (1I).

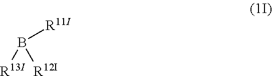

In the general formula (1I), R^{11I}, R^{12I}, and R^{13I} each independently represent an organic group.

The organic group represented by R^{11I}, R^{12I}, and R^{13I} is a monovalent organic group, and examples thereof include a monovalent aliphatic group, a monovalent alicyclic group, a monovalent aromatic group, and a monovalent heterocyclic group in the organic groups described for R^{11D} and R^{12D}, in which a monovalent aliphatic group is preferred. The monovalent aliphatic group, the monovalent alicyclic group, the monovalent aromatic group, and the monovalent heterocyclic group are the same as described for the organic groups represented by R^{11D} and R^{12D}.

The number of carbon atoms of the monovalent aliphatic group represented by R^{11I}, R^{12I}, and R^{13I} is preferably 1 or more, more preferably 2 or more, further preferably 4 or more, and still further preferably 6 or more, and the upper limit thereof is preferably 28 or less, more preferably 24 or less, further preferably 20 or less, and still further preferably 18 or less, from the standpoint of reducing the oil absorption, easily providing the excellent coating suitability, and providing the excellent battery capabilities more efficiently.

The aliphatic group may be either linear or branched, and is preferably linear. The other matters therefor are the same as in the aliphatic group represented by R^{11D} and R^{12D}.

R^{11I}, R^{12I}, and R^{13I} each also preferably represent an organic group having an oxygen atom. Examples of the organic group having an oxygen atom include a group having a group selected from the monovalent alicyclic group, the monovalent alicyclic group, the monovalent aromatic group, and the monovalent heterocyclic group, bonded via an oxygen atom. In this case, the monovalent organic group bonded via an oxygen atom is preferably a group having an oxygen atom and an aliphatic group, and particularly preferably a group having an oxygen atom and an alkyl group, i.e., an alkoxy group. The number of carbon atoms of the aliphatic group may be the same as the preferred number of carbon atoms of the monovalent aliphatic group represented by R^{11I}, R^{12I}, and R^{13I} described above.

Representative preferred examples of the compound (I) represented by the general formula (1I) include tri-n-octyl borate (represented by the general formula (1I), in which R^{11I}, R^{12I}, and R^{13I} represent octyloxy groups) and tri-n-octadecyl borate (represented by the general formula (1I), in which R^{11I}, R^{12I}, and R^{13I} represent octadecyloxy groups). It is obvious that any of compounds that have the similar structure can also provide the similar effects.

In the modified sulfide solid electrolyte of the present embodiment, the compound (I) may be used alone, or multiple kinds thereof may be used in combination.

### (Content and the Like of Compounds (A) to (I))

The content of the at least two kinds of compounds selected from the compounds (A) to (I) contained in the modified sulfide solid electrolyte of the present embodiment may vary depending on the kinds of the compounds used, and therefore cannot be determined unconditionally, and the content thereof is preferably 0.03 part by mass or more, more preferably 0.05 part by mass or more, further preferably 0.1 part by mass or more, and still further preferably 0.5 part by mass or more, and the upper limit thereof is preferably 25 parts by mass or less, and more preferably 20 parts by mass or less, per 100 parts by mass of the sulfide solid electrolyte. In the case where the content thereof is in the range, the coating suitability in coating as a paste can be efficiently enhanced, and the excellent battery capabilities can be obtained more efficiently.

As for the compounds (A) to (I) used in the modified sulfide solid electrolyte of the present embodiment, the use of two or more kinds of the compounds reduces the oil absorption, provides the excellent coating suitability, and provides the excellent battery capabilities efficiently.

In the compounds (A) to (I), as described above, the compound (B) is a compound that exerts a further excellent effect on the exertion of the oxidation resistance among the compounds (A) to (I), and the other compounds (A) and (C) to (I) each are a compound that exerts a further excellent effect on the reduction of the oil absorption. Therefore, it is preferred to use a combination of the compound that is excellent in enhancement of the oxidation resistance and the compound that is excellent in reduction of the oil absorption for enhancing the coating suitability through the reduction of the oil absorption, enhancing the battery capabilities through the enhancement of the density of the sulfide solid electrolyte, and enhancing the oxidation resistance, which is one of the battery capabilities. More specifically, it is preferred to use a combination of at least one kind of a compound selected from the compound (B) and at least one kind of a compound selected from the compounds (A) and (C) to (I), and it is more preferred to use a combination of at least one kind of a compound selected from the compound (B) and at least one kind of a compound selected from the compounds (A), (C), and (F).

In the case where the compound excellent in enhancement of the oxidation resistance (which may be hereinafter referred to as a “compound α”) the compound excellent in reduction of the oil absorption (which may be hereinafter referred to as a “compound β”) are used in combination, the ratio of the compound β with respect to the total amount of the compound α and the compound β is preferably 10% by mass or more, more preferably 20% by mass or more, further preferably 35% by mass or more, and still further preferably 50% by mass or more, and the upper limit thereof is preferably 95% by mass or less, more preferably 90% by mass or less, and further preferably 85% by mass or less, by which both the reduction of the oil absorption and the enhancement of the oxidation resistance can be simultaneously achieved to a high level with a well-balanced manner.

In the compounds (A) to (I), the compounds that are not indicated with molecular weight (specifically, the compounds (B) to (G) and (I), provided that as for the compound (B), the epoxy compound 1B is excluded since the number average molecular weight is described) each are preferably a compound that has a prescribed molecular weight from the standpoint of easily providing the excellent coating suitability, and providing the excellent battery capabilities more efficiently, as similar to the compound (H). Specifically, the molecular weight of the compound is preferably 3,000 or less, more preferably 2,000 or less, further preferably 1,500 or less, and still further preferably 1,000 or less, from the standpoint of easily providing the excellent coating suitability, and providing the excellent battery capabilities more efficiently.

The content of the at least one compound selected from the compounds (A) to (I) that has a molecular weight of 3,000 or less with respect to the total content of the at least one compound selected from the compounds (A) to (I) in the modified sulfide solid electrolyte is preferably 90% by mass or more, more preferably 95% by mass or more, further preferably 99% by mass or more, and still further preferably 100% by mass, i.e., it is still further preferred that the total amount thereof is occupied by the compounds having a number average molecular weight of 3,000 or less.

Conversely, the content of the at least one compound selected from the compounds (A) to (I) that has a molecular weight exceeding 3,000 with respect to the total content of the at least one compound selected from the compounds (A) to (I) in the modified sulfide solid electrolyte is preferably 10% by mass or less, more preferably 5% by mass or less, further preferably 1% by mass or less, and still further preferably 0% by mass, i.e., it is still further preferred that the compound having a molecular weight exceeding 3,000 is not contained.

### (Production of Sulfide Solid Electrolyte)

The sulfide solid electrolyte for forming the modified sulfide solid electrolyte of the present embodiment is then described. The sulfide solid electrolyte used in the present embodiment is not particularly limited, as long as containing a lithium atom, a sulfur atom, a phosphorus atom, and a halogen atom, and having a BET specific surface area of 10 m²/g or more, and a commercially available product or a produced product may be used.

As for the case where the sulfide solid electrolyte used in the present embodiment is produced, the method of producing the same is described. The sulfide solid electrolyte used in the present embodiment can be produced, for example, by a production method including mixing two or more kinds of raw materials selected from compounds containing at least one atom of a lithium atom, a sulfur atom, a phosphorus atom, and a halogen atom.

### (Raw Materials)

Two or more kinds of compounds selected from compounds containing at least one atom of a lithium atom, a sulfur atom, a phosphorus atom, and a halogen atom can be used as the raw materials.

The compound used as the raw material contains at least one atom of a lithium atom, a sulfur atom, a phosphorus atom, and a halogen atom, and more specifically, representative examples thereof include a raw material containing at least two kinds of atoms selected from the four kinds of atoms above, for example, lithium sulfide; a lithium halide, such as lithium fluoride, lithium chloride, lithium bromide, and lithium iodide; an alkali metal halide, such as a sodium halide, e.g., sodium iodide, sodium fluoride, sodium chloride, and sodium bromide; a phosphorus sulfide, such as diphosphorus trisulfide (P₂S₃) and diphosphorus pentasulfide (P₂S₅); a phosphorus halide, such as various phosphorus fluoride (e.g., PF₃ and PF₅), various phosphorus chloride (e.g., PC₁₃, PCl₅, and P₂Cl₄), various phosphorus bromide (e.g., PBr₃ and PBr₅), and various phosphorus iodide (e.g., PI₃ and P₂I₄); a thiophosphoryl halide, such as thiophosphoryl fluoride (PSF₃), thiophosphoryl chloride (PSCl₃), thiophosphoryl bromide (PSBr₃), thiophosphoryl iodide (PSI₃), thiophosphoryl dichloride fluoride (PSCl₂F), and thiophosphoryl dibromide fluoride (PSBr₂F); and an elemental halogen, such as fluorine (F₂), chlorine (Cl₂), bromine (Br₂), and iodine (I₂), preferably bromine (Br₂) and iodine (I₂).

Examples of the compound that can be used in addition to the raw materials described above include a compound containing at least one kind of an atom selected from the four kinds of atoms above and containing an atom other than the four kinds of atoms, and more specifically, examples thereof include a lithium compound, such as lithium oxide, lithium hydroxide, and lithium carbonate; an alkali metal sulfide, such as sodium sulfide, potassium sulfide, rubidium sulfide, and cesium sulfide; a metal sulfide, such as silicon sulfide, germanium sulfide, boron sulfide, gallium sulfide, tin sulfide (such as SnS and SnS₂), aluminum sulfide, and zinc sulfide; a phosphoric acid compound, such as sodium phosphate and lithium phosphate; a metal halide, such as an aluminum halide, a silicon halide, a germanium halide, an arsenic halide, a selenium halide, a tin halide, an antimony halide, a tellurium halide, and a bismuth halide; and a phosphorus oxyhalide, such as phosphorus oxychloride (POCl₃) and phosphorus oxybromide (POBr₃).

In the present embodiment, the halogen atom is preferably a chlorine atom, a bromine atom, or an iodine atom, and more preferably a bromine atom or an iodine atom, from the standpoint of providing a sulfide solid electrolyte having a high ionic conductivity more easily. These atoms may be used alone, or multiple kinds thereof may be used in combination. Specifically, taking a lithium halide as an example, lithium bromide may be used alone, lithium iodide may be used alone, or lithium bromide and lithium iodide may be used in combination.

From the same standpoint, the compound that can be used as the raw material is preferably a phosphorus sulfide, such as diphosphorus trisulfide (P₂S₃) and diphosphorus pentasulfide (P₂S₅); an elemental halogen, such as fluorine (F₂), chlorine (Cl₂), bromine (Br₂), and iodine (I₂); or a lithium halide, such as lithium fluoride, lithium chloride, lithium bromide, and lithium iodide, among the above, in which diphosphorus pentasulfide is preferred as a phosphorus halide, chlorine (Cl₂), bromine (Br₂), and iodine (I₂) are preferred as an elemental halogen, and lithium chloride, lithium bromide, and lithium iodide are preferred as a lithium halide.

Preferred examples of the combination of the compounds that can be used as the raw material include a combination of lithium sulfide, diphosphorus pentasulfide, and a lithium halide, and a combination of lithium sulfide, diphosphorus pentasulfide, and an elemental halide, in which lithium bromide, lithium iodide, and lithium chloride are preferred as a lithium halide, and chlorine, bromine, and iodine are preferred as an elemental halide.

In the case where lithium sulfide is used as the compound containing a lithium atom in the present embodiment, the lithium sulfide is preferably in the form of particles.

The average particle diameter (D₅₀) of the lithium sulfide particles is preferably 10 μm or more and 2,000 μm or less, more preferably 30 μm or more and 1,500 μm or less, and further preferably 50 μm or more and 1,000 μm or less. In the description herein, the average particle diameter (D₅₀) means the diameter of the particles on the cumulative particle diameter distribution curve thereof, at which the cumulative value reaches 50% of the total from the smallest particle diameter side, and the volume distribution means an average particle diameter that can be measured, for example, with a laser diffraction-scattering particle diameter distribution analyzer. A solid raw material in the raw materials described above preferably has an average particle diameter that is equivalent to the lithium sulfide particles, i.e., preferably has an average particle diameter within the average particle diameter of the lithium sulfide particles described above.

In the case where lithium sulfide, diphosphorus pentasulfide, and a lithium halide are used as the raw material, the ratio of lithium sulfide with respect to the total of lithium sulfide and diphosphorus pentasulfide is preferably 60% by mol or more, more preferably 65% by mol or more, and further preferably 68% by mol or more, and the upper limit thereof is preferably 80% by mol or less, more preferably 78% by mol or less, and further preferably 76% by mol or less, from the standpoint of providing higher chemical stability, and the standpoint of enhancing the PS₄ fraction and providing a high ionic conductivity.

In the case where lithium sulfide, diphosphorus pentasulfide, a lithium halide, and other raw materials used depending on necessity are used, the content of lithium sulfide and diphosphorus pentasulfide based on the total thereof is preferably 60% by mol or more, more preferably 65% by mol or more, and further preferably 70% by mol or more, and the upper limit thereof is preferably 100% by mol or less, more preferably 90% by mol or less, and further preferably 80% by mol or less.

In the case where lithium bromide and lithium iodide are used as a lithium halide, the ratio of lithium bromide with respect to the total of lithium bromide and lithium iodide is preferably 1% by mol or more, more preferably 20% by mol or more, further preferably 40% by mol or more, and still further preferably 50% by mol or more, and the upper limit thereof is preferably 99% by mol or less, more preferably 90% by mol or less, further preferably 80% by mol or less, and still further preferably 70% by mol or less, from the standpoint of enhancing the PS₄ fraction and providing a high ionic conductivity.

In the case where an elemental halogen is used as the raw material, and in the case where lithium sulfide and diphosphorus pentasulfide are used, the ratio of the molar number of an elemental halogen and the molar number of lithium sulfide excluding the same molar number of lithium sulfide as the elemental halogen with respect to the molar number of an elemental halogen and the total molar number of lithium sulfide excluding the same molar number of lithium sulfide as the elemental halogen, and diphosphorus pentasulfide is preferably in a range of 60 to 90%, more preferably in a range of 65 to 85%, further preferably in a range of 68 to 82%, still further preferably in a range of 72 to 78%, and particularly preferably in a range of 73 to 77%, since the high ionic conductivity can be obtained with the ratio within the range. From the same standpoint, in the case where lithium sulfide, diphosphorus pentasulfide, and an elemental halogen are used, the content of an elemental halogen based on the total amount of lithium sulfide, diphosphorus pentasulfide, and an elemental halogen is preferably 1 to 50% by mol, more preferably 2 to 40% by mol, further preferably 3 to 25% by mol, and still further preferably 3 to 15% by mol.

In the case where lithium sulfide, diphosphorus pentasulfide, an elemental halogen, and a lithium halide are used, the content of an elemental halogen (a % by mol) and the content of a lithium halide (B % by mol) based on the total amount thereof preferably satisfy the following expression (1), more preferably satisfy the following expression (2), further preferably satisfy the following expression (3), and still further preferably satisfy the following expression (4).

$$2 \leq 2 α + β \leq 100 \qquad ( 1 )$$

$$4 \leq 2 α + β \leq 80 \qquad ( 2 )$$

$$6 \leq 2 α + β \leq 50 \qquad ( 3 )$$

$$6 \leq 2 α + β \leq 30 \qquad ( 4 )$$

### (Mixing)

Two or more kinds of the raw materials selected from compounds containing at least one atom of a lithium atom, a sulfur atom, a phosphorus atom, and a halogen atom may be mixed by using a mixer, or by using an agitator, a pulverizer, or the like.

The use of an agitator may cause mixing of the raw materials, and the use of a pulverizer causes pulverization of the raw materials, and simultaneously may cause mixing thereof. In other words, it can be understood that the sulfide solid electrolyte used in the present embodiment can be obtained by subjecting two or more kinds of the raw materials selected from compounds containing at least one atom of a lithium atom, a sulfur atom, a phosphorus atom, and a halogen atom to agitation, mixing, pulverization, or a treatment including any thereof in combination.

Examples of the agitator and the mixer include a mechanical agitation mixer capable of agitating with an agitation impeller provided inside a reaction tank (which can also be referred to as agitation mixing through agitation). Examples of the mechanical agitation mixer include a high-speed agitation mixer and a double arm mixer. Examples of the high-speed agitation mixer include a vertical shaft mixer and a horizontal shaft mixer, and any of the mixers can be used.

Examples of the shape of the agitation impeller used in the mechanical agitation mixer include a blade type, an arm type, an anchor type, a paddle type, a full zone type, a ribbon type, a multistage blade type, a twin arm type, a shovel type, a biaxial blade type, a flat blade type, and a C-type blade type, in which a shovel type, a flat blade type, and a C-type blade type, an anchor type, a paddle type, a full zone type, and the like are preferred, and an anchor type, a paddle type, and a full zone type are more preferred, from the standpoint of promoting the reaction of the raw materials more efficiently.

In the case where the mechanical agitation mixer is used, the rotation number of the agitation impeller is not particularly limited, but may be appropriately regulated corresponding to the volume and the temperature of the fluid in the reaction tank, the shape of the impeller, and the like, and is generally approximately 5 rpm or more and 400 rpm or less, preferably 10 rpm or more and 300 rpm or less, more preferably 15 rpm or more and 250 rpm or less, and further preferably 20 rpm or less and 200 rpm or less, from the standpoint of promoting the reaction of the raw materials more efficiently.

The temperature condition in mixing with the mixer is not particularly limited, and is, for example, generally-30 to 120° C., preferably-10 to 100° C., more preferably 0 to 80° C., and further preferably 10 to 60° C. The mixing time is generally 0.1 to 500 hours, and from the standpoint of making the dispersion state of the raw materials more uniform for promoting the reaction, preferably 1 to 450 hours, more preferably 10 to 425 hours, further preferably 20 to 400 hours, and still further preferably 40 to 375 hours.

The method of mixing associated with pulverization by using a pulverizer has been used as the solid phase method (mechanical milling method). Examples of the pulverizer used include a medium pulverizer using a pulverization medium.

The medium pulverizer is roughly classified into a vessel driven pulverizer and a medium agitation pulverizer. Examples of the vessel driven pulverizer include a ball mill and a bead mill including an agitation tank, a pulverization tank, or a combination thereof. Examples of the medium agitation pulverizer an impact pulverizer, such as a cutter mill, a hammer mill, and a pin mill; a tower pulverizer, such as a tower mill; an agitation tank type pulverizer, such as Attritor, AquaMizer, and a sand grinder; a flow tank type pulverizer, such as Viscomill and a pearl mill; a flow pipe type pulverizer; an annular pulverizer, such as a co-ball mill; a continuous dynamic pulverizer; and various pulverizer, such as a single screw or multiple screw kneader. Among these, a ball mill and a bead mill described for the vessel driven pulverizer are preferred, in which a planetary type thereof is more preferably, in consideration of ease of regulation of the particle diameter of the resulting sulfide and the like.

The pulverizer may be appropriately selected depending on the desired scale and the like, in which a vessel driven pulverizer, such as a ball mill and a bead mill, may be used for a relatively small scale, and another pulverizer may be used for a large scale or mass production.

In the case where the material to be mixed in a liquid state or a slurry state with a liquid, such as a solvent, in mixing as described later, a wet pulverizer capable of performing wet pulverization is preferred.

Representative examples of the wet pulverizer include a wet bead mill, a wet ball mill, and a wet vibration mill, in which a wet bead mill using beads as a pulverization medium is preferred since the condition of the pulverization operation can be freely adjusted to handle a material having a smaller particle diameter. A dry pulverizer, for example, a dry medium pulverizer, such as a dry bead mill, a dry ball mill, and a dry vibration mill, and a dry non-medium pulverizer, such as a jet pulverizer, may also be used.

In the case where the material to be mixed in a liquid state or a slurry state, a circulation operation circulating the material may be used depending on necessity. A flow type pulverizer may also be used. Specific examples thereof include a pulverizer including a pulverizer (pulverizing mixer) and a thermal tank (reaction vessel), between which the slurry is circulated.

The size of the beads and the balls used in the ball mill and the bead mill may be appropriately selected depending on the desired particle diameter, the processing amount, and the like. For example, the diameter of the beads is generally 0.05 mm or more, preferably 0.1 mm or more, and more preferably 0.3 mm or more, and the upper limit thereof is generally 5.0 mm or less, preferably 3.0 mm or less, and more preferably 2.0 mm or less. The diameter of the balls is generally 2.0 mm or more, preferably 2.5 mm or more, and more preferably 3.0 mm or more, and the upper limit thereof is generally 20.0 mm or less, preferably 15.0 mm or less, and more preferably 10.0 mm or less.

Examples of the material thereof include a metal, such as a stainless steel, a chrome steel, and tungsten carbide; ceramics, such as zirconia and silicon nitride; and a mineral, such as agate.

In the case where a ball mill or a bead mill, the rotation number thereof may vary depending on the processing scale, and cannot be determined unconditionally, and the rotation number thereof is generally 10 rpm or more, preferably 20 rpm or more, and more preferably 50 rpm or more, and the upper limit thereof is generally 1,000 rpm or less, preferably 900 rpm or less, more preferably 800 rpm or less, and further preferably 700 rpm or less.

The pulverization time in this case may vary depending on the processing scale, and cannot be determined unconditionally, and the pulverization time is generally 0.5 hour or more, preferably 1 hour or more, more preferably 5 hours or more, and further preferably 10 hours or more, and the upper limit thereof is generally 100 hours or less, preferably 72 hours or less, more preferably 48 hours or less, and further preferably 36 hours or less.

The operation of mixing, agitation, pulverization, or a combination thereof can be performed, and the particle diameter and the like of the resulting sulfide can be regulated, by selecting the size and the material of the medium used (such as beads and balls), the rotation number of the rotor, the pulverization time, and the like.

### (Solvent)

In the mixing, the raw materials may be mixed with a solvent added thereto. The solvent used may be various solvents and the like widely referred to as an organic solvent.

The solvent used may be a solvent that has been used in the production of solid electrolytes, and examples thereof include a hydrocarbon solvent, such as an aliphatic hydrocarbon solvent, an alicyclic hydrocarbon solvent, and an aromatic hydrocarbon solvent.

Examples of the aliphatic hydrocarbon include hexane, pentane, 2-ethylhexane, heptane, octane, decane, undecane, dodecane, and tridecane, examples of the alicyclic hydrocarbon include cyclohexane and methylcyclohexane, and examples of the aromatic hydrocarbon solvent include benzene, toluene, xylene, mesitylene, ethylbenzene, tert-butylbenzene, trifluoromethylbenzene, and nitrobenzene.

In addition to the hydrocarbon solvents described above, examples of the solvent also include a solvent containing an atom other than a carbon atom and a hydrogen atom, e.g., a hetero atom, such as a nitrogen atom, an oxygen atom, a sulfur atom, and a halogen atom. The solvent of this type has a capability of easily forming a complex with the compounds containing a lithium atom, a phosphorus atom, a sulfur atom, and a halogen atom used as the raw material (hereinafter the solvent of this type may be referred to as a “complexing agent”), and a capability of retaining a halogen atom inside the structure of the sulfide solid electrolyte, and therefore is useful for providing the higher ionic conductivity. Preferred examples of the complexing agent include an ether solvent and an ester solvent, and also include an alcohol solvent, an aldehyde solvent, and a ketone solvent, which contain an oxygen atom as a hetero atom.

Preferred examples of the ether solvent include an aliphatic ether, such as dimethyl ether, diethyl ether, tert-butyl methyl ether, dimethoxymethane, dimethoxyethane, diethylene glycol dimethyl ether (diglyme), triethylene glycol dimethyl ether (triglyme), diethylene glycol, and triethylene glycol; an alicyclic ether, such as ethylene oxide, propylene oxide, tetrahydrofuran, tetrahydropyran, dimethoxytetrahydrofuran, cyclopentyl methyl ether, and dioxane; a heterocyclic ether, such as furan, benzofuran, and benzopyran; and an aromatic ether, such as methyl phenyl ether (anisole), ethyl phenyl ether, dibenzyl ether, and diphenyl ether.

Preferred examples of the ester solvent include an aliphatic ester, such as methyl formate, ethyl formate, methyl acetate, ethyl acetate, propyl acetate, isopropyl acetate, methyl propanoate, ethyl propanoate, dimethyl oxalate, diethyl oxalate, dimethyl malonate, diethyl malonate, dimethyl succinate, and diethyl succinate; an alicyclic ester, such as methyl cyclohexanecarboxylate, ethyl cyclohexanecarboxylate, and dimethyl cyclohexanedicarboxylate; a heterocyclic ester, such as methyl pyridinecarboxylate, methyl pyrimidinecarboxylate, acetolactone, propiolactone, butyrolactone, and valerolactone; and an aromatic ester, such as methyl benzoate, ethyl benzoate, dimethyl phthalate, diethyl phthalate, butyl benzyl phthalate, dicyclohexyl phthalate, trimethyl trimellitate, and triethyl trimellitate.

Preferred examples thereof also include an alcohol solvent, such as ethanol and butanol; an aldehyde solvent, such as formaldehyde, acetaldehyde, and dimethylformamide; and a ketone solvent, such as acetone and methyl ethyl ketone.

Examples of the solvent containing a nitrogen atom as a hetero atom include a solvent having a group containing a nitrogen atom, such as an amino group, an amide group, a nitro group, and a nitrile group.

Preferred examples of the solvent having an amino group include an aliphatic amine, such as ethylenediamine, diaminopropane, dimethylethylenediamine, diethylethylenediamine, dimethyldiaminopropane, tetramethyldiaminomethane, tetramethylethylenediamine (TMEDA), tetramethyldiaminopropane (TMPDA); an alicyclic amine, such as cyclopropanediamine, cyclohexanediamine, and bisaminomethylcyclohexane; a heterocyclic amine, such as isophorone diamine, piperazine, dipiperidylpropane, and dimethylpiperazine; and an aromatic amine, such as phenylenediamine, tolylenediamine, naphthalenediamine, methylphenylenediamine, dimethylnaphthalenediamine, dimethylphenylenediamine, tetramethylphenylenediamine, and tetramethylnaphthalenediamine.

Preferred examples thereof also include a nitrile solvent, such as acetonitrile and acrylonitrile; and a solvent containing a nitrogen atom, such as dimethylformamide, nitrobenzene, and dimethylacetamide.

Preferred examples of the solvent containing a halogen atom as a hetero atom include chloroform, carbon tetrachloride, dichloromethane, chlorobenzene, dichlorobenzene, trifluoromethylbenzene, chlorotoluene, and bromobenzene.

Preferred examples of the solvent containing a sulfur atom include dimethylsulfoxide and carbon disulfide.

In the case where the solvent is used, the amount of the solvent used is preferably 100 mL or more, more preferably 200 mL or more, further preferably 250 mL or more, and still further preferably 300 mL or more, and the upper limit thereof is preferably 3,000 mL or less, more preferably 2,500 mL or less, further preferably 2,000 mL or less, and still further preferably 1,550 mL or less, per 1 kg in total of the amounts of the raw materials. In the case where the amount of the solvent used is in the range, the raw materials can be reacted efficiently.

### (Drying)

In the case where the mixing is performed with a solvent, the fluid (which is generally a slurry) obtained by mixing may be dried after mixing. A sulfide solid electrolyte can be obtained by removing the complexing agent from the complex containing the complexing agent in the case where the complexing agent is used as a solvent, by removing the complexing agent and removing the solvent from the complex containing the complexing agent in the case where the complexing agent and the solvent are used in combination, or by removing the solvent in the case where the solvent other than the complexing agent is used. The resulting sulfide solid electrolyte exhibits an ionic conductivity derived from a lithium atom.

The drying of the fluid obtained by mixing may be performed at a temperature corresponding to the kind of the solvent, for example, a temperature of the boiling point of the complexing agent or more.

The drying can be performed by evaporating the complexing agent and the solvent used depending on necessity through reduced pressure drying (vacuum drying) with a vacuum pump or the like at generally 5 to 100° C., preferably 10 to 85° C., more preferably 15 to 70° C., and further preferably around room temperature (23° C.) (for example, room temperature ±5° C.).

The drying of the fluid may also be performed through filtration with a glass filter or the like, solid-liquid separation by decantation, or solid-liquid separation with a centrifugal separator. In the case where the solvent other than the complexing agent is used, the sulfide solid electrolyte can be obtained through solid-liquid separation. In the case where the complexing agent is used as the solvent, it suffices that solid-liquid separation is performed, and then the drying is performed under the temperature condition above for removing the complexing agent entrained in the complex.

Specifically, the solid-liquid separation can be easily performed by decantation in which the fluid is transferred to a vessel, and after settling the sulfide (or the complex (which may also be referred to as a precursor of the sulfide solid electrolyte) in the case containing the complexing agent), the complexing agent and the solvent as a supernatant are removed, by filtering using a glass filter having a pore size, for example, of approximately 10 to 200 μm, and preferably 20 to 150 μm.

The drying after mixing may be performed before the hydrogen treatment described later, or may be performed after performing the hydrogen treatment.

The sulfide solid electrolyte obtained through the mixing described above, or in the case where the solvent is used, the sulfide solid electrolyte obtained by removing the solvent through the drying described above exhibits an ionic conductivity derived from a lithium atom. The sulfide solid electrolyte obtained through the mixing described above is basically an amorphous sulfide solid electrolyte (glass component) unless performing the mixing, for example, through pulverization with a pulverizer to an extent that causes crystallization.

The sulfide solid electrolyte obtained through the mixing above may be an amorphous sulfide solid electrolyte (glass component) or may be a crystalline sulfide solid electrolyte, which may be appropriately selected depending on desire. In the case where a crystalline sulfide solid electrolyte is to be produced, a crystalline sulfide solid electrolyte can be formed by heating the amorphous sulfide solid electrolyte obtained by mixing as described above.

The sulfide solid electrolyte may contain a crystalline sulfide solid electrolyte having formed on the surface thereof an amorphous component (glass component), which is obtained as a result, for example, of the treatment described later, such as pulverization, performed for regulating the particle diameter of powder of the crystalline sulfide solid electrolyte. Therefore, the sulfide solid electrolyte containing an amorphous component encompasses an amorphous sulfide solid electrolyte, and a sulfide solid electrolyte containing a crystalline sulfide solid electrolyte having formed on the surface thereof an amorphous component.

### (Heating)

The production of the crystalline sulfide solid electrolyte may further include heating. In the case where an amorphous sulfide solid electrolyte (glass component) is obtained by mixing as described above, the crystalline sulfide solid electrolyte can be obtained by heating, and in the case where a crystalline sulfide solid electrolyte is obtained thereby, a crystalline sulfide solid electrolyte having an increased crystallinity can be obtained by heating.

In the case where a complexing agent is used as the solvent in mixing, a complex containing the complexing agent is formed, and a sulfide solid electrolyte can be obtained by removing the complexing agent by heating without the drying described above, in which either the amorphous sulfide solid electrolyte or the crystalline sulfide solid electrolyte can be obtained depending on the heating condition.

As for the heating temperature, for example, in the case where an amorphous sulfide solid electrolyte is obtained, the heating temperature may be determined depending on the structure of the crystalline sulfide solid electrolyte obtained by heating the amorphous sulfide solid electrolyte, and specifically, can be determined in such a manner that the amorphous sulfide solid electrolyte is subjected to differential thermal analysis (DTA) under a temperature rise condition of 10° C./min with a differential thermal analyzer (DTA device), in which based on the peak top temperature of the exothermic peak observed on the lowest temperature side, the heating temperature is preferably in a range of a temperature lower by 5° C. or less, more preferably a temperature lower by 10° C. or less, and further preferably a temperature lower by 20° C. or less, and the lower limit thereof is not particularly limited, and may be approximately a temperature lower by −40° C. than the peak top temperature of the exothermic peak observed on the lowest temperature side or more. Within the temperature range, the amorphous sulfide solid electrolyte can be obtained more efficiently and securely. The heating temperature for providing the amorphous sulfide solid electrolyte may vary depending on the structure of the crystalline sulfide solid electrolyte to be obtained, and cannot be determined unconditionally, and in general, the heating temperature is preferably 135° C. or less, more preferably 130° C. or less, and further preferably 125° C. or less, and the lower limit thereof is not particularly limited and is preferably 90° C. or more, more preferably 100° C. or more, and further preferably 105° C. or more.

In the case where a crystalline sulfide solid electrolyte is obtained by heating an amorphous sulfide solid electrolyte, the heating temperature may be determined depending on the structure of the crystalline sulfide solid electrolyte, and is preferably a temperature higher than the heating temperature for providing the amorphous sulfide solid electrolyte described above, and specifically, the heating temperature can be determined in such a manner that the amorphous sulfide solid electrolyte is subjected to differential thermal analysis (DTA) under a temperature rise condition of 10° C./min with a differential thermal analyzer (DTA device), in which based on the peak top temperature of the exothermic peak observed on the lowest temperature side, the heating temperature is preferably in a range of a temperature higher by 5° C. or more, more preferably a temperature higher by 10° C. or more, and further preferably a temperature higher by 20° C. or more, and the upper limit thereof is not particularly limited, and may be approximately a temperature higher by 40° C. than the peak top temperature of the exothermic peak observed on the lowest temperature side or less. Within the temperature range, the crystalline sulfide solid electrolyte can be obtained more efficiently and securely. The heating temperature for providing the crystalline sulfide solid electrolyte may vary depending on the composition and the structure of the crystalline sulfide solid electrolyte to be obtained, and cannot be determined unconditionally, and in general, the heating temperature is preferably 130° C. or more, more preferably 135° C. or more, and further preferably 140° C. or more, and the upper limit thereof is not particularly limited and is preferably 600° C. or less, more preferably 550° C. or less, and further preferably 500° C. or less.

The heating time is not particularly limited, as long as being the time capable of providing the amorphous sulfide solid electrolyte or the crystalline sulfide solid electrolyte to be obtained, and for example, is preferably 1 minute or more, more preferably 10 minutes or more, further preferably 30 minutes or more, and still further preferably 1 hour or more. The upper limit of the heating time is not particularly limited, and is preferably 24 hours or less, more preferably 10 hours or less, further preferably 5 hours or less, and still further preferably 3 hours or less.

The heating is preferably performed in an inert gas atmosphere (such as a nitrogen atmosphere and an argon atmosphere or a reduced pressure atmosphere (particularly in vacuum), which may also be an inert gas atmosphere containing a certain concentration of hydrogen. The crystalline sulfide solid electrolyte thereby can be prevented from being deteriorated (for example, oxidized).

The heating method is not particularly limited, and examples thereof include a method using a hot plate, a vacuum heating device, an argon gas atmosphere furnace, or a baking furnace. In the industrial production, a horizontal dryer, a horizontal vibration fluid dryer, or the like having a heating unit and a conveying mechanism may also be used, which can be selected depending on the processing amount to be heated.

### (Sulfide Solid Electrolyte)

The sulfide solid electrolyte used in the present embodiment may be a commercially available product or a produced product as described above.

The sulfide solid electrolyte obtained by the method described above is an amorphous (glass component) or crystalline sulfide solid electrolyte containing a lithium atom, a sulfur atom, a phosphorus atom, and a halogen atom, and can be preferably used as the sulfide solid electrolyte in the present embodiment.

### (BET Specific Surface Area)

The sulfide solid electrolyte used in the present embodiment has a BET specific surface area of 10 m²/g or more. The modified sulfide solid electrolyte of the present embodiment has an effect of exhibiting the excellent coating suitability in coating as a paste and exhibiting the excellent battery capabilities efficiently irrespective of such a large specific surface area, and the higher the BET specific surface area is, the more advantageous the effect can be. From this standpoint, the BET specific surface area is preferably 12 m²/g or more, more preferably 15 m²/g or more, and further preferably 20 m²/g or more. From the same standpoint, the upper limit thereof is not particularly limited, and is practically 100 m²/g or less, preferably 75 m²/g or less, and more preferably 50 m²/g or less.

In the description herein, the BET specific surface area is a specific surface area that is measured according to JIS Z8830: 2013 (Determination of the specific surface area of powders (solids) by gas adsorption) using krypton as an adsorbate.

### (Amorphous Sulfide Solid Electrolyte)

The amorphous sulfide solid electrolyte obtained by the method described above contains a lithium atom, a sulfur atom, a phosphorus atom, and a halogen atom, and representative preferred examples thereof include a solid electrolyte constituted by lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr; and a solid electrolyte further containing other atoms, such as an oxygen atom and a silicon atom, such as Li₂S—P₂S₅—Li₂O—LiI and Li₂S—SiS₂—P₂S₅—LiI. Preferred examples thereof include a solid electrolyte constituted by lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr, from the standpoint of providing the higher ionic conductivity.

The kinds of atoms constituting the amorphous sulfide solid electrolyte can be confirmed, for example, with an inductively coupled plasma (ICP) light emission spectroscope.

The shape of the amorphous sulfide solid electrolyte is not particularly limited, and examples thereof include a particle shape. Examples of the average particle diameter (D₅₀) of the amorphous sulfide solid electrolyte having a particle shape include a range of 0.01 μm to 500 μm, or 0.1 to 200 μm.

### (Crystalline Sulfide Solid Electrolyte)

The crystalline sulfide solid electrolyte obtained by the method described above may be so-called glass ceramics obtained by heating the amorphous sulfide solid electrolyte to the crystallization temperature or more, and examples of the crystal structure thereof include an Li₃PS₄ crystal structure, an Li₄P₂S₆ crystal structure, an Li₇—PS₆ crystal structure, an Li₇—P₃S₁₁ crystal structure, and a crystal structure having peaks around 2θ=20.2° and 23.6° (see, for example, JP 2013-16423 A).

Examples thereof also include an Li₄₋ₓGe₁₋ₓPₓS₄ based thio-LISICON Region II type crystal structure (see Kanno, et al., Journal of The Electrochemical Society, 148 (7) A742-746 (2001)) and a crystal structure similar to the Li₄₋ₓGe₁₋ₓPₓS₄ based thio-LISICON Region II type crystal structure (see Solid State Ionics, 177 (2006), 2721-2725). The crystal structure of the crystalline sulfide solid electrolyte obtained by the production method of the present embodiment is preferably the thio-LISICON Region II type crystal structure among the above from the standpoint of providing the higher ionic conductivity. The “thio-LISICON Region II type crystal structure” herein means any of the Li₄₋ₓGe₁₋ₓPₓS₄ based thio-LISICON Region II type crystal structure and the crystal structure similar to the Li₄₋ₓGe₁₋ₓPₓS₄ based thio-LISICON Region II type crystal structure. The crystal structure of the crystalline sulfide solid electrolyte obtained by the production method of the present embodiment may have the thio-LISICON Region II type crystal structure, or may have the crystal structure as a main crystal phase, and preferably has the crystal structure as a main crystal phase from the standpoint of providing the higher ionic conductivity. In the description herein, the expression “having as a main crystal phase” means that the proportion of the target crystal structure in the entire crystal structure is 80% or more, preferably 90% or more, and more preferably 95% or more. The crystalline sulfide solid electrolyte obtained by the production method of the present embodiment preferably does not contain crystalline Li₃PS₄ (β-Li₃PS₄) from the standpoint of providing the higher ionic conductivity.

In the X-ray diffractometry using CuKα line, the diffraction peaks of the Li₃PS₄ crystal structure appear, for example, around 2θ=17.5°, 18.3°, 26.1°, 27.3°, and 30.0°, the diffraction peaks of the Li₄P₂S₆ crystal structure appear, for example, around 2θ=16.9°, 27.1°, and 32.5°, the diffraction peaks of the Li₂PS₆ crystal structure appear, for example, around 2θ=15.3°, 25.2°, 29.6°, and 31.0°, the diffraction peaks of the Li₂P₃S₁₁ crystal structure appear, for example, around 2θ=17.8°, 18.5°, 19.7°, 21.8°, 23.7°, 25.9°, 29.6°, and 30.0°, the diffraction peaks of the Li₄₋ₓGe₁₋ₓPₓS₄ based thio-LISICON Region II type crystal structure appear, for example, around 2θ=20.1°, 23.9°, and 29.5°, and the diffraction peaks of the crystal structure similar to the Li₄₋ₓGe₁₋ₓPₓS₄ based thio-LISICON Region II type crystal structure appear, for example, around 2θ=20.2 and 23.6°. These peak positions may vary within a range of ±0.5°.

In the case where the thio-LISICON Region II type crystal structure is obtained in the present embodiment, it is preferred that crystalline Li₃PS₄ (β-Li₃PS₄) is not contained as described above. The sulfide solid electrolyte obtained by the production method of the present embodiment does not have diffraction peaks at 2θ=17.5° and 26.1° appearing for crystalline Li₃PS₄, or even though the sulfide solid electrolyte has the diffraction peaks, the peaks are extremely smaller than the diffraction peaks of the thio-LISICON Region II type crystal structure.

The crystal structure having the Li₇PS₆ structural skeleton in which a part of P is replaced by Si represented by the compositional formulae Li₇₋ₓP_{1-y}Si_{y}S₆ and Li₇₋ₓP_{1-y}Si_{y}S₆ (in which x represents-0.6 to 0.6, and y represents 0.1 to 0.6) is a cubic crystal or an orthorhombic crystal, and preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. The crystal structure represented by the compositional formula Li₇₋ₓ₋₂ₓPS_{6-x-y}Clₓ (in which 0.8≤x≤ 1.7, and 0<y≤−0.25×+0.5) is preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. The crystal structure represented by the compositional formula Li₇₋ₓPS₆₋ₓHaₓ (in which Ha represents Cl or Br, and x preferably represents 0.2 to 1.8) is preferably a cubic crystal, and in the X-ray diffractometry using CuKα line, has peaks appearing mainly at 2θ=15.5°, 18.0°, 25.0°, 30.0°, 31.4°, 45.3°, 47.0°, and 52.0°. These crystal structures basically having the Li₂PS₆ structural skeleton are also referred to as an argyrodite type crystal structure.

These peak positions may vary within a range of +0.5°.

The shape of the crystalline sulfide solid electrolyte is not particularly limited, and examples thereof include a particle shape. Examples of the average particle diameter (D₅₀) of the crystalline sulfide solid electrolyte having a particle shape include a range of 0.01 μm to 500 μm, or 0.1 to 200 μm.

### (Properties of Modified Sulfide Solid Electrolyte)

The modified sulfide solid electrolyte of the present embodiment has a BET specific surface area of 10 m²/g or more, i.e., has a large specific surface area. The BET specific surface area is preferably 12 m²/g or more, more preferably 15 m²/g or more, and further preferably 20 m²/g or more, from the standpoint of the fact that the higher the BET specific surface area is, the more advantageous the effect can be. From the same standpoint, the upper limit thereof is not particularly limited, and is practically 100 m²/g or less, preferably 75 m²/g or less, and more preferably 50 m²/g or less.

The attachment of a lithium halide to the sulfide solid electrolyte does not largely influence the BET specific surface area thereof, and the BET specific surface area of the sulfide solid electrolyte used in the present embodiment and the BET specific surface area of the modified sulfide solid electrolyte are substantially the same as each other. Therefore, the use of the sulfide solid electrolyte having a BET specific surface area of 10 m²/g or more can naturally provide the modified sulfide solid electrolyte having a BET specific surface area of 10 m²/g or more.

The oil absorption of the modified sulfide solid electrolyte of the present embodiment is reduced due to the effect of the compounds (A) to (I) attached to the surface thereof generally to 1.10 mL/g or less, and furthermore to 1.00 mL/g or less, 0.95 mL/g or less, 0.90 mL/g or less, 0.85 mL/g or less, 0.80 mL/g or less, or 0.75 mL/g or less, irrespective of the large BET specific surface area thereof described above. The modified sulfide solid electrolyte of the present embodiment has a small oil absorption irrespective of the large BET specific surface area thereof, and thereby the paste thereof can be suppressed in increase of the viscosity of the paste, the excellent coating suitability can be obtained in coating, and the excellent battery capabilities can be easily obtained since a solvent or the like is not necessarily used for preventing the increase of the viscosity of the paste.

In the description herein, the oil absorption is measured in such a manner that one drop of butyl butyrate is added to 1 g of the modified sulfide solid electrolyte as a specimen in a mortar or the like, and agitated with a spatula, and the operation is repeated until the specimen becomes a paste form, at which the total amount of butyl butyrate is designated as an oil absorption (mL/g). The “paste form” herein means such a state that “the specimen can be spread without cracking or crumbling, and can be lightly attached to the measuring plate” defined in JIS K5101-13-1:2004 (Test methods for pigments, Part 13: Oil absorption, Section 1: Refined linseed oil method), Section 7.2 Measurement.

The index of the oil absorption calculated by the following expression is preferably as small as possible, and is generally 90% or less, and furthermore 85% or less, 80% or less, 75% or less, or 70% or less, and the lower limit thereof is not particularly limited, and is generally 50% or more.

$$Index of oil absorption ( \% ) = ( oil absorption B / oil absorption A ) \times 100$$

Oil absorption A: Oil absorption of sulfide solid electrolyte before modification (mL/g)
Oil absorption B: Oil absorption of modified sulfide solid electrolyte (mL/g)

The ionic conductivity of the modified sulfide solid electrolyte of the present embodiment is generally 0.5 mS/cm or more, and furthermore 1.0 mS/cm or more, 1.5 mS/cm or more, 1.6 mS/cm or more, or 1.7 mS/cm or more, i.e., an extremely high ionic conductivity, resulting in a lithium battery having the excellent battery capabilities.

The oxidation current of the modified sulfide solid electrolyte of the present embodiment is lower than the oxidation current of the sulfide solid electrolyte used, and thus the excellent oxidation resistance.

The reduction rate of the oxidation current of the modified sulfide solid electrolyte of the present embodiment is generally 15% or more, and furthermore 20% or more, 25% or more, 30% or more, or 35% or more. The reduction rate of the oxidation current is calculated by the following expression.

$$Reduction rate of oxidation current ( \% ) = ( ( oxidation current A - oxidation current B ) / oxidation current A ) \times 100$$

Oxidation current A: Oxidation current of sulfide solid electrolyte before modification (mA)
Oxidation current B: Oxidation current of modified sulfide solid electrolyte (mA)

The index of the oxidation current calculated by the following expression is preferably as small as possible, and is generally 85% or less, and furthermore 80% or less, 75% or less, 70% or less, or 65% or less, and the lower limit thereof is not particularly limited, and is generally 50% or more.

Index of oxidation current (%)=(oxidation current B/oxidation current A)×100
Oxidation current 1: Oxidation current of modified sulfide solid electrolyte (mA)
Oxidation current 2: Oxidation current of sulfide solid electrolyte before modification (mA)

The absolute value of the oxidation current of the crystalline sulfide solid electrolyte obtained by the production method of the present embodiment may vary depending on the measurement condition and the like, and cannot be determined unconditionally, and in the case where the oxidation current is measured by the measurement method in the examples described later, the oxidation current is generally as small as 0.55 mA or less, and furthermore 0.45 mA or less, 0.43 mA or less, 0.41 mA or less, or 0.40 mA or less, and the lower limit thereof may be approximately 0.20 mA.

### (Applications)

The modified sulfide solid electrolyte of the present embodiment is excellent in coating suitability, and can be applied to the production of batteries without the use of a solvent or the like, and therefore the excellent battery capabilities can be exhibited efficiently. Furthermore, the modified sulfide solid electrolyte has a high ionic conductivity and the excellent battery capabilities, and therefore can be favorably applied to batteries.

The modified sulfide solid electrolyte of the present embodiment can be used in a positive electrode layer, can be used in a negative electrode layer, and may be used in an electrolyte layer. These layers can be produced according to the known method.

The battery preferably includes a collector, in addition to the positive electrode layer, the electrolyte layer, and the negative electrode layer, and the known collector may be used. Examples thereof used include a layer including a material that reacts with the solid electrolyte, such as Au, Pt, Al, Ti, or Cu, covered with Au or the like.

### [Method of Producing Modified Sulfide Solid Electrolyte]

The method of producing a modified sulfide solid electrolyte of the present embodiment is a production method including
mixing a sulfide solid electrolyte having a BET specific surface area of 10 m²/g or more and containing a lithium atom, a sulfur atom, a phosphorus atom, and a halogen atom, an organic solvent, and at least two kinds of compounds selected from the following compounds (A) to (I), and
removing the organic solvent.

The production method of the present embodiment can efficiently produce the modified sulfide solid electrolyte of the present embodiment. In other words, the modified sulfide solid electrolyte of the present embodiment is preferably produced by the production method of the present embodiment.
Compound (A): a compound having one heterocyclic ring having a carbon atom and an oxygen atom
Compound (B): a compound having two or more heterocyclic rings having a carbon atom and an oxygen atom
Compound (C): an organic halide 1 (excluding the following compound (F))
Compound (D): a compound having a formyl group (CH(═O)—)
Compound (E): a compound having two or more acetyl groups (CH₃C(═O)—)
Compound (F): an organic halide 2 having two or more halogen-containing groups represented by —CH₂X^{1F} (in which X^{1F} represents a fluorine atom or a bromine atom) and an organic group
Compound (G): a thiol compound
Compound (H): a metal-free phosphorus compound (provided that the compound does not contain an oxygen atom that is bonded to a phosphorus atom via a single bond)
Compound (I): a metal-free boron compound

In the compound having two or more halogen-containing groups represented by —CH₂X^{1F} (in which X^{1F} represents a fluorine atom or a bromine atom) and an organic group as the compound (F), the halogen atom represented by X^{1F} is preferably a fluorine atom or a bromine atom.

The sulfide solid electrolyte having a BET specific surface area of 10 m²/g or more and containing a lithium atom, a sulfur atom, a phosphorus atom, and a halogen atom used in the production method of the present embodiment may be the same sulfide solid electrolyte as described for that can be used in the modified sulfide solid electrolyte of the present embodiment described above. Therefore, the sulfide solid electrolyte may be a commercially available product or a produced product.

Examples of the organic solvent used in the production method of the present embodiment include the solvents described for those that can be used in the method of producing the sulfide solid electrolyte described above. Among the solvents, preferred examples thereof include an aliphatic hydrocarbon solvent, an alicyclic hydrocarbon solvent, an aromatic hydrocarbon solvent, and an ether solvent, an ester solvent, and a nitrile solvent, which are exemplified as the complexing agent, in which an aromatic hydrocarbon solvent is more preferred, from the standpoint of promoting the mixing of the sulfide solid electrolyte and the heteropolycyclic compound, and providing the modified sulfide solid electrolyte containing the sulfide solid electrolyte and the heteropolycyclic compound efficiently, and the standpoint of promoting the attachment of the heteropolycyclic compound to the sulfide solid electrolyte.

In the production method of the present embodiment, one of the organic solvents may be used alone, or multiple kinds thereof may be used in combination.

In the production method of the present embodiment, the method of mixing the sulfide solid electrolyte, the heteropolycyclic compound, and the organic solvent can be performed in the same method as in the “mixing” in the method of producing the sulfide solid electrolyte described above.

The removal of the organic solvent can be performed in the same method as in the “drying” in the method of producing the sulfide solid electrolyte described above.

In the production method of the present embodiment, the “heating” in the method of producing the sulfide solid electrolyte described above can be performed.

### [Electrode Mixture]

The electrode mixture of the present embodiment is an electrode mixture containing the modified sulfide solid electrolyte according to the present embodiment, and an electrode active substance, and is an electrode mixture containing the modified sulfide solid electrolyte according to another embodiment, and an electrode active substance.

### (Electrode Active Substance)

The electrode active substance used is either a positive electrode active substance or a negative electrode active substance depending on whether the electrode mixture is used in a positive electrode or a negative electrode, respectively.

The positive electrode active substance used is not particularly limited, as long as being a material that is capable of promoting the cell chemical reaction associated with lithium ion migration caused by an atom that can be used as an atom exhibiting ionic conductivity in relation to the negative electrode active substance, preferably a lithium atom. Examples of the positive electrode active substance capable of performing intercalation and deintercalation of a lithium ion include an oxide based positive electrode active substance and a sulfide based positive electrode active substance.

Preferred examples of the oxide based positive electrode active substance include a lithium-containing transition metal complex oxide, such as LMO (lithium manganese oxide), LCO (lithium cobalt oxide), NMC (lithium nickel cobalt manganese oxide), NCA (lithium nickel cobalt aluminum oxide), LNCO (lithium nickel cobalt oxide), and an olivine type compound (LiMeNPO₄, in which Me=Fe, Co, Ni, or Mn).

Examples of the sulfide based positive electrode active substance include titanium sulfide (TiS₂), molybdenum sulfide (MoS₂), iron sulfide (FeS, FeS₂), copper sulfide (CuS), and nickel sulfide (Ni₃S₂).

In addition to the positive electrode active substances described above, niobium selenide (NbSe₃) and the like can also be used.

One kind of the positive electrode active substance may be used alone, or multiple kinds thereof may be used in combination.

The negative electrode active substance used is not particularly limited, as long as being a material that is capable of promoting the cell chemical reaction associated with lithium ion migration caused preferably by a lithium atom, such as a metal that is capable of forming an alloy with an atom that can be used as an atom exhibiting ionic conductivity in relation to the negative electrode active substance, preferably a lithium atom, an oxide thereof, and an alloy of the metal and a lithium atom. The negative electrode active substance capable of performing intercalation and deintercalation of a lithium ion used may be any negative electrode active substance known in the field of batteries with no particular limitation.

Examples of the negative electrode active substance include metallic lithium or a metal capable of forming an alloy with metallic lithium, such as metallic lithium, metallic indium, metallic aluminum, metallic silicon, and metallic tin, an oxide of the metal, and an alloy of the metal and metallic lithium.

The electrode active substance used in the present embodiment may have a surface coated with a coating layer.

Preferred examples of the material for forming the coating layer include an ionic conductor, such as a nitride, an oxide, or a composite thereof, of an atom exhibiting ionic conductivity in the sulfide solid electrolyte, preferably a lithium atom. Specific examples thereof include a conductor having lithium nitride (Li₃N) or Li₄GeO₄ as the major structure, for example, a silicon type crystal structure, such as Li₄₋₂ₓZnₓGeO₄, a conductor having an Li₃PO₄ type skeleton structure, for example, a thiosilicon type crystal structure, such as Li₄₋ₓGe₁₋ₓPₓS₄, a conductor having a perovskite type crystal structure, such as La_{2/3-x}Li₃₋ₓTiO₃, and a conductor having a NASICON type crystal structure, such as LiTi₂(PO₄)₃.

Examples thereof also include lithium titanate, such as Li_{y}Ti_{3-y}O₄ (0<y<3) and Li₄T₁₅O₁₂ (LTO), a sodium metalate of a metal belonging to Group 5 of Periodic Table, such as LiNbO₃ and LiTaO₃, and an oxide based conductor, such as an Li₂O—B₂O₃—P₂O₅ based conductor, an Li₂O—B₂O₃—ZnO based conductor, and an Li₂O—Al₂O₃—SiO₂—P₂O₅—TiO₂ based conductor.

The electrode active substance having a coating layer can be obtained, for example, in such a manner that a solution containing atoms constituting the material for forming the coating layer is attached to the surface of the electrode active substance, and the electrode active substance having the solution attached thereto is then baked preferably at 200° C. or more and 400° C. or less.

The solution containing atoms used herein may be a solution containing an alkoxide of metals, such as lithium ethoxide, titanium isopropoxide, niobium isopropoxide, and tantalum isopropoxide. In this case, the solvent used may be an alcohol based solvent, such as ethanol and butanol; an aliphatic hydrocarbon solvent, such as hexane, heptane, and octane; an aromatic hydrocarbon solvent, such as benzene, toluene, and xylene; and the like.

The solution can be attached through immersion, spray coating, or the like.

The baking temperature is preferably 200° C. or more and 400° C. or less as described above, and more preferably 250° C. or more and 390° C. or less, from the standpoint of enhancing the production efficiency and the battery capabilities, and the baking time is generally approximately 1 minute to 10 hours, and preferably 10 minutes to 4 hours.

The coverage of the coating layer is preferably 90% or more, more preferably 95% or more, and further preferably 100%, based on the surface area of the electrode active substance, i.e., the entire surface thereof is coated. The thickness of the coating layer is preferably 1 nm or more, and more preferably 2 nm or more, and the upper limit thereof is preferably 30 nm or less, and more preferably 25 nm or less.

The thickness of the coating layer can be measured through cross sectional observation with a transmission electron microscope (TEM), and the coverage can be calculated from the thickness of the coating layer, the elemental analysis values, and the BET specific surface area.

### (Additional Components)

The electrode mixture of the present embodiment may contain an additional component, such as a conducting material and a binder, in addition to the modified sulfide solid electrolyte and the electrode active substance described above. Accordingly, in the electrode mixture of the present embodiment, an additional component, such as a conducting material and a binder, may be used in addition to the modified sulfide solid electrolyte and the electrode active substance described above. The additional component, such as a conducting material and a binder, may be used by adding to and mixing with the modified sulfide solid electrolyte and the electrode active substance, in mixing the modified sulfide solid electrolyte and the electrode active substance.

Examples of the conducting material include a carbonaceous material, such as artificial graphite, graphite carbon fibers, resin fired carbon, thermal decomposition vapor phase grown carbon, coke, mesocarbon microbeads, furfuryl alcohol resin fired carbon, polyacene, pitch based carbon fibers, vapor phase grown carbon fibers, natural graphite, and non-graphitizable carbon, from the standpoint of enhancing the battery capabilities by enhancing the electron conductivity.

The use of the binder enhances the strength in the case where a positive electrode or a negative electrode is produced.

The binder is not particularly limited, as long as being capable of imparting the capabilities, such as bindability and flexibility, and examples thereof include a fluorine based polymer, such as polytetrafluoroethylene and polyvinylidene fluoride, a thermoplastic elastomer, such as butylene rubber and styrene-butadiene rubber, and a resin, such as an acrylic resin, an acrylic polyol resin, a polyvinylacetal resin, a polyvinylbutyral resin, and a silicone resin.

The mixing ratio (mass ratio) of the electrode active substance and the modified sulfide solid electrolyte in the electrode mixture is preferably 99.5/0.5 to 40/60, more preferably 99/1 to 50/50, and further preferably 98/2 to 60/40, in consideration of the enhancement of the battery capabilities and the production efficiency.

In the case where the conductive material is contained, the content of the conductive material in the electrode mixture is not particularly limited, and is preferably 0.5% by mass or more, more preferably 1% by mass or more, and further preferably 1.5% by mass or more, and the upper limit thereof is preferably 10% by mass or less, more preferably 8% by mass or less, and further preferably 5% by mass or less, in consideration of the enhancement of the battery capabilities and the production efficiency.

In the case where the binder is contained, the content of the binder in the electrode mixture is not particularly limited, and is preferably 1% by mass or more, more preferably 3% by mass or more, and further preferably 5% by mass or more, and the upper limit thereof is preferably 20% by mass or less, more preferably 15% by mass or less, and further preferably 10% by mass or less, in consideration of the enhancement of the battery capabilities and the production efficiency.

### [Lithium Ion Battery]

The lithium ion battery of the present embodiment is a lithium ion battery including at least one of the modified sulfide solid electrolyte and the electrode mixture according to the present embodiment, or including at least one of the modified sulfide solid electrolyte and the electrode mixture according to another embodiment.

The lithium ion battery of the present embodiment is not particularly limited in configuration thereof, and may have a configuration of an ordinary lithium ion battery, as long as including the modified sulfide solid electrolyte of the present embodiment or an electrode mixture containing the same, or including the modified sulfide solid electrolyte of another embodiment or an electrode mixture containing the same.

The lithium ion battery of the present embodiment preferably includes, for example, a positive electrode layer, a negative electrode layer, an electrolyte layer, and a collector. The positive electrode layer and the negative electrode layer each preferably use the electrode mixture of the present embodiment, and the electrolyte layer preferably uses the modified sulfide solid electrolyte of the present embodiment or the modified sulfide solid electrolyte of another embodiment.

The collector used may be the known material. Examples thereof used include a layer including a material that reacts with the solid electrolyte, such as Au, Pt, Al, Ti, or Cu, covered with Au or the like.

### EXAMPLES

The present invention will be described specifically with reference to examples below, but the present invention is not limited to the examples.

### [Production Example: Production of Sulfide Solid Electrolyte]

Under a nitrogen atmosphere, 0.59 g of lithium sulfide, 0.95 g of diphosphorus pentasulfide, 0.19 g of lithium bromide, and 0.28 g of lithium iodide were placed in a Schlenk flask (capacity: 100 mL) having a stirring bar inside. After rotating the stirring bar, 20 mL of tetramethylethylenediamine (TMEDA) as a complexing agent was added thereto, followed by continuously agitating for 12 hours, and the resulting material containing a complex was dried in vacuum (room temperature: 23° C.) to provide a complex in a powder form. Subsequently, the complex in a powder form was heated at 120° C. in vacuum for 2 hours to provide an amorphous sulfide solid electrolyte. The amorphous sulfide solid electrolyte was further heated at 140° C. in vacuum for 2 hours to provide a crystalline sulfide solid electrolyte 1 (the heating temperature for providing the crystalline sulfide solid electrolyte (which is 140° C. in this example) may also be referred to as a “crystallization temperature”).

The BET specific surface areas of the amorphous sulfide solid electrolyte and the crystalline sulfide solid electrolyte thus obtained were measured and were both 40 m²/g.

### Example 1

Under a nitrogen atmosphere, 3 g of the crystalline sulfide solid electrolyte produced in Production Example above was weighed and placed in a Schlenk flask (capacity: 100 mL) having a stirring bar inside, to which 22 g of toluene was added, and the mixture was agitated to provide a fluid in a slurry form. To the fluid in a slurry form, 2-ethylhexyl glycidyl ether as a compound 1 and bisphenol A diglycidyl ether as a compound 2 at a mass ratio of 20/80 (i.e., the content of the compound 1 was 20% by mass based on the total amount of the compounds used) were added to the fluid in a slurry form in an amount providing a proportion of 5 parts by mass per 100 parts by mass of the sulfide solid electrolyte (i.e., 0.15 g), and after agitating for 10 minutes, toluene was distilled off through vacuum drying to provide a modified sulfide solid electrolyte.

The resulting modified sulfide solid electrolyte was measured for the oil absorption, the ionic conductivity, and the oxidation current by the following methods. The oil absorption (index) and the oxidation current (index) were calculated by the following methods. The measurement results and the calculation results are shown in Table 1.

### Examples 2 to 5

A modified sulfide solid electrolyte was produced in the same manner as in Example 1 except that in Example 1, the ratios of the compound 1 and the compound 2 were changed to the ratio shown in Table 1.

The resulting modified sulfide solid electrolyte was measured for the oil absorption, the ionic conductivity, and the oxidation current by the following methods. The oil absorption (index) and the oxidation current (index) were calculated by the following methods. The measurement results and the calculation results are shown in Table 1.

### Comparative Example 1

The sulfide solid electrolyte obtained in Production Example above was measured for the oil absorption, the ionic conductivity, and the oxidation current by the following methods. The measurement results are shown in Table 1. The oil absorption of the sulfide solid electrolyte was 1.03 mL/g, and the oxidation current thereof was 0.60 mA.

### Comparative Examples 2 and 3

A modified sulfide solid electrolyte was produced in the same manner as in Example 1 except that the ratios of the compound 1 and the compound 2 in Example 1 were changed to the ratio shown in Table 1.

The resulting modified sulfide solid electrolyte was measured for the oil absorption, the ionic conductivity, and the oxidation current by the following methods. The oil absorption (index) and the oxidation current (index) were calculated by the following methods. The measurement results and the calculation results are shown in Table 1.

### (Measurement of Specific Surface Area)

The specific surface area was measured by the BET method through krypton (Kr) adsorption with a gas adsorption amount measurement device.

### (Measurement of Oil Absorption)

One drop of butyl butyrate was added to 1 g of the solid electrolyte obtained in each of Examples and Comparative Examples as a specimen in a mortar, and agitated with a spatula, and the operation was repeated until the specimen became a paste form, at which the total amount of butyl butyrate was designated as an oil absorption (mL/g). The index of the oil absorption is a value that is calculated by the following expression.

### (Oil Absorption (Index))

The oil absorption of the sulfide solid electrolyte obtained in Production Example was measured in the same manner as above (Measurement of Oil Absorption). The value obtained by calculating by the following expression using the oil absorption A of the sulfide solid electrolyte and the oil absorption B of the sulfide solid electrolyte obtained in each of Examples and Comparative Examples was designated as the index of the oil absorption.

$$Index of oil absorption ( \% ) = ( oil absorption B / oil absorption A ) \times 100$$

### (Measurement of Ionic Conductivity)

In the examples, the ionic conductivity was measured in the following manner.

A circular pellet having a diameter of 10 mm (cross sectional area S: 0.785 cm²) and a height (L) of 0.1 to 0.3 cm was molded from the sulfide solid electrolyte to provide a specimen. Electrode terminals were attached to the upper and lower surfaces of the specimen, which was then measured by the alternating current impedance method (frequency range: 1 MHz to 100 Hz, amplitude: 10 mV) at 25° C. to provide a Cole-Cole plot. On the right side of the circular arc observed on the high frequency range region thereof, the real part Z′ (Ω) at the point making —Z″ (Ω) minimum was designated as the bulk resistance R (Ω) of the electrolyte, and the ionic conductivity σ (S/cm) was calculated according to the following expressions.

$$R = ρ ( L / S )$$

$$σ = 1 / ρ$$

### (CV Measurement (Oxidation Current))

For evaluating the oxidation current, the following CV measurement cell was used.

The powder obtained in each of Examples and Comparative Examples was used, and 100 mg in total of the powder and Denka Black particles (particle diameter: 35 nm, available from Denka Co., Ltd.) (powder/Denka Black (mass ratio)=85/15) were mixed in a mortar for 10 minutes to prepare measurement powder (1).

In a battery cell having a diameter of 10 mm, 100 mg of an electrolyte for a separator layer was added and pressed three times while rotating 120° each time with a stainless steel mold at 10 MPa/cm², and then 10 mg of the measurement powder (1) was added and pressed three times while rotating 120° each time at 20 MPa/cm². The assembly was then pressed from the opposite side to the measurement powder (1) three times while rotating 120° each time at 20 MPa/cm².

The electrolyte for the separator layer above was synthesized under the following condition.

Under a nitrogen atmosphere, 20.5 g of Li₂S, 33.1 g of P₂S₅, 10.0 g of LiI, and 6.5 g of LiBr were placed in a 1 L reaction vessel equipped with an agitation impeller. After rotating the agitation impeller, 630 g of toluene was added, and the resulting slurry was agitated for 10 minutes. The reaction vessel was connected to a bead mill capable of performing a cycle operation (“Starmill LMZ015” (registered trade name), available from Ashizawa Finetech Ltd., material of beads: zirconia, diameter of beads: 0.5 mm, amount of beads used; 456 g), and a pulverization process (flow rate of pump: 650 mL/min, circumferential speed of bead mill: 12 m/s, temperature of mill jacket: 45° C.) was performed for 45 hours.

The resulting slurry was dried in vacuum at room temperature (25° C.) and then heated (80° C.) to provide an amorphous solid electrolyte as white powder. The resulting white powder was further heated in vacuum to 195° C. for 2 hours to provide crystalline solid electrolyte as white powder. In the XRD spectrum of the crystalline solid electrolyte, crystallization peaks were detected at 2θ=20.2° and 23.6°, from which the solid electrolyte had a thio-LISICON Region II type crystal structure. The average particle diameter (D₅₀) of the resulting crystalline solid electrolyte was 4.5 μm, and the ionic conductivity thereof was 5.0 mS/cm.

On the side of the electrolyte for the separator layer opposite to the measurement powder (1), an InLi foil (having a layered structure of In: 10 mm in diameter×0.1 mm/Li: 9 mm in diameter×0.08 mm/stainless steel: 10 mm in diameter×0.1 mm/boundary of layers) was provided, and the assembly was pressed once at 6 MPa/cm². The cell was fixed with four screws with an insulator intervening for avoiding short circuit between the measurement powder (1) and the InLi foil, and the screws were fixed at a torque of 8 N·m to provide a measurement cell.

The resulting measurement cell was connected to a measurement device (“VMP-300” (model No.), available from Bio-Logic Science Instruments SAS), and a CV curve was obtained under the following condition. The maximum current in the CV curve was designated as the oxidation current.
Measurement temperature: 25° C.
Sweep speed: 0.1 mV/s
Potential measurement range: open circuit voltage (+2.1 V)=>+5.0 V=>2.1 V
Number of cycles: 2

As for the index of the oxidation current, the value obtained by calculating by the following expression using the oxidation current A of the sulfide solid electrolyte and the oxidation current B of the sulfide solid electrolyte obtained in each of Examples and Comparative Examples was designated as the index of the oil absorption.

$$Index of oxidation current ( \% ) = ( oxidation current B / oxidation current A ) \times 100$$

### (Oxidation Current (Index))

The value obtained by calculating by the following expression using the oxidation current A of the sulfide solid electrolyte and the oxidation current B of the sulfide solid electrolyte obtained in each of Examples and Comparative Examples measured according to the section (CV Measurement (Oxidation Current)) above was designated as the index of the oxidation current.

$$Index of oxidation current ( \% ) = ( oxidation current B / oxidation current A ) \times 100$$

TABLE 1

| | | Example | | | | | Comparative Example | | |
|---|---|---|---|---|---|---|---|---|---|
| | | 1 | 2 | 3 | 4 | 5 | 1 | 2 | 3 |
| Ratio of Compound 1 | % by mass | 20 | 40 | 60 | 80 | 90 | 0 | 0 | 100 |
| Ratio of Compound 2 | % by mass | 80 | 60 | 40 | 20 | 10 | 0 | 100 | 0 |
| Total amount of | % by mass | 5 | 5 | 5 | 5 | 5 | 0 | 5 | 5 |
| compounds | | | | | | | | | |
| Specific surface area | m²/g | 40 | 40 | 40 | 40 | 40 | 40 | 40 | 40 |
| Oil absorption | mL/g | 0.87 | 0.81 | 0.76 | 0.67 | 0.62 | 1.03 | 0.91 | 0.61 |
| Oil absorption (index) | % | 84 | 79 | 74 | 65 | 60 | 100 | 88 | 59 |
| Oxidation current | mA | 0.37 | 0.35 | 0.34 | 0.38 | 0.41 | 0.60 | 0.38 | 0.47 |
| Oxidation current (index) | % | 61 | 59 | 57 | 63 | 69 | 100 | 64 | 78 |
| Ionic conductivity | mS/cm | 1.7 | 1.7 | 1.8 | 1.8 | 1.8 | 3.9 | 1.7 | 1.8 |

The details of the compound 1 and the compound 2 shown in Table 1 are as follows. The compound 1 is 2-ethylhexyl glycidyl ether (molecular weight: 186.30), which is the epoxy compound 2A represented by the general formula (2A), in which X^{21A} represents a group represented by the general formula (2Aa), and X^{22A} and X^{23A} represent hydrogen atoms, and in the general formula (2Aa), R^{21A} represents a methylene group, and R^{22A} represents a 2-ethylhexyl group. The structural formula thereof is as follows.

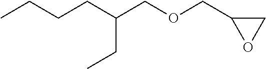

The compound 2 is bisphenol A diglycidyl ether (molecular weight: 340.42), which is a compound represented by the general formula (1B), in which X^{1B} represents a divalent aromatic group obtained by removing one hydrogen atom from each of the two hydroxy groups of bisphenol A as the basic structure, m_{1B} represents 2, and l_{1B} and n_{1B} represent 0. The structural formula thereof is as follows.

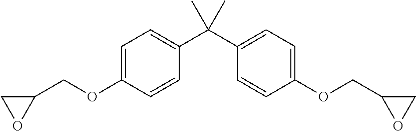

It has been confirmed by the examples that the modified sulfide solid electrolyte of the present embodiment has a reduced oil absorption, i.e., an oil absorption (index) of 60 to 84% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 57 to 69% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 to 1.8 mS/cm, and a high ionic conductivity is provided although decreased as compared to the sulfide solid electrolyte using no compound in Comparative Example 1.

On the other hand, the sulfide solid electrolyte of Comparative Example 3 using the compound 1 alone has a large oxidation current (index) of 78%, and the sulfide solid electrolyte of Comparative Example 2 using the compound 2 alone has a large oil absorption (index) of 88%.

It has been confirmed from the results that the modified sulfide solid electrolyte of the present embodiment using the compounds 1 and 2 has a small oil absorption, is excellent in coating suitability, has a small oxidation current, and has the excellent oxidation resistance. It has also been confirmed that the method of producing a modified sulfide solid electrolyte of the present embodiment is a production method favorable for exhibiting the effect of reducing the oil absorption and enhancing the coating suitability for the sulfide solid electrolyte having a large specific surface area of 10 m²/g or more.

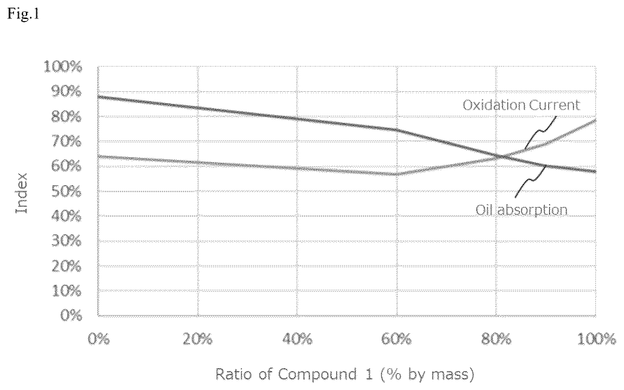

FIG. 1 shows a graph obtained by plotting the oil absorption (index) and the oxidation current (index) on the content of the compound 1 with respect to the total amount of the compounds (shown as “Ratio of Compound 1 (% by mass)” in the graph in FIG. 1) as the abscissa in Examples and Comparative Examples. It can be understood from the graph that the modified sulfide solid electrolyte of the present embodiment achieves both the reduction of the oil absorption and the reduction of the oxidation current in a well-balanced manner, as compared to the sulfide solid electrolytes of Comparative Examples 2 and 3 using one kind of the compound (which correspond to ratios of the compound 1 of 0% by mass and 100% by mass respectively in the graph in FIG. 1).

It is also understood that the compound 1 is further effective for reducing the oil absorption, and the compound 2 is further effective for reducing the oxidation current. For example, a modified sulfide solid electrolyte having desired capabilities can be obtained by regulating the ratios of the compound 1 further effective for reducing the oil absorption and the compound 2 further effective for reducing the oxidation current.

### Example 6 and Comparative Example 4

A modified sulfide solid electrolyte was produced in the same manner as in Example 1 except that in Example 1, the compounds 1 and 2 were changed to the compound 3 and the compound 4, and the ratios of the compounds were changed to the ratio shown in Table 2.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 2.

TABLE 2

| | | | Comparative |
|---|---|---|---|
| | | Example | Example |
| | | 6 | 4 |
| Ratio of Compound 3 | % by mass | 80 | 0 |
| Ratio of Compound 4 | % by mass | 20 | 100 |
| Total amount of compounds | % by mass | 5 | 5 |
| Specific surface area | m²/g | 40 | 40 |
| Oil absorption | mL/g | 0.61 | 0.66 |
| Oil absorption (index) | % | 59 | 64 |
| Oxidation current | mA | 0.44 | 0.62 |
| Oxidation current (index) | % | 73 | 104 |
| Ionic conductivity | mS/cm | 1.7 | 2.4 |

The compound 3 is 4-tert-butylphenyl glycidyl ether (molecular weight: 206.29), which is the epoxy compound 2A represented by the general formula (2A), in which X^{21A} represents a group represented by the general formula (2Aa), and X^{22A} and X^{23A} represent hydrogen atoms, and in the general formula (2Aa), R^{21A} represents a methylene group, and R^{22A} represents a 4-tert-butylphenyl group. The structural formula thereof is as follows.

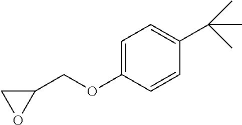

The compound 4 is tri-n-octylphosphine oxide (molecular weight: 386.64), which is the compound represented by the general formula (1H), in which R^{11H} to R^{13H} represent octyl groups. The structural formula thereof is as follows.

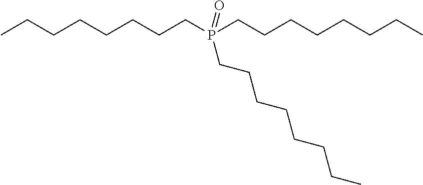

It has been confirmed from the results of Example 6 that the modified sulfide solid electrolyte of the present embodiment has a reduced oil absorption, i.e., an oil absorption (index) of 59% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 73% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 mS/cm, and a high ionic conductivity is provided although decreased as compared to the sulfide solid electrolyte using no compound in Comparative Example 1.

On the other hand, the sulfide solid electrolyte of Comparative Example 4 using the compound 4 alone has a large oxidation current (index) of 104%, which is eventually increased from the sulfide solid electrolyte of Comparative Example 1.

### Examples 7 to 11

A modified sulfide solid electrolyte was produced in the same manner as in Example 1 except that in Example 1, the compound 2 was changed to the compound 5, and the ratios of the compounds were changed to the ratio shown in Table 3.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 3.

TABLE 3

| | | Example | | | | |
|---|---|---|---|---|---|---|
| | | 7 | 8 | 9 | 10 | 11 |
| Ratio of Compound 1 | % by mass | 20 | 40 | 60 | 80 | 90 |
| Ratio of Compound 5 | % by mass | 80 | 60 | 40 | 20 | 10 |
| Total amount of | % by mass | 5 | 5 | 5 | 5 | 5 |
| compounds | | | | | | |
| Specific surface area | m²/g | 40 | 40 | 40 | 40 | 40 |
| Oil absorption | mL/g | 0.88 | 0.80 | 0.79 | 0.79 | 0.69 |
| Oil absorption (index) | % | 85 | 78 | 77 | 77 | 67 |
| Oxidation current | mA | 0.33 | 0.35 | 0.36 | 0.37 | 0.39 |
| Oxidation current (index) | % | 55 | 58 | 60 | 62 | 65 |
| Ionic conductivity | mS/cm | 1.7 | 1.7 | 1.8 | 1.8 | 1.8 |

The compound 5 is bisphenol A propoxylate diglycidyl ether (molecular weight: 358.43), which is the compound represented by the general formula (1B), in which X^{1B} represents a divalent aromatic group obtained by removing one hydrogen atom from each of the two propyl groups of 2,2-bis(4-propoxyphenyl) propane as the basic structure, n_{1B} represents 2, and l_{1B} and m_{1B} represent 0. The structural formula thereof is as follows.

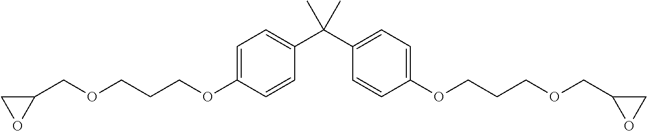 [SMILES: CC(C)(c1ccc(OCCCOCC2CO2)cc1)c1ccc(OCCCOCC2CO2)cc1]

It has been confirmed from the results of Examples 7 to 11 that the modified sulfide solid electrolyte of the present embodiment has a reduced oil absorption, i.e., an oil absorption (index) of 67 to 85% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 55 to 65% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 to 1.8 mS/cm, and a high ionic conductivity is provided although decreased as compared to the sulfide solid electrolyte using no compound in Comparative Example 1.

### Examples 12 and 13 and Comparative Example 5

A modified sulfide solid electrolyte was produced in the same manner as in Example 1 except that in Example 1, the compound 1 was changed to the compound 6, and the ratios of the compounds were changed to the ratio shown in Table 4.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 4.

TABLE 4

| | | | | Comparative |
|---|---|---|---|---|
| | | Example | | Example |
| | | 12 | 13 | 5 |
| Ratio of Compound 2 | % by mass | 80 | 90 | 0 |
| Ratio of Compound 6 | % by mass | 20 | 10 | 100 |
| Total amount of compounds | % by mass | 5 | 5 | 5 |
| Specific surface area | m²/g | 40 | 40 | 40 |
| Oil absorption | mL/g | 0.85 | 0.87 | 0.97 |
| Oil absorption (index) | % | 82 | 85 | 95 |
| Oxidation current | mA | 0.40 | 0.29 | 0.65 |
| Oxidation current (index) | % | 66 | 48 | 109 |
| Ionic conductivity | mS/cm | 1.7 | 1.7 | 3.2 |

The compound 6 is 2-bromopropane (molecular weight: 122.99), which is the compound represented by the general formula (1C), in which X^{11C} represents a bromine atom, X^{12C} and X^{13C} represent methyl groups, and X^{14C} represents a hydrogen atoms. The structural formula thereof is as follows.

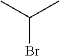

It has been confirmed from the results of Examples 12 and 13 that the modified sulfide solid electrolyte of the present embodiment has a reduced oil absorption, i.e., an oil absorption (index) of 82 to 85% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 48 to 66% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 mS/cm, and a high ionic conductivity is provided although decreased as compared to the sulfide solid electrolyte using no compound in Comparative Example 1.

On the other hand, the sulfide solid electrolyte of Comparative Example 5 using the compound 6 alone has a large oxidation current (index) of 109%, which is eventually increased from the sulfide solid electrolyte of Comparative Example 1.

### Example 14 and Comparative Example 6

A modified sulfide solid electrolyte was produced in the same manner as in Example 1 except that in Example 1, the compound 1 was changed to the compound 7, and the ratios of the compounds were changed to the ratio shown in Table 5.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 5.

TABLE 5

| | | | Comparative |
|---|---|---|---|
| | | Example | Example |
| | | 14 | 6 |
| Ratio of Compound 2 | % by mass | 80 | 0 |
| Ratio of Compound 7 | % by mass | 20 | 100 |
| Total amount of compounds | % by mass | 5 | 5 |
| Specific surface area | m²/g | 40 | 40 |
| Oil absorption | mL/g | 0.81 | 0.71 |
| Oil absorption (index) | % | 79 | 69 |
| Oxidation current | mA | 0.46 | 0.61 |
| Oxidation current (index) | % | 77 | 101 |
| Ionic conductivity | mS/cm | 1.7 | 3.2 |

The compound 7 is 3-phenylpropyl bromide (molecular weight: 199.09), which is the compound represented by the general formula (1C), in which X^{11C} represents a bromine atom, X^{12C} represents a phenylpropyl group, and X^{13C} and X^{14C} represent hydrogen atoms. The structural formula thereof is as follows.

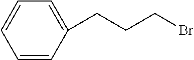

It has been confirmed from the results of Example 14 that the modified sulfide solid electrolyte of the present embodiment has a reduced oil absorption, i.e., an oil absorption (index) of 79% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 77% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 mS/cm, and a high ionic conductivity is provided although decreased as compared to the sulfide solid electrolyte using no compound in Comparative Example 1.

On the other hand, the sulfide solid electrolyte of Comparative Example 6 using the compound 7 alone has a large oxidation current (index) of 101%, which is eventually increased from the sulfide solid electrolyte of Comparative Example 1.

### Example 15

A modified sulfide solid electrolyte was produced in the same manner as in Example 1 except that in Example 1, the compound 1 was changed to the compound 8, and the ratios of the compounds were changed to the ratio shown in Table 6.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 6.

TABLE 6

| | | Example |
|---|---|---|
| | | 15 |
| Ratio of Compound 2 | % by mass | 80 |
| Ratio of Compound 8 | % by mass | 20 |
| Total amount of compounds | % by mass | 5 |
| Specific surface area | m²/g | 40 |
| Oil absorption | mL/g | 0.81 |
| Oil absorption (index) | % | 79 |
| Oxidation current | mA | 0.46 |
| Oxidation current (index) | % | 77 |
| Ionic conductivity | mS/cm | 1.7 |

The compound 8 is 1-dodecanethiol (molecular weight: 202.40) which is the compound represented by general formula (1G), in which R^{11G} represents a single bond, n_{11G} represents 0, R^{13G} represents a 1,12-dodecanediyl group, and X^{11G} represents a hydrogen atom.

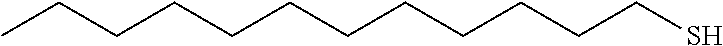

It has been confirmed from the results of Example 15 that the modified sulfide solid electrolyte of the present embodiment has a reduced oil absorption, i.e., an oil absorption (index) of 79% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 77% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 mS/cm, and a high ionic conductivity is provided although decreased as compared to the sulfide solid electrolyte using no compound in Comparative Example 1.

### Example 16

A modified sulfide solid electrolyte was produced in the same manner as in Example 1 except that in Example 1, the compound 1 was changed to the compound 9, and the ratios of the compounds were changed to the ratio shown in Table 7.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 7.

TABLE 7

| | | Example |
|---|---|---|
| | | 16 |
| Ratio of Compound 2 | % by mass | 80 |
| Ratio of Compound 9 | % by mass | 20 |
| Total amount of compounds | % by mass | 5 |
| Specific surface area | m²/g | 40 |
| Oil absorption | mL/g | 0.85 |
| Oil absorption (index) | % | 83 |
| Oxidation current | mA | 0.41 |
| Oxidation current (index) | % | 68 |
| Ionic conductivity | mS/cm | 1.8 |

The compound 9 is tri-n-octadecyl borate (molecular weight: 386.64), which is the compound represented by the general formula (1I), in which R^{11I} to R^{13I} represent octadecyloxy groups. The structural formula thereof is as follows.

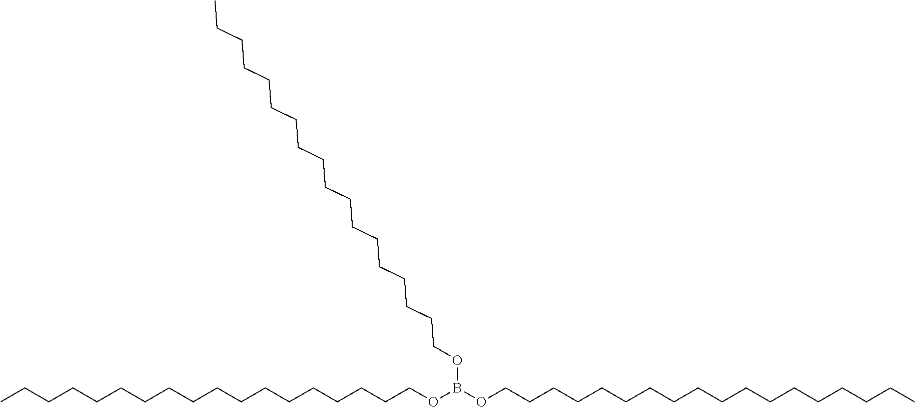

It has been confirmed from the results of Example 16 that the modified sulfide solid electrolyte of the present embodiment has a reduced oil absorption, i.e., an oil absorption (index) of 83% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 68% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.8 mS/cm, and a high ionic conductivity is provided although decreased as compared to the sulfide solid electrolyte using no compound in Comparative Example 1.

### Examples 17 and 18

A modified sulfide solid electrolyte was produced in the same manner as in Example 1 except that in Example 1, the compound 1 was changed to the compound 10, and the ratios of the compounds were changed to the ratio shown in Table 8.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 8.

TABLE 8

Example

| | | 17 | 18 |
|---|---|---|---|
| Ratio of Compound 2 | % by mass | 80 | 90 |
| Ratio of Compound 10 | % by mass | 20 | 10 |
| Total amount of compounds | % by mass | 5 | 5 |
| Specific surface area | m²/g | 40 | 40 |
| Oil absorption | mL/g | 0.79 | 0.65 |
| Oil absorption (index) | % | 77 | 63 |
| Oxidation current | mA | 0.39 | 0.41 |
| Oxidation current (index) | % | 65 | 68 |
| Ionic conductivity | mS/cm | 1.9 | 1.7 |

The compound 10 is 2,2,3,3,4,4,5,5,6,6,7,7,7-tridecafluoroheptyloxirane (molecular weight: 376.12), which is the compound represented by the general formula (1A), in which X^{11A} represents a 2,2,3,3,4,4,5,5,6,6,7,7,7-tridecafluoroheptyl group, and X^{11B} and X^{11C} represent hydrogen atoms. The structural formula thereof is as follows.

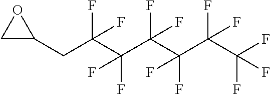

It has been confirmed from the results of Examples 17 and 18 that the modified sulfide solid electrolyte of the present embodiment has a reduced oil absorption, i.e., an oil absorption (index) of 63 to 77% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 65 to 68% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.7 to 1.9 mS/cm, and a high ionic conductivity is provided although decreased as compared to the sulfide solid electrolyte using no compound in Comparative Example 1.

### Example 19

A modified sulfide solid electrolyte was produced in the same manner as in Example 1 except that in Example 1, the compound 2 was changed to the compound 11, and the ratios of the compounds were changed to the ratio shown in Table 9.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 9.

TABLE 9

| | | Example |
|---|---|---|
| | | 19 |
| Ratio of Compound 1 | % by mass | 50 |
| Ratio of Compound 11 | % by mass | 50 |
| Total amount of compounds | % by mass | 5 |
| Specific surface area | m²/g | 40 |
| Oil absorption | mL/g | 0.80 |
| Oil absorption (index) | % | 78 |
| Oxidation current | mA | 0.33 |
| Oxidation current (index) | % | 55 |
| Ionic conductivity | mS/cm | 1.5 |

The compound 11 is tris(4-hydroxyphenyl) methane triglycidyl ether (molecular weight: 460.52), which is the compound represented by general formula (1B), in which X^{1B} represents a trivalent group obtained by removing one hydrogen atom from each of the three hydroxy groups of methylidinetrisphenol as the basic structure, l_{1B} and m_{1B} represent 0, and n_{1B} represents 3. The structural formula thereof is as follows.

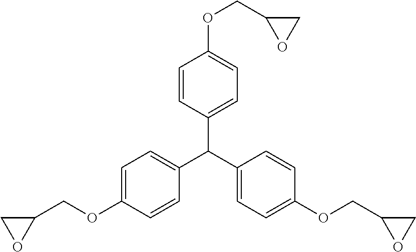

It has been confirmed from the results of Example 19 that the modified sulfide solid electrolyte of the present embodiment has a reduced oil absorption, i.e., an oil absorption (index) of 78% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 55% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.5 mS/cm, and a high ionic conductivity is provided although decreased as compared to the sulfide solid electrolyte using no compound in Comparative Example 1.

### Example 20

A modified sulfide solid electrolyte was produced in the same manner as in Example 1 except that in Example 1, the compound 2 was changed to the compound 12, and the ratios of the compounds were changed to the ratio shown in Table 10.

The resulting modified sulfide solid electrolyte was measured for the oil absorption, the ionic conductivity, and the oxidation current by the methods described above. The oil absorption (index) and the oxidation current (index) were calculated by the methods described above. The measurement results and the calculation results are shown in Table 10.

TABLE 10

| | | Example |
|---|---|---|
| | | 20 |
| Ratio of Compound 1 | % by mass | 50 |
| Ratio of Compound 12 | % by mass | 50 |
| Total amount of compounds | % by mass | 5 |
| Specific surface area | m²/g | 40 |
| Oil absorption | mL/g | 0.75 |
| Oil absorption (index) | % | 73 |
| Oxidation current | mA | 0.28 |
| Oxidation current (index) | % | 47 |
| Ionic conductivity | mS/cm | 1.3 |

The compound 12 is 1,3-bis(2-(7-oxabicyclo[4.1.0]heptan-3-yl)ethyl)-1,1,3,3-tetramethyldisiloxane (molecular weight: 382.69), which is the compound represented by the general formula (1B), in which X^{1B} represents a divalent group obtained by removing one hydrogen atom from the three hydrogen atoms connected to the end carbon atoms of 1,3-ethylhexyl-1,1,3,3-tetramethyldisiloxane as the basic structure, l_{1B} represents 2, and m_{1B} and n_{1B} represent 0. The structural formula thereof is as follows.

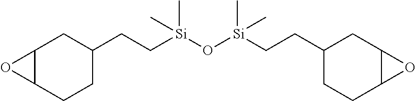 [SMILES: C[Si](C)(CCC1CCC2OC2C1)O[Si](C)(C)CCC1CCC2OC2C1]

It has been confirmed from the results of Example 20 that the modified sulfide solid electrolyte of the present embodiment has a reduced oil absorption, i.e., an oil absorption (index) of 73% with respect to the sulfide solid electrolyte before the modification in Comparative Example 1 as 100, and thus has a reduced oil absorption irrespective of the large specific surface area of 10 m²/g or more, resulting in the excellent coating suitability. It has also been confirmed that the oxidation current (index) thereof is 47% with respect to the sulfide solid electrolyte before the modification in Comparative Example 1 as 100, and thus the oxidation current is also reduced, resulting in the excellent oxidation resistance. It has also been confirmed from the examples that the ionic conductivity of the modified sulfide solid electrolyte of the present embodiment is 1.3 mS/cm, and a high ionic conductivity is provided although decreased as compared to the sulfide solid electrolyte using no compound in Comparative Example 1.

### INDUSTRIAL APPLICABILITY

The modified sulfide solid electrolyte of the present embodiment is a sulfide solid electrolyte that is excellent in coating suitability in coating as a paste, and can exhibit the excellent battery capabilities efficiently, irrespective of the large specific surface area thereof. The modified sulfide solid electrolyte of the present embodiment has a high ionic conductivity, and therefore is favorably used in batteries, particularly batteries used in information-related devices, communication devices, and the like, such as personal computers, video cameras, and mobile phones.

1. A modified sulfide solid electrolyte comprising a sulfide solid electrolyte having a BET specific surface area of 10 m²/g or more and comprising a lithium atom, a sulfur atom, a phosphorus atom, a halogen atom, and at least two kinds of compounds selected from the following compounds (A) to (I):
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups represented by —CH₂X^{1F} (wherein X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

2. The modified sulfide solid electrolyte according to claim 1, wherein the modified sulfide solid electrolyte comprises at least one kind of a compound selected from the compound (B) and at least one kind of a compound selected from the compounds (A) and (C) to (I).

3. The modified sulfide solid electrolyte according to claim 1, wherein the modified sulfide solid electrolyte comprises at least one kind of a compound selected from the compound (B) and at least one kind of a compound selected from the compounds (A), (C), and (F).

4. The modified sulfide solid electrolyte according to claim 1, wherein the heterocyclic ring having a carbon atom and an oxygen atom of the compounds (A) and (B) is an oxirane ring.

5. The modified sulfide solid electrolyte according to claim 1, wherein the solid electrolyte having a BET specific surface area of 10 m²/g or more comprises compound (C), and wherein compound (C) is at least one kind of a compound selected from a compound having one group represented by —CH₂X^{1C} wherein X^{1C} represents a halogen atom, a compound having a halogenated formyl group (CX^{1C}(═O)— wherein X^{1C} represents a halogen atom, and a compound having a halogenated silyl group —SiX^{1C}n_{1C} wherein X^{1C} represents a halogen atom, and n_{1C} represents an integer of 1 to 3.

6. The modified sulfide solid electrolyte according to claim 4, wherein solid electrolyte having a BET specific surface area of 10 m²/g or more comprises compound (A), and wherein the compound (A) is at least one kind of a compound selected from an epoxy compound 1A represented by the following general formula (1A), an epoxy compound 2A represented by the following general formula (2A), and an epoxy compound 3A represented by the following general formula (3A): 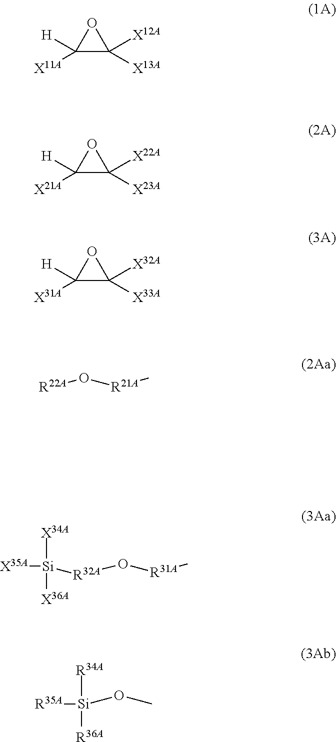
wherein
in the general formula (1A), X^{11A} to X^{13A} each independently represent a hydrogen atom, a halogen atom, a hydrocarbon group, or a halogenated hydrocarbon group, and at least one of X^{11A} to X^{13A} represents a hydrocarbon group or a halogenated hydrocarbon group,
in the general formula (2A), X^{21A} to X^{23A} each independently represent a hydrogen atom, a halogen atom, a hydrocarbon group, a halogenated hydrocarbon group, or a group represented by the general formula (2Aa), and at least one of X^{21A} to X^{23A} represents a group represented by the general formula (2Aa), and in the general formula (2Aa), R^{21A} represents a divalent hydrocarbon group, and R^{22A} represents a hydrogen atom, a halogen atom, a hydrocarbon group, or a halogenated hydrocarbon group,
in the general formula (3A), X^{31A} to X^{33A} each independently represent a hydrogen atom, a halogen atom, a hydrocarbon group, a halogenated hydrocarbon group, or a group represented by the general formula (3Aa), and at least one of X^{31A} to X^{33A} represents a group represented by the general formula (3Aa), and in the general formula (3Aa), R^{31A} and R^{32A} each independently represent a single bond or a divalent hydrocarbon group, and X^{34A} to X^{36A} each independently represent a hydrogen atom, a halogen atom, a hydrocarbon group, a halogenated hydrocarbon group, —OR^{33A}, or a group represented by the general formula (3Ab), wherein R^{33A} to R^{36A} each independently represent a hydrogen atom, a halogen atom, a hydrocarbon group, or a halogenated hydrocarbon group.

7. The modified sulfide solid electrolyte according to claim 4, wherein solid electrolyte having a BET specific surface area of 10 m²/g or more comprises compound (B), and wherein the compound (B) is an epoxy compound having two or more groups selected from an epoxy group, a glycidyl group, and a glycidyl ether group represented by the following general formula (1B): 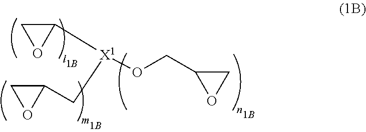
wherein in the general formula (1B), X^{1B} represents a single bond, an aliphatic group, an alicyclic group, an aromatic group, an organic group having a siloxane structure, or an organic group containing a combination of these groups, and l_{1B}, m_{1B}, and n_{1B} each represent an integer of 0 or more and 16 or less, and satisfy l_{1B}+m_{1B}+n_{1B}≥2, and in the case where the organic group represented by X^{1B} has the alicyclic group, the epoxy group may be condensed with the alicyclic ring in the alicyclic group.

8. The modified sulfide solid electrolyte according to claim 5, wherein the compound (C) is at least one kind of a compound selected from an organic halide 1a represented by the following general formula (1C), an organic halide 1b represented by the following general formula (2C), an organic halide 1c represented by the following general formula (3C), and an organic halide 1d represented by the following general formula (4C): 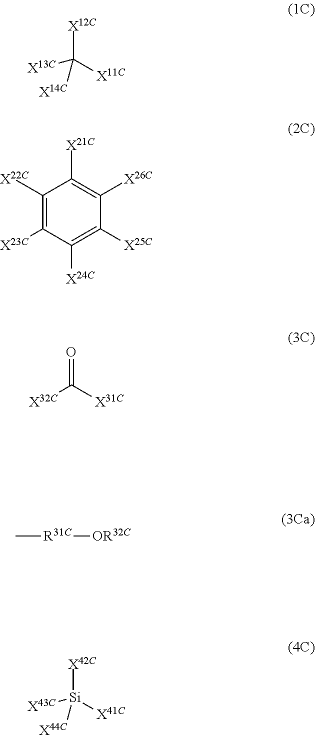
wherein
in the general formula (1C), X^{11C} represents a halogen atom, and X^{12C} to X^{14C} each independently represent a hydrogen atom, a halogen atom, an aliphatic hydrocarbon group, an alicyclic hydrocarbon group, or an aromatic hydrocarbon group, in which the hydrogen atoms of the aliphatic hydrocarbon group, the alicyclic hydrocarbon group, and the aromatic hydrocarbon group may be replaced by a halogen atom,
in the general formula (2C), X^{21C} to X^{26C} each independently represent a hydrogen atom, a halogen atom, an aliphatic hydrocarbon group, an alicyclic hydrocarbon group, or an aromatic hydrocarbon group, in which the hydrogen atoms of the aliphatic hydrocarbon group, the alicyclic hydrocarbon group, and the aromatic hydrocarbon group represented by X^{21C} to X^{26C} may be replaced by a halogen atom, and at least one of X^{21C} to X^{26C} represents a halogen atom or a group containing a halogen atom,
in the general formula (3C), X^{31C} and X^{32C} each independently represent a hydrogen atom, a halogen atom, an aliphatic hydrocarbon group, an alicyclic hydrocarbon group, an aromatic hydrocarbon group, or a group represented by the general formula (3Ca), and in the general formula (3Ca), R^{31C} represents a single bond or an aliphatic hydrocarbon group, and R^{32C} represents a hydrogen atom, a halogen atom, or an aliphatic hydrocarbon group, the hydrogen atoms of the aliphatic hydrocarbon group, the alicyclic hydrocarbon group, and the aromatic hydrocarbon group may be replaced by a halogen atom, and at least one of X^{31C} and X^{32C} represents a halogen atom or a group containing a halogen atom
in the general formula (4C), X^{41C} to X^{44C} each independently represent a hydrogen atom, a halogen atom, an aliphatic hydrocarbon group, an alicyclic hydrocarbon group, or an aromatic hydrocarbon group, in which the aliphatic hydrocarbon group, the alicyclic hydrocarbon group, and the aromatic hydrocarbon group may be substituted by a halogen atom, and at least one of X^{41C} to X^{44C} represents a halogen atom or a group containing a halogen atom,
in the general formulae (1C) to (4C), the halogen atoms represented by X^{11C}, X^{21C}, X^{31C}, and X^{41C} each are an atom selected from a chlorine atom, a bromine atom, and an iodine atom, and the halogen atoms represented by X^{12C} to X^{14C}, X^{22C} to X^{26C}, X^{32C}, and X^{42C} to X^{44C} each are an atom selected from a fluorine atom, a chlorine atom, a bromine atom, and an iodine atom.

9. The modified sulfide solid electrolyte according to claim 1, wherein the solid electrolyte having a BET specific surface area of 10 m²/g or more comprises compound (D), and wherein the compound (D) is a compound represented by the following general formula (1D): 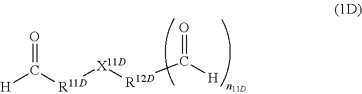
wherein in the general formula (1D), R^{11D} and R^{12D} each independently represent an organic group or a single bond, X^{11D} represents an oxygen atom, a sulfur atom, or a single bond, and n_{11D} represents 0 or 1.

10. The modified sulfide solid electrolyte according to claim 1, wherein the solid electrolyte having a BET specific surface area of 10 m²/g or more comprises compound (E), and wherein compound (E) is a compound represented by the following general formula (1E): 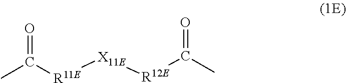
wherein in the general formula (1E), R^{11E} and R^{12E} each independently represent an organic group or a single bond, and X^{11E} represents an oxygen atom, a sulfur atom, or a single bond.

11. The modified sulfide solid electrolyte according to claim 1, wherein the solid electrolyte having a BET specific surface area of 10 m²/g or more comprises compound (F), and wherein compound (F) is a compound represented by the following general formula (1F): 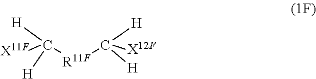
wherein in the general formula (1F), R^{11F} represents an organic group or a single bond, and X^{11F} and X^{12F} each independently represent a fluorine atom or a bromine atom.

12. The modified sulfide solid electrolyte according to claim 1, wherein the solid electrolyte having a BET specific surface area of 10 m²/g or more comprises compound (G), and wherein compound (G) is at least one kind of a compound selected from a thiol compound 1 represented by the following general formula (1G) and a thiol compound 2 represented by the following general formula (2G): 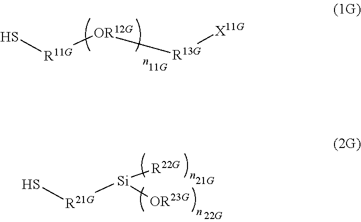
wherein
in the general formula (1G), R^{11G}, R^{12G}, and R^{13G} each independently represent an organic group or a single bond, X^{11G} represents a hydrogen atom or a thiol group, and n_{11G} represents an integer of 0 to 3, provided that at least one of R^{11G}, R^{12G}, and R^{13G} represents an organic group,
in the general formula (2G), R^{21G}, R^{22G}, and R^{23G} each independently represent an organic group, and n_{21G} and n_{22G} each represent an integer of 0 to 3, in which n_{21G} and n_{22G} satisfy n_{21G}+n_{22G}=3, provided that at least one of R^{21G}, R^{22G}, and R^{23G} represents an organic group.

13. The modified sulfide solid electrolyte according to claim 1, wherein the solid electrolyte having a BET specific surface area of 10 m²/g or more comprises compound (H), and wherein compound (H) is at least one kind of a compound selected from a metal-free phosphorus compound 1H represented by the following general formula (1H), a metal-free phosphorus compound 2H represented by the following general formula (2H), and a metal-free phosphorus compound 3H represented by the following general formula (3H): 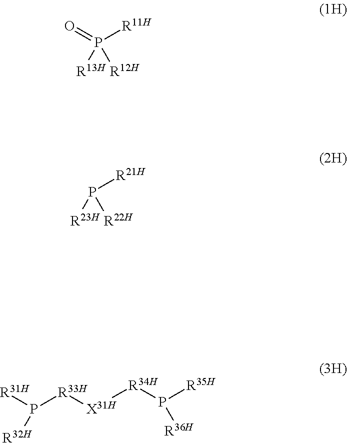
wherein
in the general formula (1H), R^{11H}, R^{12H}, and R^{13H} each independently represent an organic group,
in the general formula (2H), R^{21H}, R^{22H}, and R^{23H} each independently represent an organic group,
in the general formula (3H), R^{31H}, R^{32H}, R^{35H}, and R^{36H} each independently represent an organic group, R^{33H} and R^{34H} each independently represent a single bond or an organic group, and X^{31H} represents a single bond or an oxygen atom, in which at least one of R^{33H} and R^{34H} represents an organic group, and R^{33H} and R^{34H} may be bonded to each other to form a condensed ring.

14. The modified sulfide solid electrolyte according to claim 1, wherein solid electrolyte having a BET specific surface area of 10 m²/g or more comprises compound (I), and wherein the compound (I) is a compound represented by the following general formula (1I): 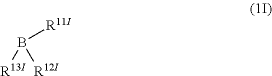
wherein in the general formula (1I), R^{11I}, R^{12I}, and R^{13I} each independently represent an organic group.

15. The modified sulfide solid electrolyte according to claim 1, wherein the modified sulfide solid electrolyte has a content of the at least two kinds of compounds of 0.03 part by mass or more and 25 parts by mass or less per 100 parts by mass of the sulfide solid electrolyte.

16. A method of producing a modified sulfide solid electrolyte, comprising
mixing a sulfide solid electrolyte having a BET specific surface area of 10 m²/g or more and comprising a lithium atom, a sulfur atom, a phosphorus atom, a halogen atom, an organic solvent, and at least two kinds of compounds selected from the following compounds (A) to (I), and
removing the organic solvent:
compound (A): a compound having one heterocyclic ring having a carbon atom and an oxygen atom,
compound (B): a compound having two or more heterocyclic rings having a carbon atom and an oxygen atom,
compound (C): an organic halide 1 (excluding the following compound (F)),
compound (D): a compound having a formyl group (CH(═O)—),
compound (E): a compound having two or more acetyl groups (CH₃C(═O)—),
compound (F): an organic halide 2 having two or more halogen-containing groups represented by —CH₂X^{1F} (wherein X^{1F} represents a fluorine atom or a bromine atom) and an organic group,
compound (G): a thiol compound,
compound (H): a metal-free phosphorus compound (provided that the compound does not contain an oxygen atom that is bonded to a phosphorus atom via a single bond), and
compound (I): a metal-free boron compound.

17. The method of producing a modified sulfide solid electrolyte according to claim 16, wherein the organic solvent is at least one kind of a solvent selected from an aliphatic hydrocarbon solvent, an alicyclic hydrocarbon solvent, an aromatic hydrocarbon solvent, an ether solvent, an ester solvent, and a nitrile solvent.

18. An electrode mixture comprising the modified sulfide solid electrolyte according to claim 1 and an electrode active substance.

19. A lithium ion battery, comprising the electrode mixture according to claim 18.
